(19) United States
(12) Patent Application Publication
(10) Pub. No.: US 2013/0081053 A1
(43) Pub. Date: Mar. 28, 2013

(54) Acquiring and transmitting tasks and subtasks to interface devices

(71) Applicants: Royce A. Levien, Lexington, MA (US); Richard T. Lord, Tacoma, WA (US); Robert W. Lord, Seattle, WA (US); Mark A. Malamud, Seattle, WA (US); John D. Rinaldo, JR., Bellevue, WA (US)

(72) Inventors: Royce A. Levien, Lexington, MA (US); Richard T. Lord, Tacoma, WA (US); Robert W. Lord, Seattle, WA (US); Mark A. Malamud, Seattle, WA (US); John D. Rinaldo, JR., Bellevue, WA (US)

(73) Assignee: Elwha LLC, a limited liability company of the State of Delaware

(21) Appl. No.: 13/200,553

(22) Filed: Sep. 23, 2011

(51) Int. Cl. G06F 9/46

(52) U.S. Cl. 718/107

(57) ABSTRACT

A computationally implemented method includes receiving request data including a request to carry out a task of acquiring data, acquiring one or more subtasks related to the task of acquiring data, selecting two or more discrete interface devices based on at least one of a status of the two or more discrete interface devices and a characteristic of the two or more discrete interface devices, transmitting at least one of the one or more subtasks to at least two of the two or more discrete interface devices, and receiving result data corresponding to a result of at least one subtask of the one or more subtasks executed by at least one of the two or more discrete interface devices. In addition to the foregoing, other method aspects are described in the claims, drawings, and text.

### BACKGROUND

This application is related to using interface devices to collect data.

### SUMMARY

A computationally implemented method includes, but is not limited to receiving request data including a request to carry out a task of acquiring data, acquiring one or more subtasks related to the task of acquiring data, selecting two or more discrete interface devices based on at least one of a status of the two or more discrete interface devices and a characteristic of the two or more discrete interface devices, transmitting at least one of the one or more subtasks to at least two of the two or more discrete interface devices, and receiving result data corresponding to a result of at least one subtask of the one or more subtasks executed by at least one of the two or more discrete interface devices. In addition to the foregoing, other method aspects are described in the claims, drawings, and text forming a part of the present disclosure.

In one or more various aspects, related systems include but are not limited to circuitry and/or programming for effecting the herein referenced method aspects; the circuitry and/or programming can be virtually any combination of hardware, software, and/or firmware in one or more machines or article of manufacture configured to effect the herein-referenced method aspects depending upon the design choices of the system designer.

A computationally implemented system includes, but is not limited to: means for receiving request data including a request to carry out a task of acquiring data, means for acquiring one or more subtasks related to the task of acquiring data, means for selecting two or more discrete interface devices based on at least one of a status of the two or more discrete interface devices and a characteristic of the two or more discrete interface devices, means for transmitting at least one of the one or more subtasks to at least two of the two or more discrete interface devices, and means for receiving result data corresponding to a result of at least one subtask of the one or more subtasks executed by at least one of the two or more discrete interface devices.

A computationally implemented system includes, but is not limited to: circuitry for receiving request data including a request to carry out a task of acquiring data, circuitry for acquiring one or more subtasks related to the task of acquiring data, circuitry for selecting two or more discrete interface devices based on at least one of a status of the two or more discrete interface devices and a characteristic of the two or more discrete interface devices, circuitry for transmitting at least one of the one or more subtasks to at least two of the two or more discrete interface devices, and circuitry for receiving result data corresponding to a result of at least one subtask of the one or more subtasks executed by at least one of the two or more discrete interface devices.

A computer program product comprising an article of manufacture bearing one or more instructions for receiving request data including a request to carry out a task of acquiring data, one or more instructions for acquiring one or more subtasks related to the task of acquiring data, one or more instructions for selecting two or more discrete interface devices based on at least one of a status of the two or more discrete interface devices and a characteristic of the two or more discrete interface devices, one or more instructions for transmitting at least one of the one or more subtasks to at least two of the two or more discrete interface devices, and one or more instructions for receiving result data corresponding to a result of at least one subtask of the one or more subtasks executed by at least one of the two or more discrete interface devices.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1, including FIGS. 1A and 1B, shows a high-level block diagram of an interface device operating in an exemplary environment 100, according to an embodiment.

FIG. 2A shows a particular perspective of the request data receiving module 151 of the computing device 30 of environment 100 of FIG. 1.

FIG. 2B, including FIGS. 2B1 and 2B2, shows a particular perspective of the subtask acquiring module 152 of the computing device 30 of environment 100 of FIG. 1.

FIG. 2C, including FIGS. 2C1-2C5, shows a particular perspective of the interface device selecting module 153 of the computing device 30 of environment 100 of FIG. 1.

FIG. 2D shows a particular perspective of the subtask transmitting module 154 of the computing device 30 of environment 100 of FIG. 1.

FIG. 2E shows a particular perspective of the result data receiving module 155 of the computing device 30 of environment 100 of FIG. 1.

FIGS. 3A, 3B, and 3C show exemplary database structures of an interface database 28, according to an embodiment.

FIG. 4 is a high-level logic flowchart of a process, e.g., operational flow 400, according to an embodiment.

FIG. 5A is a high-level logic flowchart of a process depicting alternate implementations of a receiving request data operation 1001 of FIG. 4.

FIG. 5B is a high-level logic flowchart of a process depicting alternate implementations of a receiving request data operation 1001 of FIG. 4.

FIG. 6A is a high-level logic flowchart of a process depicting alternate implementations of an acquiring one or more subtasks operation 2001 of FIG. 4.

FIG. 6B is a high-level logic flowchart of a process depicting alternate implementations of an acquiring one or more subtasks operation 2001 of FIG. 4.

FIG. 6C is a high-level logic flowchart of a process depicting alternate implementations of an acquiring one or more subtasks operation 2001 of FIG. 4.

FIG. 6D is a high-level logic flowchart of a process depicting alternate implementations of an acquiring one or more subtasks operation 2001 of FIG. 4.

FIG. 7A is a high-level logic flowchart of a process depicting alternate implementations of a selecting two or more discrete interface devices operation 3001 of FIG. 4.

FIG. 7B is a high-level logic flowchart of a process depicting alternate implementations of a selecting two or more discrete interface devices operation 3001 of FIG. 4.

FIG. 7C is a high-level logic flowchart of a process depicting alternate implementations of a selecting two or more discrete interface devices operation 3001 of FIG. 4.

FIG. 7D is a high-level logic flowchart of a process depicting alternate implementations of a selecting two or more discrete interface devices operation 3001 of FIG. 4.

FIG. 7E is a high-level logic flowchart of a process depicting alternate implementations of a selecting two or more discrete interface devices operation 3001 of FIG. 4.

FIG. 7F is a high-level logic flowchart of a process depicting alternate implementations of a selecting two or more discrete interface devices operation 3001 of FIG. 4.

FIG. 7G is a high-level logic flowchart of a process depicting alternate implementations of a selecting two or more discrete interface devices operation 3001 of FIG. 4.

FIG. 8A is a high-level logic flowchart of a process depicting alternate implementations of a transmitting at least one of the one or more subtasks operation 4001 of FIG. 4.

FIG. 8B is a high-level logic flowchart of a process depicting alternate implementations of a transmitting at least one of the one or more subtasks operation 4001 of FIG. 4.

FIG. 8C is a high-level logic flowchart of a process depicting alternate implementations of a transmitting at least one of the one or more subtasks operation 4001 of FIG. 4.

FIG. 9 is a high-level logic flowchart of a process depicting alternate implementations of a receiving result data operation 5001 of FIG. 4.

### DETAILED DESCRIPTION

In the following detailed description, reference is made to the accompanying drawings, which form a part hereof. In the drawings, similar symbols typically identify similar or identical components or items, unless context dictates otherwise. The illustrative embodiments described in the detailed description, drawings, and claims are not meant to be limiting. Other embodiments may be utilized, and other changes may be made, without departing from the spirit or scope of the subject matter presented here.

The emergence of portable computing devices (e.g., laptop computers, computer tablets, digital music players, personal navigation systems, net books, smart phones, personal digital assistants (“PDAs”), digital still cameras, digital video cameras, and handheld game devices, e.g., PlayStation Portable and Nintendo 3DS) into all segments of society over the last two decades has resulted in vast socioeconomic benefits generally enriching the lives of those who choose to take advantage of the benefits that such devices provide. The rise in the portability of such devices has provided a wealth of information available to a user.

In addition, the promulgation of portable electronic devices, each having their own set of unique sensors and detectors, has been widespread. Currently, there are very few populated areas of developed countries which do not contain a large number of portable computing devices at any given time. These portable computing devices are constantly collecting data, and capable of collecting data, which is not stored in any repository or transmitted to any device which may use such data. Thus, such data, and opportunity to collect data, may be lost.

In accordance with various embodiments, computationally implemented methods, systems, circuitry, articles of manufacture, and computer program products are designed to, among other things, provide an interface for receiving request data including a request to carry out a task of acquiring data, acquiring one or more subtasks related to the task of acquiring data, selecting two or more discrete interface devices based on at least one of a status of the two or more discrete interface devices and a characteristic of the two or more discrete interface devices, transmitting at least one of the one or more subtasks to at least two of the two or more discrete interface devices, and receiving result data corresponding to a result of at least one subtask of the one or more subtasks executed by at least one of the two or more discrete interface devices.

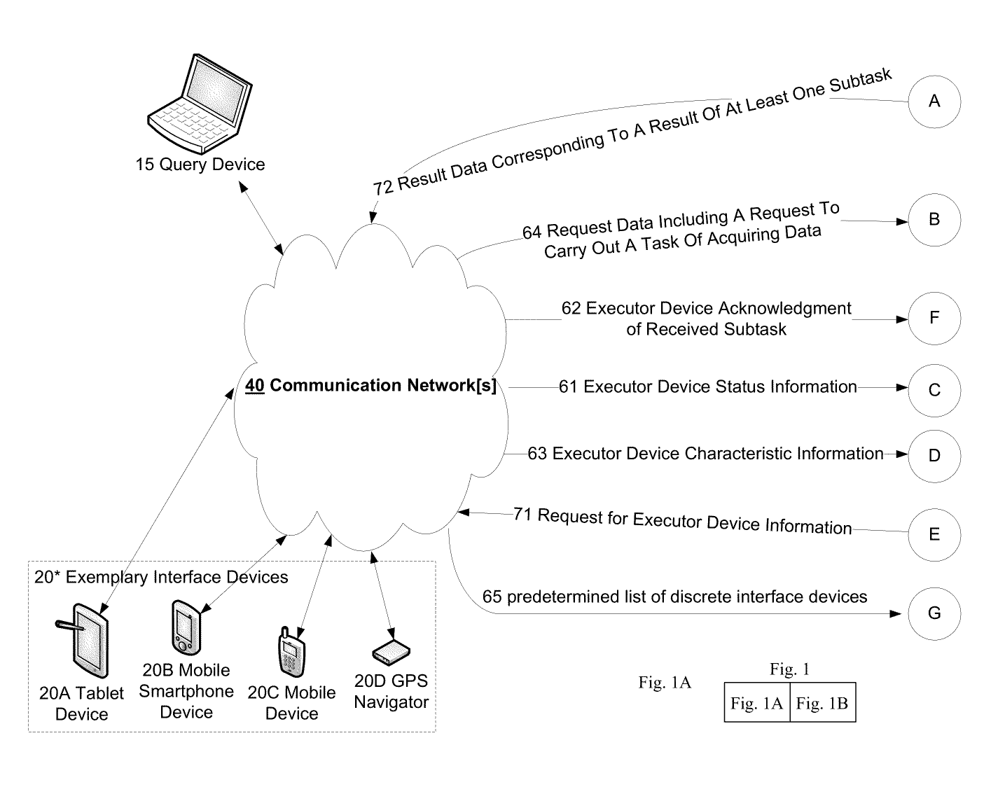

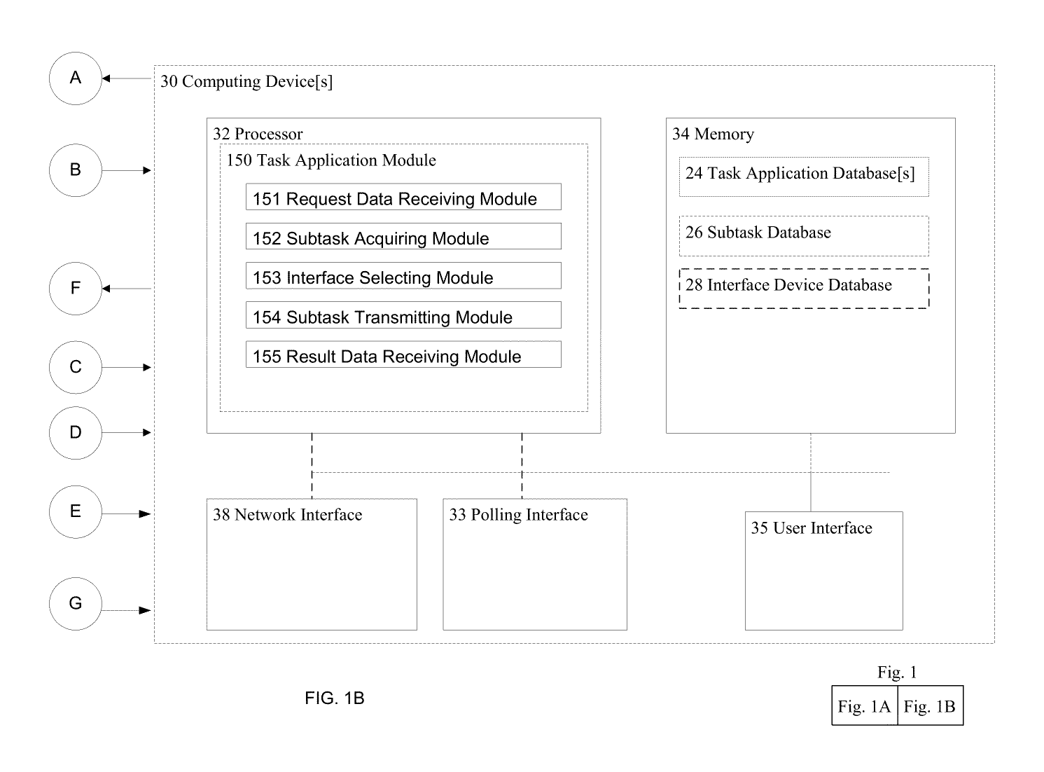

FIG. 1 illustrates an example environment 100 in which the methods, systems, circuitry, articles of manufacture, and computer program products in accordance with various embodiments may be implemented by computing device 30. It is noted that, in the context of this application, “computing device 30” means “computing device 30.” Specifically, FIG. 1 illustrates an operational flow 400 representing example operations for, among other things, interfacing with a system of interface devices to carry out a task by acquiring one or more subtasks related to the task, and transmitting the subtasks to two or more discrete interface devices for execution.

In some embodiments, the computing device 30 may be a network device such as a server. Alternatively, the computing device 30 may be a plurality of network devices such as a plurality of network computers, servers, and storage devices. The one or more computing devices are connected via a communications network 40.

Note that in the following description, the character “*” represents a wildcard. Thus, references to, for example, executor devices 20* of FIG. 1 may be in reference to discrete interface device 20a, discrete interface device 20b, and discrete interface device 20c. Within the context of this application, “discrete interface device” is defined as an “interface device capable of operating or being operated independently of other discrete interface devices.” The discrete interface devices may be completely unaware of each other, and are not necessarily the same type. For example, FIG. 1 illustrates discrete interface device 20A as a tablet, discrete interface device 20B as a PDA, and discrete interface device 20C as a cellular telephone. These drawings are meant to be illustrative only, and should not be construed as limiting the definition of discrete interface devices 20*, which can be any device with computing functionality. For example, discrete interface devices 20* include but are not limited to laptop computers, computer tablets, digital music players, personal navigation systems, net books, smart phones, PDAs, digital still cameras, digital video cameras, vehicle assistance systems, and handheld game devices. For the purposes of this application, the type of interface device is not important, except that it can communicate with a communications network, and that it has device characteristics and status, as will be described in more detail herein.

In some implementations described herein, logic and similar implementations may include software or other control structures. Electronic circuitry, for example, may have one or more paths of electrical current constructed and arranged to implement various functions as described herein. In some implementations, one or more media may be configured to bear a device-detectable implementation when such media hold or transmit a device detectable instructions operable to perform as described herein. In some variants, for example, implementations may include an update or modification of existing software or firmware, or of gate arrays or programmable hardware, such as by performing a reception of or a transmission of one or more instructions in relation to one or more operations described herein. Alternatively or additionally, in some variants, an implementation may include special-purpose hardware, software, firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Alternatively or additionally, implementations may include executing a special-purpose instruction sequence or invoking circuitry for enabling, triggering, coordinating, requesting, or otherwise causing one or more occurrences of virtually any functional operations described herein. In some variants, operational or other logical descriptions herein may be expressed as source code and compiled or otherwise invoked as an executable instruction sequence. In some contexts, for example, implementations may be provided, in whole or in part, by source code, such as C++, or other code sequences. In other implementations, source or other code implementation, using commercially available and/or techniques in the art, may be compiled/implemented/translated/converted into a high-level descriptor language (e.g., initially implementing described technologies in C or C++ programming language and thereafter converting the programming language implementation into a logic-synthesizable language implementation, a hardware description language implementation, a hardware design simulation implementation, and/or other such similar mode(s) of expression). For example, some or all of a logical expression (e.g., computer programming language implementation) may be manifested as a Verilog-type hardware description (e.g., via Hardware Description Language (HDL) and/or Very High Speed Integrated Circuit Hardware Descriptor Language (VHDL)) or other circuitry model which may then be used to create a physical implementation having hardware (e.g., an Application Specific Integrated Circuit). Those skilled in the art will recognize how to obtain, configure, and optimize suitable transmission or computational elements, material supplies, actuators, or other structures in light of these teachings.

The computing device 30 may communicate via a communications network 40. In various embodiments, the communication network 40 may include one or more of a local area network (LAN), a wide area network (WAN), a metropolitan area network (MAN), a wireless local area network (WLAN), a personal area network (PAN), a Worldwide Interoperability for Microwave Access (WiMAX), public switched telephone network (PTSN), a general packet radio service (GPRS) network, a cellular network, and so forth. The communication networks 40 may be wired, wireless, or a combination of wired and wireless networks. It is noted that “communication network” here refers to communication networks, which may or may not interact with each other.

Communications between the computing device 30 and the communications network 40 may be facilitated by the network interface module 38, which may be implemented as hardware or software, or both, used to interface the computing device 30 with the one or more communication networks 40. In some embodiments, the network interface module 38 may be a Network Interface Card, e.g., a NIC. The specific structure of network interface module 38 depends on the type or types of one or more communication networks 40 that are used. Particular details of this transmission will be discussed in more detail herein.

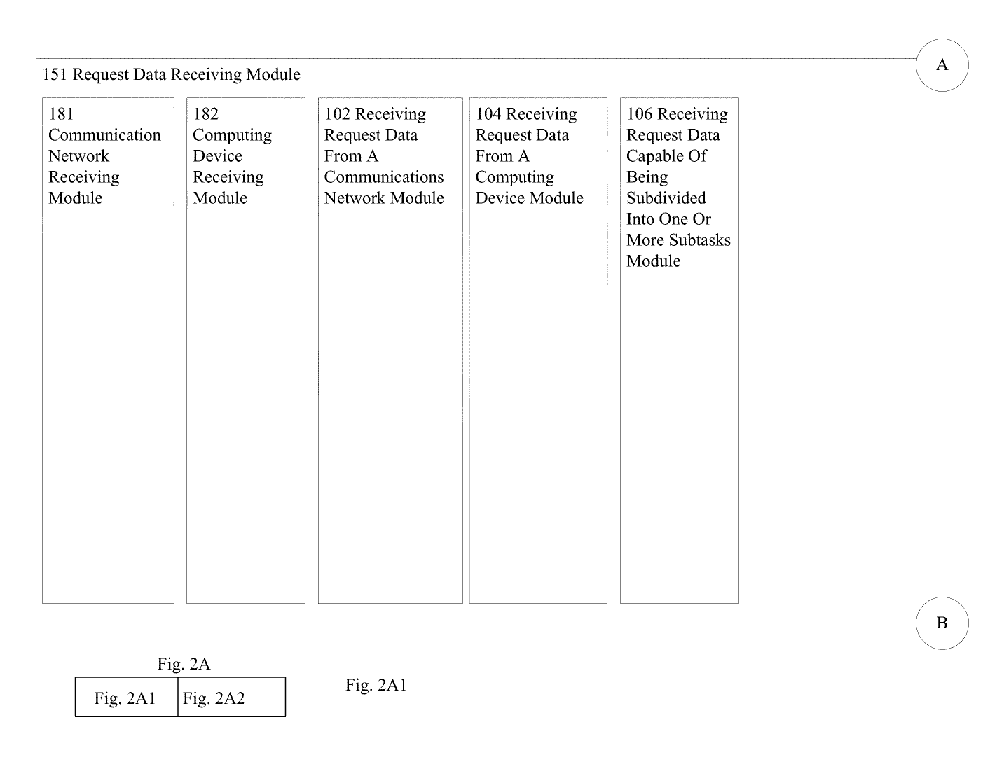

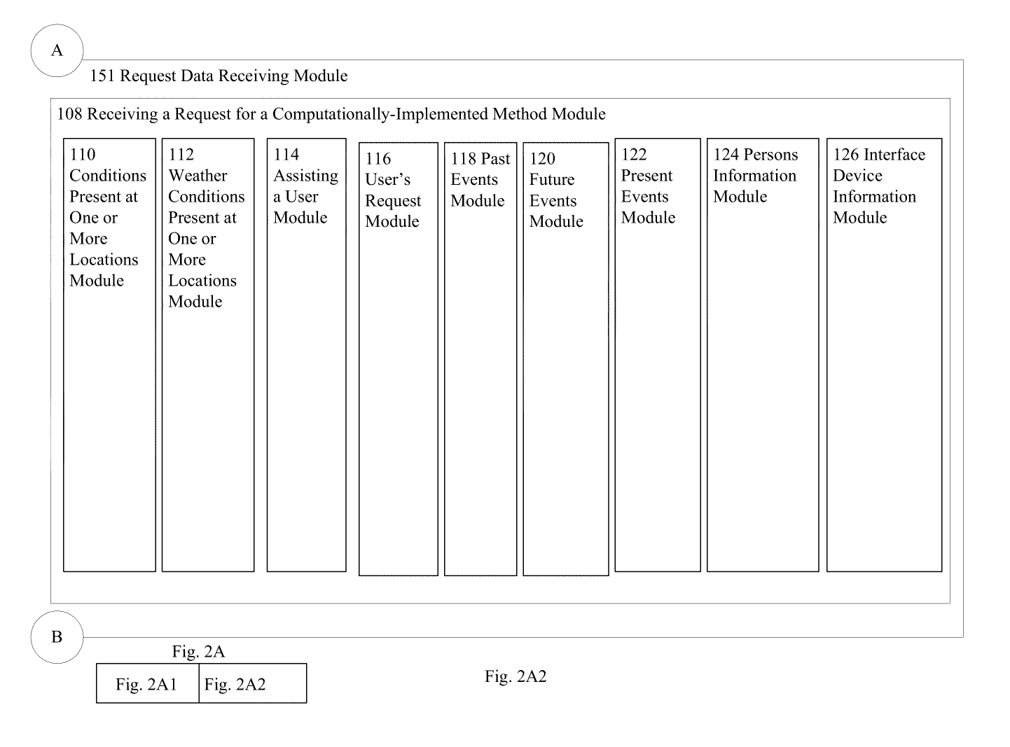

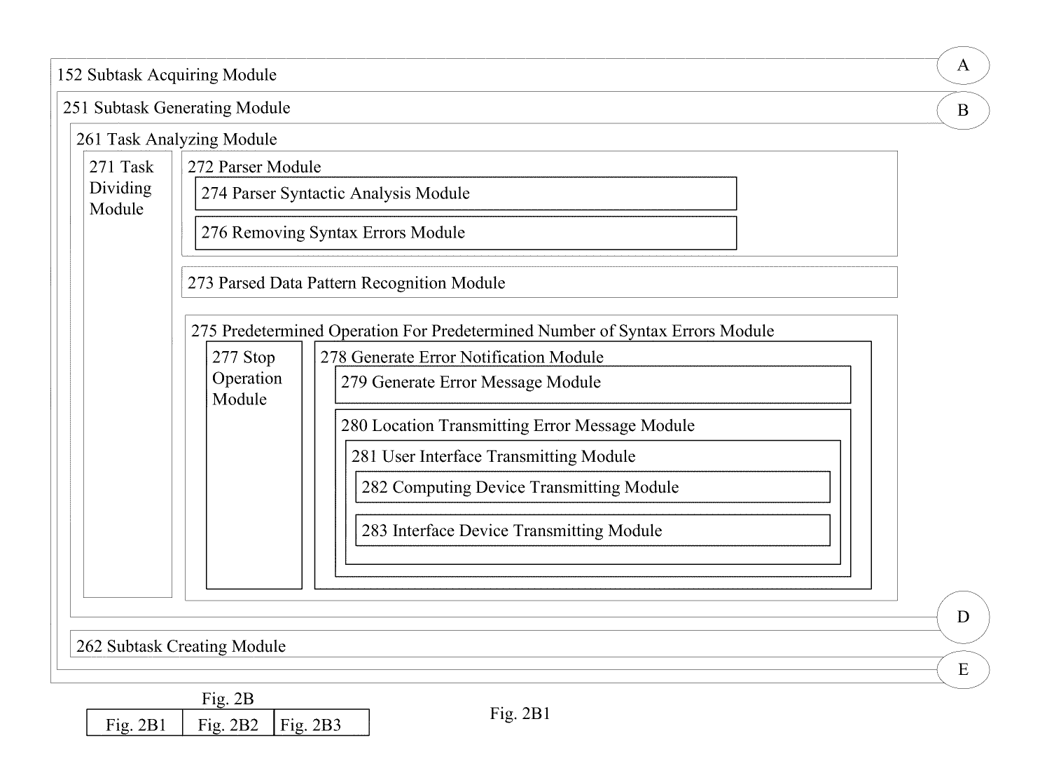

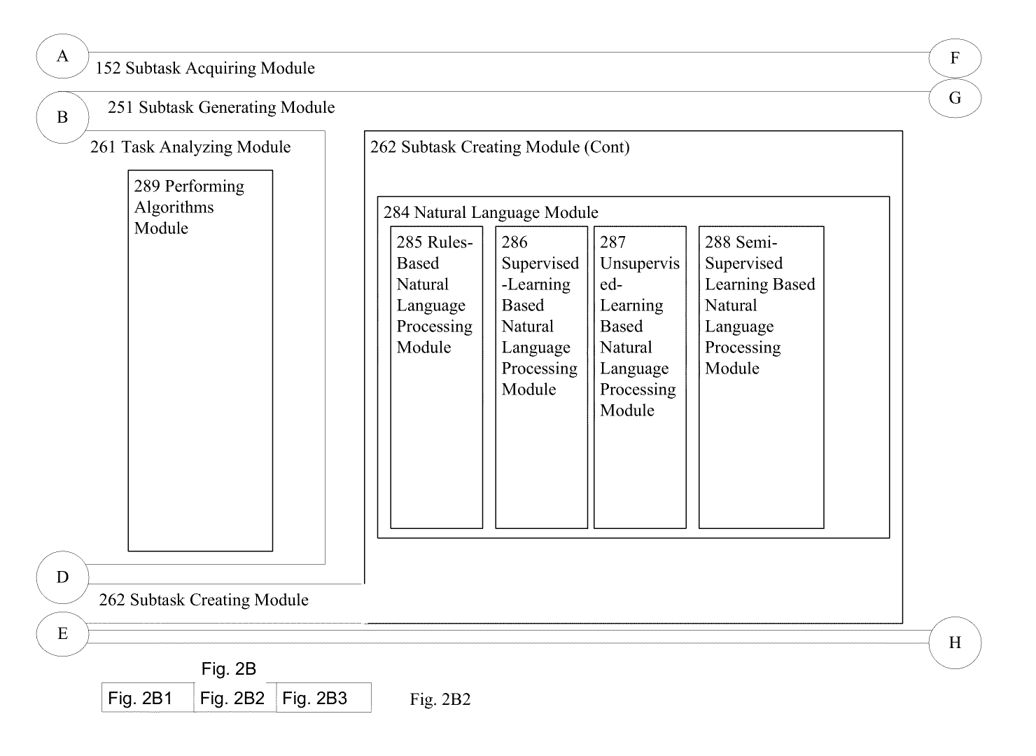

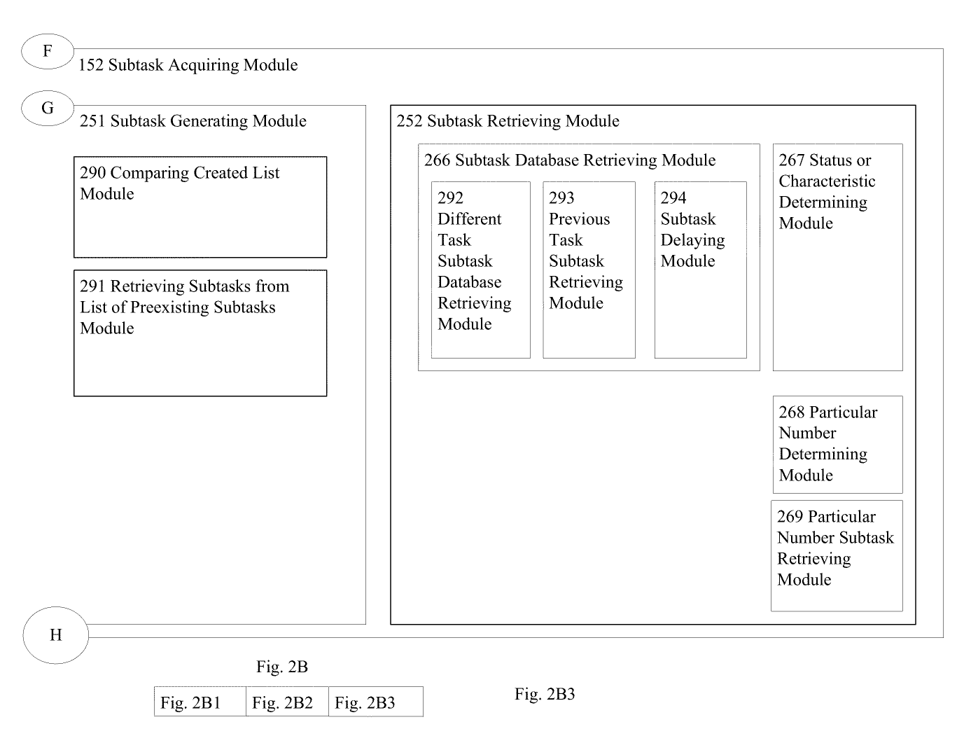

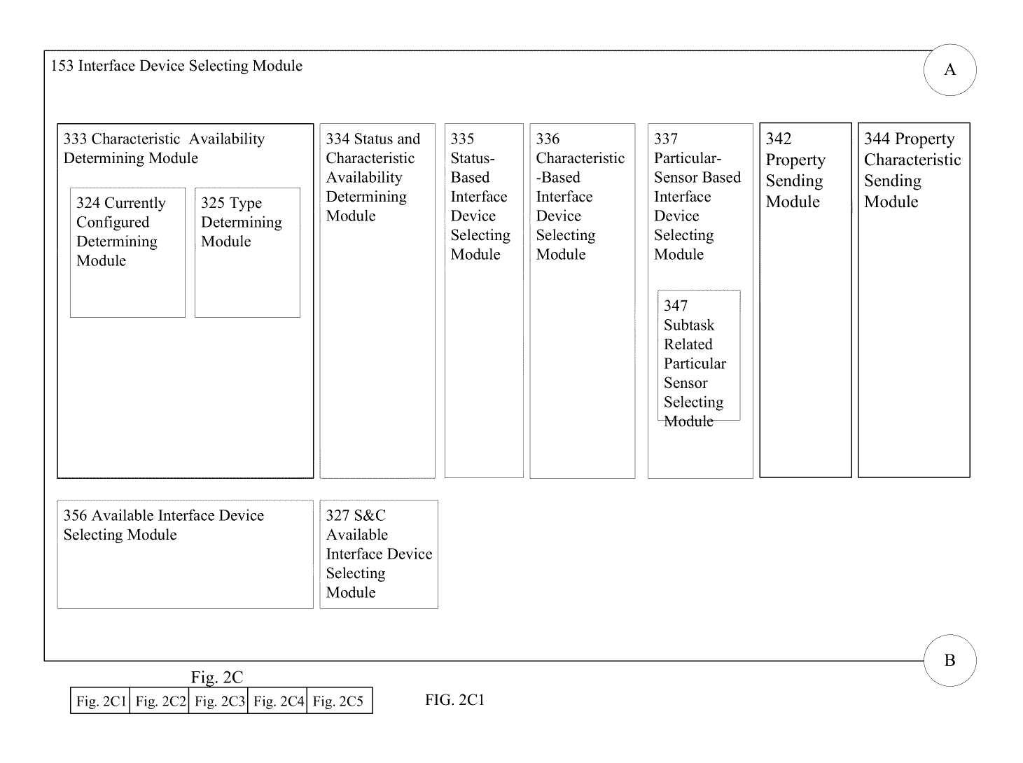

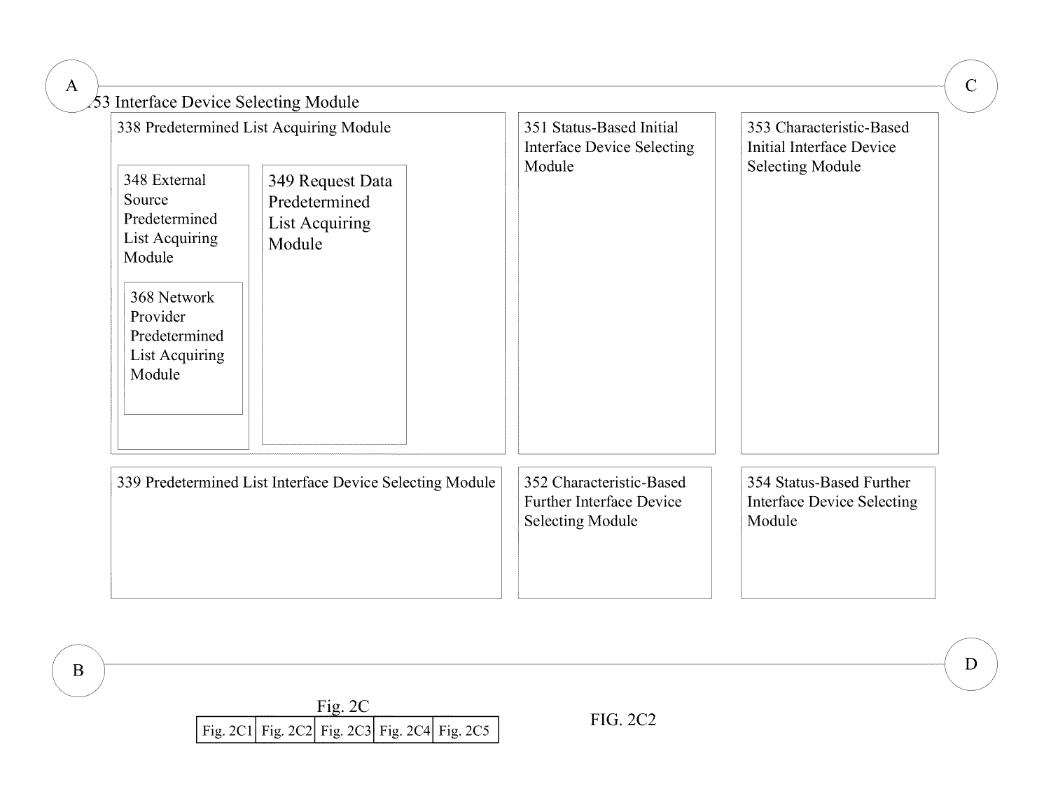

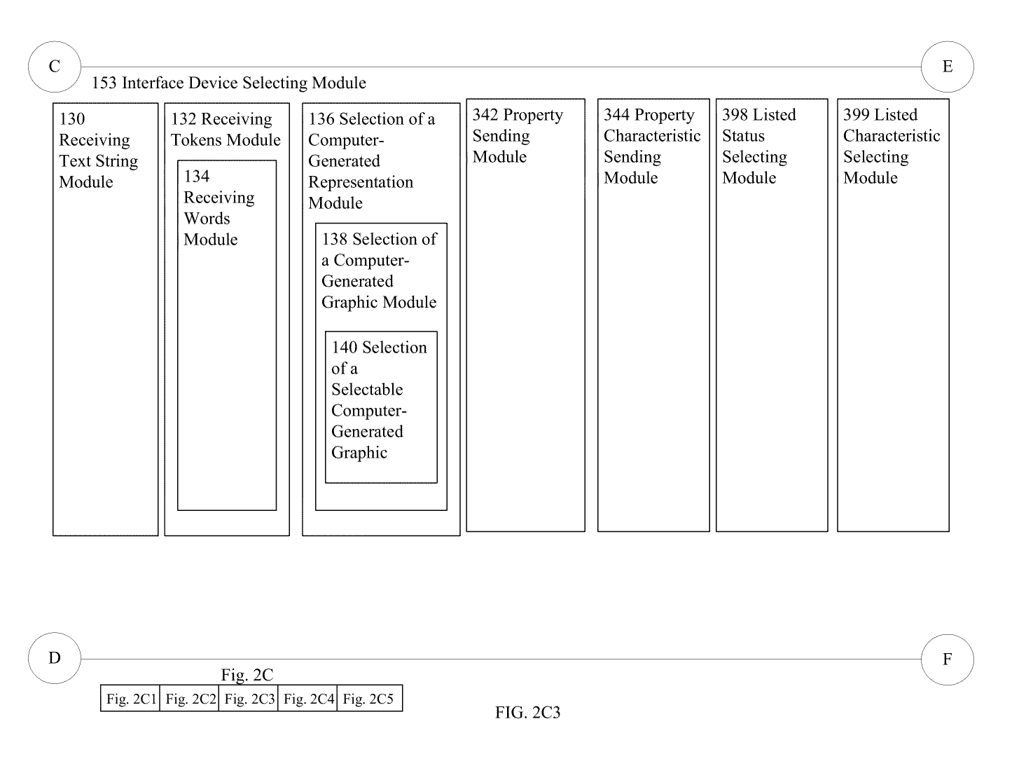

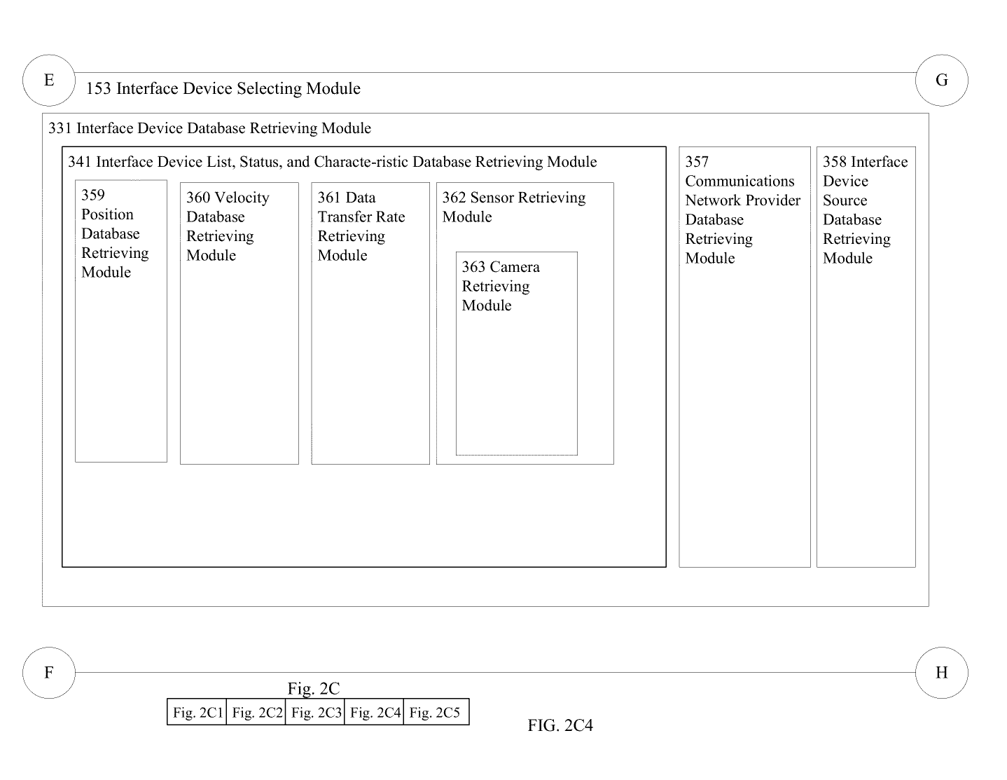

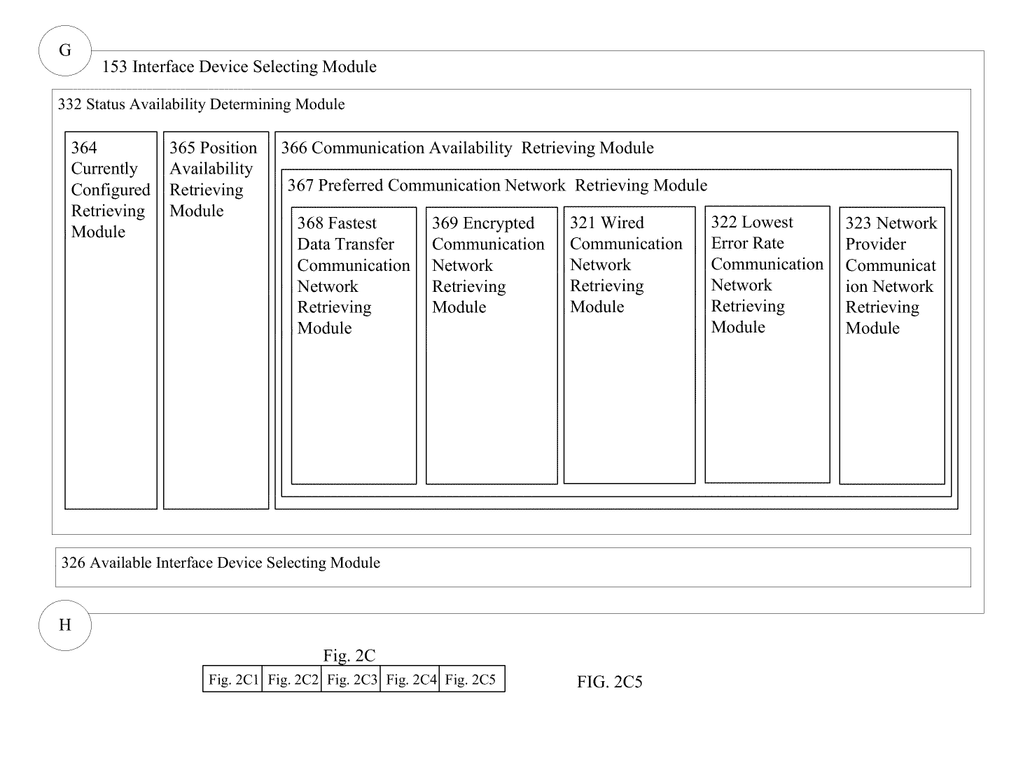

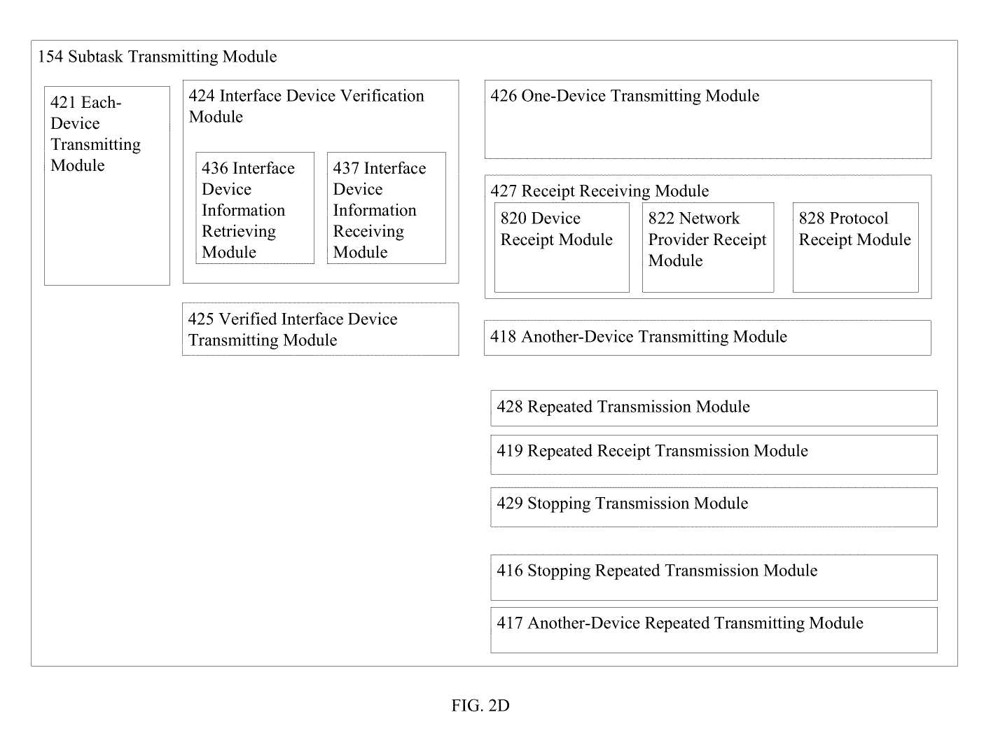

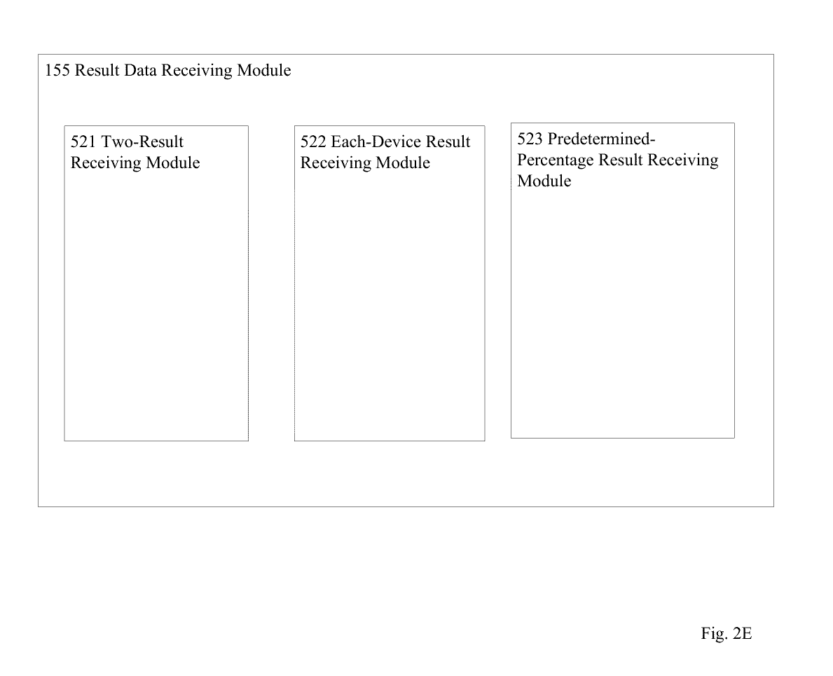

Referring again to the example environment 100 of FIG. 1, in various embodiments, the computing device 30 may comprise, among other elements, a processor 32, a memory 34, a network interface 38, a polling interface 33, and a user interface 35. As shown in environment 100 of FIG. 1, and FIG. 2A, task application module 150 is configured to receive request data including a request to carry out a task of acquiring data 64, executor device acknowledgement of received subtask 64, and executor device status information 61, executor device characteristic information 63. Task application module 150 also is configured to transmit a request for executor device information 71, and result data corresponding to a result of at least one subtask 72. A more detailed discussion related to the communication of the computing device 30 with the query device 15 and the executor devices 20*, including the submodules of task application module 150, will be provided below with respect to the operations and processes to be described herein.

Referring to FIG. 2A, task application module 150 comprises a request data receiving module 151 shows receiving request data including a request to carry out a task of acquiring data, subtask acquiring module 152 shows acquiring one or more subtasks related to the task of acquiring data, interface device selecting module 153 shows selecting two or more discrete interface devices based on at least one of a status of the two or more discrete interface devices and a characteristic of the two or more discrete interface devices, subtask transmitting module 154 shows transmitting at least one of the one or more subtasks to at least two of the two or more discrete interface devices, and result data receiving module 155 for receiving result data corresponding to a result of at least one subtask of the one or more subtasks executed by at least one of the two or more discrete interface devices. These modules are illustrated in environment 100 of FIG. 1 as a part of processor 32, however, this is for illustration purposes only. Each of the modules may reside on a number of processors and/or memories that are part of the one or more computing devices. The modules may be executed on distributed or parallel processors or cores, and implemented across processors that are remote. In various embodiments, the various modules included in the computing device 30 including the task application module 150, the request data receiving module 151, the subtask acquiring module 152, the interface device selecting module 153, the subtask transmitting module 154, and the result data receiving module 155, and their sub-modules (as depicted in FIGS. 2A, 2B, 2C, 2D, and 2E), may be implemented using hardware (e.g., circuitry), software, firmware, or any combination thereof.

For example, in some embodiments, the task application module 150, the request data receiving module 151, the subtask acquiring module 152, the interface device selecting module 153, the subtask transmitting module 154, and the result data receiving module 155, and their sub-modules may be implemented using hardware such as specially designed circuitry including, for example, application specific integrated circuit or ASIC. Alternatively, the task application module 150, the request data receiving module 151, the subtask acquiring module 152, the interface device selecting module 153, the subtask transmitting module 154, and the result data receiving module 155, and their sub-modules may be implemented using software in the form of computer readable instructions that is executed by one or more processors. In still other embodiments, the task application module 150, the request data receiving module 151, the subtask acquiring module 152, the interface device selecting module 153, the subtask transmitting module 154, and the result data receiving module 155, and their sub-modules may be implemented using a combination of hardware and software such as when the task application module 150, the request data receiving module 151, the subtask acquiring module 152, the interface device selecting module 153, the subtask transmitting module 154, and the result data receiving module 155, and their sub-modules are implemented using Field Programmable Gate Arrays or FPGAs. In the illustrated embodiment, FIG. 1 depicts the hardware implementation of the computing device 40. That is, the task application module 150, the request data receiving module 151, the subtask acquiring module 152, the interface device selecting module 153, the subtask transmitting module 154, and the result data receiving module 155, and their sub-modules are each depicted as being implemented by circuits that along with the network interface 38 and the memory 34 that may be coupled together by, for example, a bus.

For ease of illustration and understanding, FIG. 1 illustrates a single device embodiment of computing device 30 (e.g., meaning that the computing device 30 that is depicted in FIG. 1 is depicted as being embodied in a single network component device such as a single server rather than being embodied by multiple servers as in the case of cloud computing). In other embodiments, however, the computing device 30 may be implemented using multiple network component devices (e.g., multiple servers) located at multiple network sites such as in the case in cloud or distributed computing. In addition, although FIG. 1 illustrates only the hardware embodiment of the computing device 30, in other embodiments, the task application module 150, and sub-modules as illustrated in FIGS. 1B, 2A, 2B, 2C, 2D, and 2E, may also be implemented using software, firmware, or any combination of hardware, software, and firmware. Further, one or more of the modules of the computing device 30, including the request data receiving module 151, the subtask acquiring module 152, the interface device selecting module 153, the subtask transmitting module 154, and the result data receiving module 155, may be located at different network sites as is the case in cloud computing.

As described above, the computing device 30 may comprise a memory 34. In some embodiments, memory 34 may comprise of one or more of one or more mass storage devices, read-only memory (ROM), programmable read-only memory (PROM), erasable programmable read-only memory (EPROM), cache memory such as random access memory (RAM), flash memory, synchronous random access memory (SRAM), dynamic random access memory (DRAM), and/or other types of memory devices. In some embodiments, memory 34 may be located at a single network site. In other embodiments, memory 140 may be located at multiple network sites, including sites that are distant from each other. In the embodiment shown in FIG. 1B, memory 34 is shown as including a task application database 24 and a subtask database 26, which will be described in more detail herein. These portions of memory 34 are shown for illustration purposes only, and in other embodiments may be omitted or modified, depending upon the implementation.

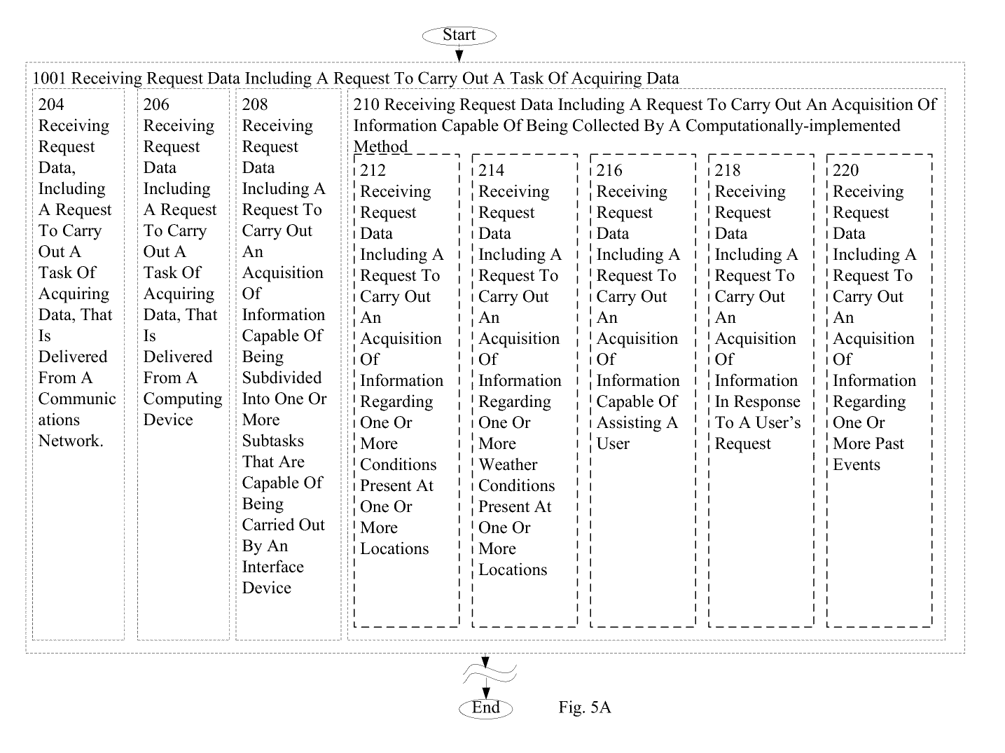

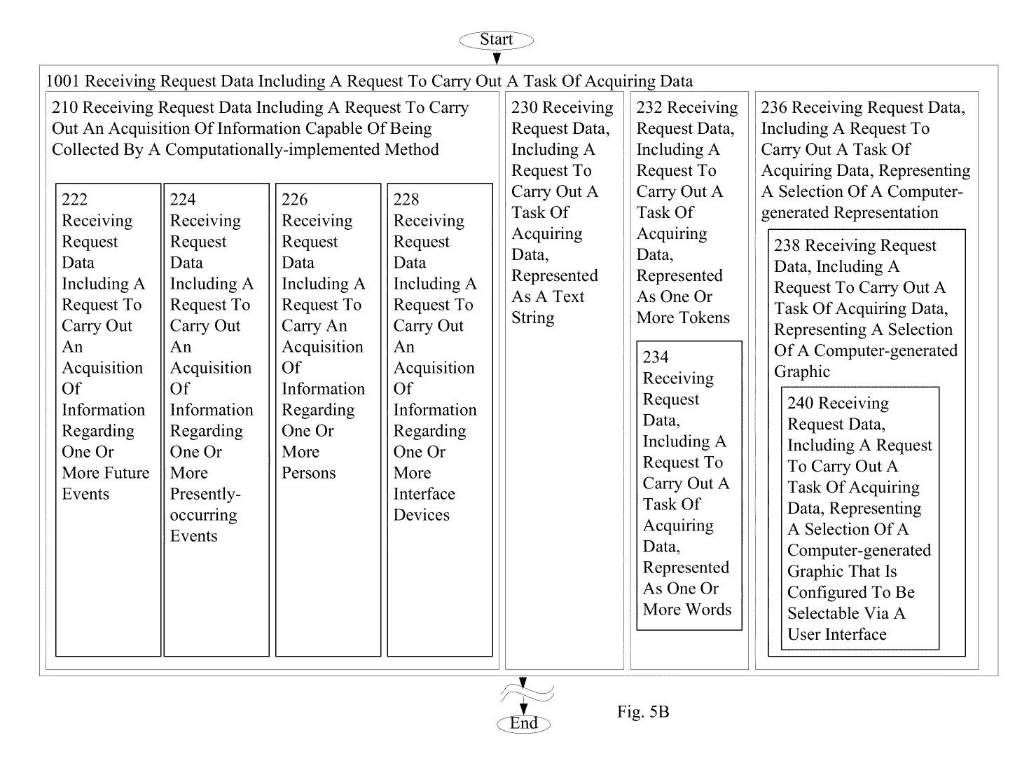

Computing device 30 also may include a processor 32. Processor 32 may include one or more microprocessors, Central Processing Units (“CPU”), a Graphics Processing Units (“GPU”), Physics Processing Units, Digital Signal Processors, Network Processors, Floating Point Processors, and the like. In some embodiments, processor 32 may be a server. In some embodiments, processor 32 may be a distributed-core processor. Although processor 32 is depicted as a single processor that is part of a single computing device 30, in some embodiments, processor 32 may be multiple processors distributed over one or many computing devices 30, which may or may not be configured to work together. Processor 32 is illustrated as being configured to execute computer readable instructions in order to execute one or more operations described above, and as illustrated in FIGS. 5, 6A-6C, 7A-7D, 8A-8C, and 9. In some embodiments, processor 32 is designed to be configured to operate as the task application module 150, which may include request data receiving module 151, subtask acquiring module 152, interface selecting module 153, subtask transmitting module 154, and result data receiving module 155.

As described above, and with reference to FIG. 1, computing device 30 may include a polling interface 33. Polling interface 33 may be implemented in hardware, or software, or both, and may communicate with the communication network 40 in order to poll devices, e.g., interface devices. Polling interface 33 may be similar to network interface 38, with the additional functionality of polling interface devices 20*, as well as listening for interface devices 20* that may be attempting to communicate with computing device 30.

As described above, and with reference to FIG. 1, computing device 30 may include a user interface 35. The user interface may be implemented in hardware or software, or both, and may include various input and output devices to allow an operator of a computing device 30 to interact with computing device 30. For example, user interface 35 may include, but is not limited to, an audio display, a video display, a microphone, a camera, a keyboard, a mouse, a joystick, a game controller, a touchpad, a handset, or any other device that allows interaction between a computing device and a user.

The following paragraphs describe in more detail the implementations of the task application module in FIGS. 2A-2E. These implementations are meant to be exemplary only, and in other embodiments, the task application module 150 may be implemented in any manner that allows the task application module to perform some or all of the various procedures described herein. The following is an abbreviated description of the operations and implementations of the various layouts of the modules comprising some embodiments of the task application module 150. More detailed descriptions will be provided further herein with respect to the operations carried out by the various modules. For example, FIG. 2A shows a particular implementation of the request data receiving module 151 shown in FIG. 1. As illustrated in FIG. 2A, the request data receiving module 151 may include one or more sub-modules in various alternative implementations. For example, in some embodiments, the request data receiving module 151 may include a communications network receiving module 181 configured to at least receive request data including a request to carry out a task of acquiring data from a communications network 40, via one or more of network interface 38 and polling interface 33. In some embodiments, the request data receiving module 151 may include a computing device receiving module 182 configured to at least receive request data delivered from a computing device. For example, the request data receiving module 151 may communicate with user interface 35, which may be an interface where an operator of computing device 30 may enter request data that includes a request to carry out a task of acquiring data. In this manner, the request data receiving module 151 may receive request data including a request to carry out a task of acquiring data without communicating with communication network 40.

FIG. 2B shows a particular implementation of the subtask acquiring module 152 shown in FIG. 1. As illustrated in FIG. 2B, the subtask acquiring module 152 may include one or more sub-modules in various alternative implementations. For example, in some embodiments, the subtask acquiring module may include a subtask generating module 251 for generating subtasks. In some embodiments, the subtask acquiring module 152 may include a subtask retrieving module 252 shows retrieving subtasks, e.g., from a database 26 in memory 34, from some other location, or from the communication network 40. In some embodiments, the subtask generating module 251 may include a task analyzing module 261, which task analyzing module 261 may further include a task dividing module 271. Subtask generating module 251 includes a task analyzing module 261, subtask generating module 251 also may include a subtask creating module 262 that creates subtasks, which in some embodiments is based on the analysis performed by the task analyzing module 261. In some embodiments, the subtask generating module 251 may include a task analyzing and deconstructing module 263, which may analyze the task by deconstructing the task into component subtasks. In some embodiments, the subtask generating module 251 may include a comparing subtasks module 264, which may compare subtasks used to carry out a task with subtasks that previously have been created. Subtask generating module 251 includes a comparing subtasks module 264, subtask generating module 251 also may comprise a retrieving compared subtasks module 265. In some embodiments, retrieving compared subtasks module 265 retrieves the subtasks matched by comparing subtasks module 264.

As described above, and as illustrated in FIG. 2B, the subtask acquiring module 152 may include a subtask retrieving module 252 shows retrieving subtasks, e.g., from a database 26 in memory 34, from some other location, or from the communication network 40. In some embodiments, subtask retrieving module 252 may include a subtask database retrieving module 266, which may retrieve subtasks from various types of databases. In some embodiments, the subtask database retrieving module 266 may include a different-task subtask database retrieving module 272 shows retrieving subtasks that were previously generated for a different task of acquiring information data. In some embodiments, the subtask database retrieving module 266 may include a previous-task subtask retrieving module 273 retrieving subtasks that were previously generated for a task of acquiring data. In some embodiments, the subtask database retrieving module 266 may include a subtask delaying module 274 for delaying transmission of subtasks.

In some embodiments, as illustrated in FIG. 2B, the subtask retrieving module 252 may include a status or characteristic determining module 267 for determining a status or characteristic of one or more interface devices 20*. In some embodiments, in which the subtask retrieving module 252 includes a status or characteristic determining module 267, the subtask retrieving module 252 also may include a particular number determining module 268 which may determine a particular number of subtasks to retrieve, and a particular number subtask retrieving module 269 which retrieves the particular number of subtasks.

FIG. 2C shows a particular implementation of the interface device selecting module 153 shown in FIG. 1. As illustrated in FIG. 2C, the interface device selecting module 153 may include one or more sub-modules in various alternative implementations. For example, in some embodiments, as shown in FIG. 2C, the interface device selecting module 153 may include an interface device database retrieving module for retrieving interface devices 20*, and in some embodiments, information about those interface devices 20* from a database, e.g., interface device database 28. In some embodiments, as shown in FIG. 2C, the interface device database retrieving module 331 may include an interface device list, status, and characteristic database retrieving module 341, for retrieving interface devices and status and characteristic information about the interface devices. In some embodiments, as shown in FIG. 2C, the interface device selecting module 153 may include a status availability determining module 332 shows determining availability of interface devices based on at least one status of the interface devices 20*. Similarly, in some embodiments, as shown in FIG. 2C, the interface device selecting module 153 may include a characteristic availability determining module 333 for determining availability of interface devices based on at least one characteristic of the interface devices 20*. In some other embodiments, as shown in FIG. 2C, the interface device selecting module 153 may include a status and characteristic availability module 334 for determining availability of interface devices based on at least one characteristic of the interface devices 20* and at least one status of the interface devices 20*. In embodiments which the interface device selecting module 153 includes one or more of the a characteristic availability determining module 333, status availability determining module 332, and status and characteristic availability module 334, interface device selecting module 153 also may include an available interface device selecting module 356 for selecting interface devices 20* from the available interface devices 20* as shown in FIG. 2C.

In some embodiments, as shown in FIG. 2C, interface device selecting module 153 may include a status-based interface device selecting module 335 for selecting interface devices 20* based on at least one status of the interface devices 20*. Similarly, in some embodiments, as shown in FIG. 2C, interface device selecting module 153 may include a characteristic-based interface device selecting module 336 for selecting interface devices 20* based on at least one status of the interface devices 20*. In some embodiments, as shown in FIG. 2C, interface device selecting module 153 may include a may include a particular-sensor based interface device selecting module 337 for selecting interface devices 20* based on a particular sensor present at the interface devices 20. In some embodiments, as shown in FIG. 2C, particular-sensor based interface device selecting module 337 may further include subtask-related particular sensor selecting module 347 for selecting interface devices 20* that have one or more particular sensors configured to carry out at least a portion of one or more subtasks.

In some embodiments, as shown in FIG. 2C, interface device selecting module 153 may include a predetermined list acquiring module 338 for acquiring, e.g., retrieving or generating, a predetermined list of discrete interface devices. In some embodiments in which interface device selecting module 153 includes a predetermined list acquiring module 338, predetermined list acquiring module 338 may further include an external source predetermined list acquiring module 348, as shown in FIG. 2C, for acquiring a predetermined list from an external source. In some embodiments in which predetermined list acquiring module 338 includes an external source predetermined list acquiring module 348, external source predetermined list acquiring module 348 may include a network provider predetermined list acquiring module 368, as shown in FIG. 2C, for acquiring a predetermined list from a network provider. In some embodiments in which interface device selecting module 153 includes a predetermined list acquiring module 338, predetermined list acquiring module 338 may further include a request data predetermined list acquiring module 349, as shown in FIG. 2C, for acquiring a predetermined list from the request data received by the request data receiving module 151. In some embodiments in which interface device selecting module 153 includes a predetermined list acquiring module 338, as shown in FIG. 2C, interface device selecting module 153 also may include a predetermined list interface device selecting module 339 for selecting interface devices from the predetermined list.

In some embodiments, as shown in FIG. 2C, interface device selecting module 153 may include a status-based initial interface selecting device module 351 for selecting interface devices 20* based on a status. In some embodiments, in which interface device selecting module 153 includes a status-based initial interface selecting device module 351 as shown in FIG. 2C, interface device selecting module 153 also may include characteristic-based further interface device selecting module 352 shows further selecting interface devices 20* based on a characteristic. In some embodiments, as shown in FIG. 2C, interface device selecting module 153 may include a characteristic-based initial interface selecting device module 353 for selecting interface devices 20* based on a characteristic. In some embodiments, in which interface device selecting module 153 includes a characteristic-based initial interface selecting device module 353 as shown in FIG. 2C, interface device selecting module 153 also may include status-based further interface device selecting module 354 for further selecting interface devices 20* based on a status.

FIG. 2D shows a particular implementation of the subtask transmitting module 154 shown in FIG. 1. As illustrated in FIG. 2D, the subtask transmitting module may include one or more sub-modules in various alternative implementations. In some embodiments, subtask transmitting module 154 may include each-device transmitting module 421 for transmitting subtasks to each of the selected interface devices 20*. In some embodiments, as shown in FIG. 2D, subtask transmitting module 154 may include single-subtask transmitting module 154 for transmitting a single subtask to each of the selected interface devices 20*. In some embodiments, as shown in FIG. 2D, subtask transmitting module 154 may include only-two-devices transmitting module 423 for transmitting subtasks to only two interface devices 20*. In some embodiments, as shown in FIG. 2D, subtask transmitting module 154 may include an interface device verification module 424 for verifying data regarding one or more interface devices 20*. In some embodiments. in which subtask data transmitting module 154 includes interface device verification module 424, interface device verification module 424 may further include interface device information retrieving module 436, as shown in FIG. 2D, for retrieving interface device information about one or more interface devices 20* from an interface device database, e.g., interface device database 28.

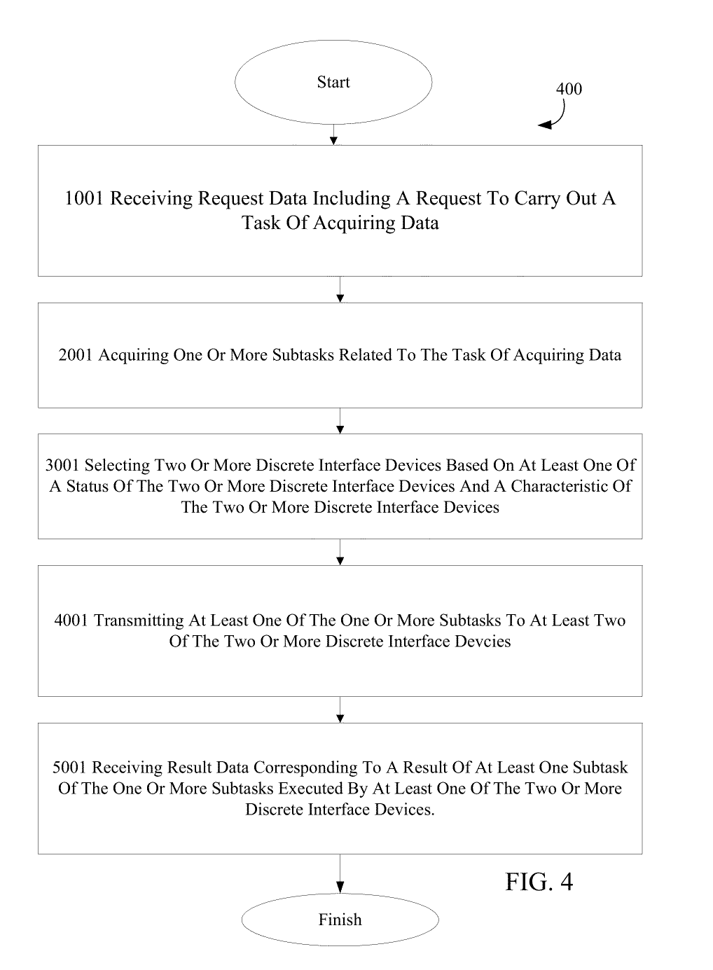

In some cases, a “user” is a representation of a person operating an electronic device, e.g., a portable computing device, or a non-portable computing device, e.g., a desktop computer, an information kiosk, or a terminal, e.g., an ATM terminal. In another embodiment, however, a user is merely a representation of someone making a request. For example, a user may be an automated program that sends a request to carry out a task of acquiring data. For example, and in some embodiments, an automated weather tracking station may send out a request for the temperature and barometric pressure in a particular geographic area, e.g., a zip code, each day at the same time. As will be further described with reference to FIG. 4, the operational flow 400 may be executed in a variety of different ways in various alternative implementations, which will be discussed in more detail herein.

Following are a series of flowcharts depicting implementations. For ease of understanding, the flowcharts are organized such that the initial flowcharts present implementations via an example implementation and thereafter the following flowcharts present alternate implementations and/or expansions of the initial flowchart(s) as either sub-component operations or additional component operations building on one or more earlier-presented flowcharts. Those having skill in the art will appreciate that the style of presentation utilized herein (e.g., beginning with a presentation of a flowchart(s) presenting an example implementation and thereafter providing additions to and/or further details in subsequent flowcharts) generally allows for a rapid and easy understanding of the various process implementations. In addition, those skilled in the art will further appreciate that the style of presentation used herein also lends itself well to modular and/or object-oriented program design paradigms.

Further, in FIG. 4 and in the figures to follow thereafter, various operations may be depicted in a box-within-a-box manner. Such depictions may indicate that an operation in an internal box may comprise an optional example embodiment of the operational step illustrated in one or more external boxes. However, it should be understood that internal box operations may be viewed as independent operations separate from any associated external boxes and may be performed in any sequence with respect to all other illustrated operations, or may be performed concurrently. Still further, these operations illustrated in FIG. 4 as well as the other operations to be described herein may be performed by at least one of a machine, an article of manufacture, or a composition of matter.

It is noted that, for the examples set forth in this application, the tasks and subtasks are commonly represented by short strings of text. This representation is merely for ease of explanation and illustration, and should not be considered as defining the format of tasks and subtasks. Rather, in various embodiments, the tasks and subtasks may be stored and represented in any data format or structure, including numbers, strings, Booleans, classes, methods, complex data structures, and the like.

Those having skill in the art will recognize that the state of the art has progressed to the point where there is little distinction left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

With reference now to FIG. 4, shown is operational flow 400. Operation 1001 depicts receiving request data including a request to carry out a task of acquiring data (e.g., request data receiving module 151 of FIG. 1 receiving request data (e.g., “a request to take a picture”) including a request to carry out a task of acquiring data (e.g., “please acquire a near-real time picture of the Eiffel Tower in France”).

In one embodiment, request data receiving module 151 of computing device 30 receives the request data delivered from a communications network 40, as shown in FIG. 1. The request data includes a request to carry out a task, e.g., a query for one or more pieces of information). For example, a task may include a request from a user in Des Moines, Iowa, to receive a real-time picture of the Eiffel Tower in France. As another example, a task may include a request from a user to receive a current panoramic or 360-degree picture of Times Square. The user may be remotely located from Tasks, however, are not limited to pictures. For example, a task may include a request from a user to receive weather conditions, e.g., temperature, humidity, precipitation, cloud cover, and/or barometric pressure, in an area distant from the user. A task also may include a request from a user to receive environmental conditions, e.g., smog levels, allergen levels, and/or toxin levels. A task further may include a request for real-time information about a place, e.g., whether Dan's Grocery has any pomegranates in stock. Tasks also may represent more complex queries. For example, a user may request to know which grocery has the freshest pomegranates in ZIP code 98006, or which route from Seattle, Wash., to Los Angeles, Calif., will expose him to the least smog, based on weather conditions and traffic. Any such query is a task that is received by the request data receiving module 151 of the task application module 150.

In other embodiments of the invention, request data receiving module 151 of FIG. 2A may receive request data including a request to carry out a task of acquiring data from a local source, e.g., a GUI of an interface device. Moreover, the request may take a number of different forms. The request data may be a text-based request, i.e., “take a 360-degree picture of the Eiffel Tower.” The request data may also be a response to a presentation from a GUI, i.e., “option 3,” which may correspond to a 360-degree picture of the Eiffel Tower. The request data may be any combination of these forms, e.g., a response to a presentation from a GUI, i.e., “option 3,” which may correspond to a 360-degree picture, and a text-based request, i.e., “Eiffel Tower.” As will be discussed further herein, the receiving request data operation 101 receives the data. In this example, the request to carry out a task of acquiring data is a request to carry out a task of acquiring data, e.g., a 360-degree picture of the Eiffel Tower.

Referring now to FIG. 4, operation 2001 illustrates acquiring one or more subtasks related to the task of acquiring data. For example, FIG. 2A shows subtask acquiring module 152 acquiring (e.g., retrieving or generating) one or more subtasks (e.g., “take a picture of the Eiffel Tower”) that are related to the task of acquiring data (e.g., “please acquire a near-real time picture of the Eiffel Tower in France”). For the purposes of this application, “acquiring” subtasks is defined as including both “generating” subtasks, e.g., subtasks that are created in response to the receipt of request data for carrying out a task, and “retrieving” subtasks, e.g., retrieving subtasks that were previously created, either to complete other tasks, or for efficiency or other reasons.

For instance, and as an illustration, if the received task is “Take a 360 degree picture of the Eiffel Tower,” then this task may be divided into fifty subtasks of “take a picture of the Eiffel Tower.” These subtasks, when distributed to the interface devices, as will be discussed in more detail herein, will be executed, and the data resulting from the tasks, i.e., the pictures taken by the interface devices 20*, will be received by the task application module, and combined to create the 360 degree picture. As another example, the received task may be “calculate the fastest route to drive from the Sears Tower downtown Chicago to Interstate 90 at the present time.” For this task, the subtask acquiring module 152 may acquire subtasks including “report the position of the interface device and determine the velocity,” and these subtasks may be distributed to the proper areas, as will be discussed in more detail herein. As yet another example, the received task may be “Please find a geographic location in downtown Washington D.C., within six blocks of the White House that has the strongest wireless interne signal.” For this task, the subtask acquiring module 152 may acquire subtasks including “report the strength of the strongest wireless signal you are receiving,” and send that task to interface devices 20* that are positioned within six blocks of the White House, and which have wireless radios. As still another example, a task may be “map a route from the Space Needle to the Fisherman's Market that has the least exposure to allergens.” For this task, the subtask acquiring module 152 may acquire subtasks including “report the allergen levels in the vicinity.” These examples are meant to be illustrative of subtasks, and not exhaustive. The details of acquiring the subtasks will be described in more detail herein.

With reference now to FIG. 4, operation 3001 shows selecting two or more discrete interface devices based on at least one of a status of the two or more discrete interface devices and a characteristic of the two or more discrete interface devices. For example, FIG. 1 shows module 153 of selecting two or more discrete interface devices (e.g. mobile smart phone device 20B and mobile device 20C) based on at least one of a status (e.g., a location of the smart phone device 20B and mobile device 20C, for example, “within 200 meters of the Eiffel Tower in France”) of the two or more discrete interface devices and a characteristic (e.g., “has a camera of at least 5.0 megapixel quality”) of the two or more discrete interface devices. Within the context of this application, “discrete interface devices” means “interface devices capable of operating or being operated independently of each other.” The discrete interface devices may be two cellular telephones, for example, or one GPS device and one cellular telephone, or one GPS device and one portable music player. The task of selecting two or more discrete interface devices may be performed in a variety of ways, which will be described in more detail herein.

With reference now to FIG. 4, operation 4001 shows transmitting at least one of the one or more subtasks to at least two of the two or more discrete interface devices (e.g., as shown in FIG. 1, the subtask transmitting module 154 of the task application module 150 of the computing device 30 may transmit at least one of the one or more subtasks (e.g., “take a picture of the Eiffel Tower”) to at least two of the two or more discrete interface devices (e.g., at least to smart phone device 20B and mobile device 20C)). The transmitting may be facilitated by the network interface module 38, which may be implemented as hardware or software, or both, used to interface the computing device 30 with the one or more communication networks 40.

The specific structure of network interface module 38 depends on the type or types of one or more communication networks 40 that are used. Particular details of this transmission will be discussed in more detail herein. Subtask transmitting module 154 may receive the selected interface devices selected in the selecting two or more discrete interface devices operation 3001, and the acquired subtasks from the acquiring one or more subtasks operation 2001. Then, subtask transmitting module 154 may transmit at least one of the one or more subtasks to at least two of the two or more discrete interface devices. The transmission may be sent via communications network 40, and the transmission data may take any form suitable for transmission over a network. For example, in various embodiments, the data may be represented as an electromagnetic signal, such as an electrical voltage, radio wave, microwave, or infrared signal. The data may be transmitted via analog or digital signals, or via a combination of both. For example, in some embodiments, the Transmission Control Protocol (TCP) may be used, with or without the Internet Protocol (IP). Data may be transmitted serially or in parallel, and may be transmitted synchronously or asynchronously. In this application, the transmitted data may be represented as text strings, but in other embodiments, the transmitted data may be in the form of any suitable data structure, including any modulations or modifications of the data to facilitate transmission, receipt, processing, storing, or displaying the data.

Referring now to FIG. 4, operation 5001 depicts receiving result data corresponding to a result of at least one subtask of the one or more subtasks executed by at least one of the two or more discrete interface devices (e.g., result data receiving module 155 receiving result data (e.g., “a picture”) corresponding to a result of at least one subtask (e.g., “taking a picture in near-real time of the Eiffel Tower in Paris) of the one or more subtasks executed by at least one of the two or more discrete interface devices (e.g., pictures taken with mobile device 20A and mobile device 20C, respectively)). For example, the result data receiving module 155 as shown in FIG. 2A of the task application module 150 of the computing device 30 of FIG. 1B may perform the task of receiving result data corresponding to a result of at least one subtask of the one or more subtasks executed by at least one of the two or more discrete interface devices. As shown in environment 100 of FIG. 1, the computing device 30 may receive the result data corresponding to a result of at least one subtask 72 from the communication network 40. The receiving may be facilitated by the network interface module 38, which may be implemented as hardware or software, or both, used to interface the computing device 30 with the one or more communication networks 40. The specific structure of network interface module 38 depends on the type or types of one or more communication networks 40 that are used. As will be discussed herein, in some embodiments, the result data may be received from one or more of the interface devices 20* that may carry out the one or more subtasks. In some embodiments, the result data is received from a different source, e.g., from a service provider that acts as an intermediary or as an aggregator for the interface devices 20*. In other embodiments, the interface devices 20* transmit the result data to a particular location, where the result data is then received by the computing device 30. In some embodiments, the interface device does not execute a subtask in response to the computing device 30 transmitting a subtask to the interface device, e.g., as in the transmitting operation 4001. For example, in some embodiments, the result data may have been previously acquired by the interface devices 20*, prior to receiving the one or more transmitted subtasks from the computing device 30.

Moreover, in some embodiments, the result data may be received all at once, or in discrete parts. In some embodiments, each time an interface device carries out a subtask, computing device 30 receives result data corresponding to the result of the executed subtask. In some embodiments, computing device 30 receives result data corresponding to the result of one or more executed subtasks after a predetermined number of subtasks have been executed by one or more discrete interface devices. Particular details of this transmission will be discussed in more detail herein.

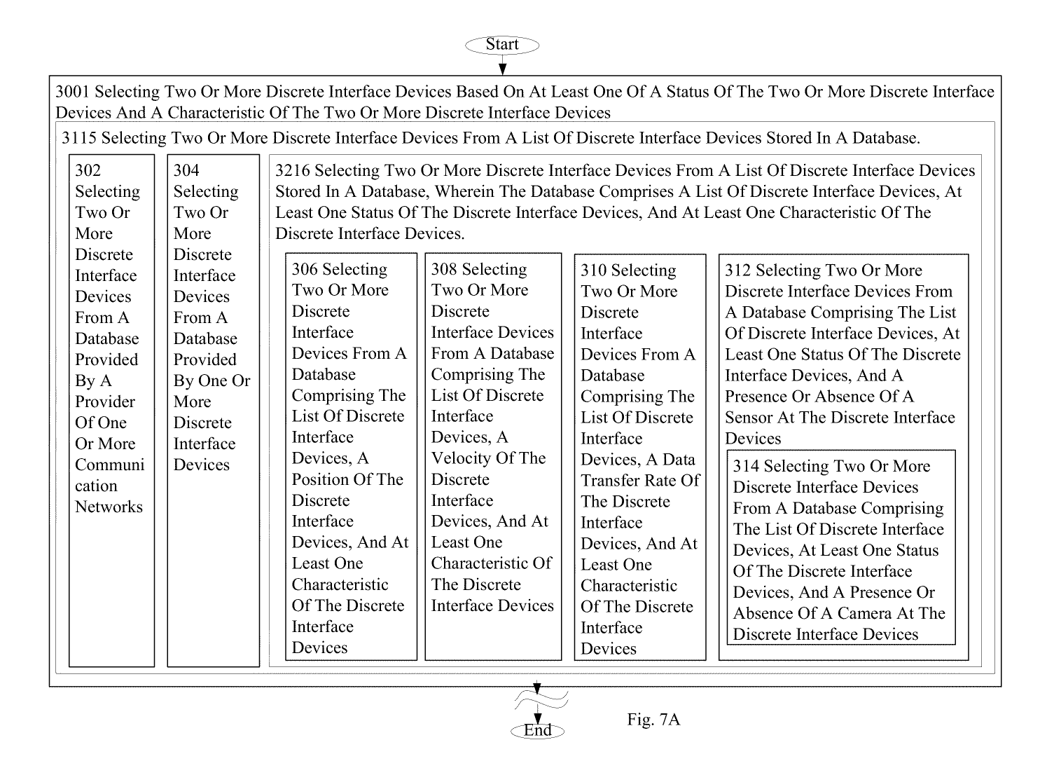

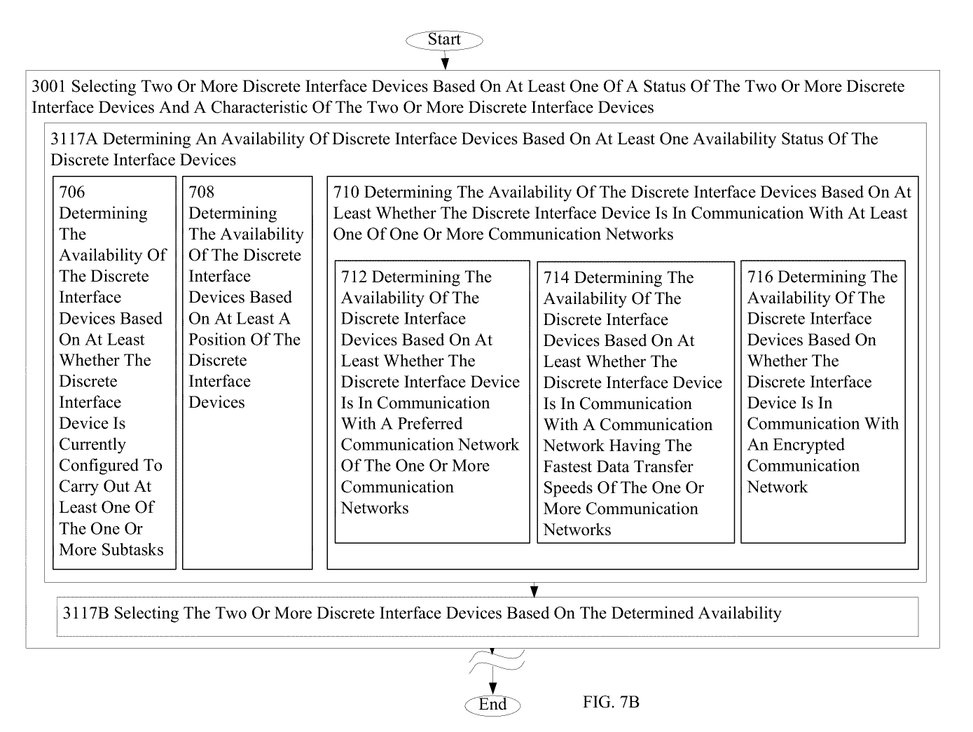

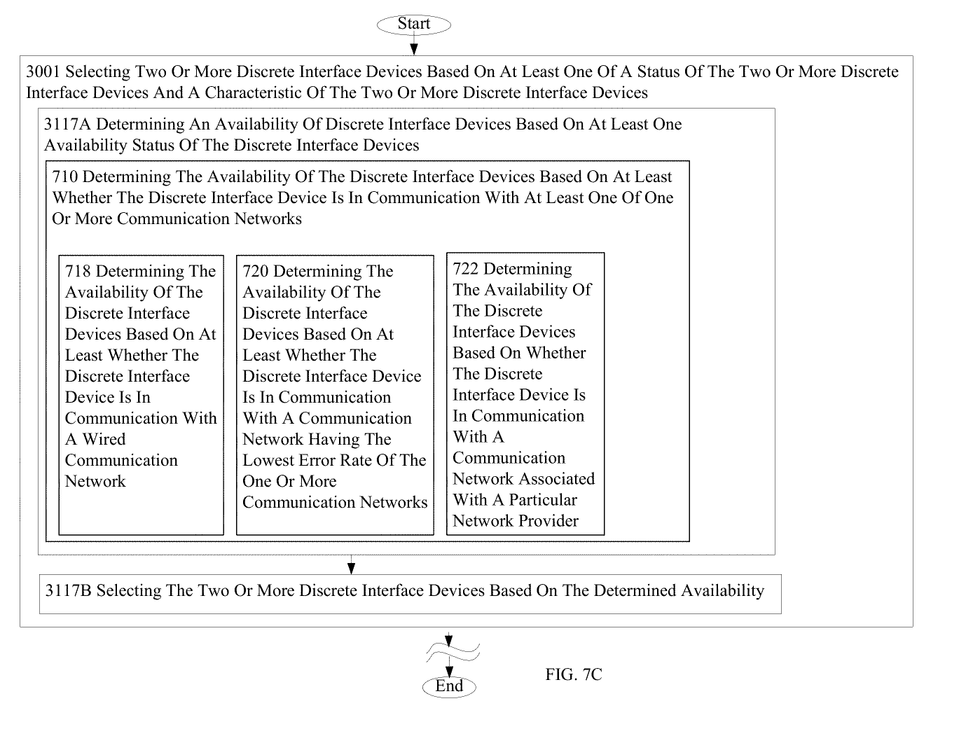

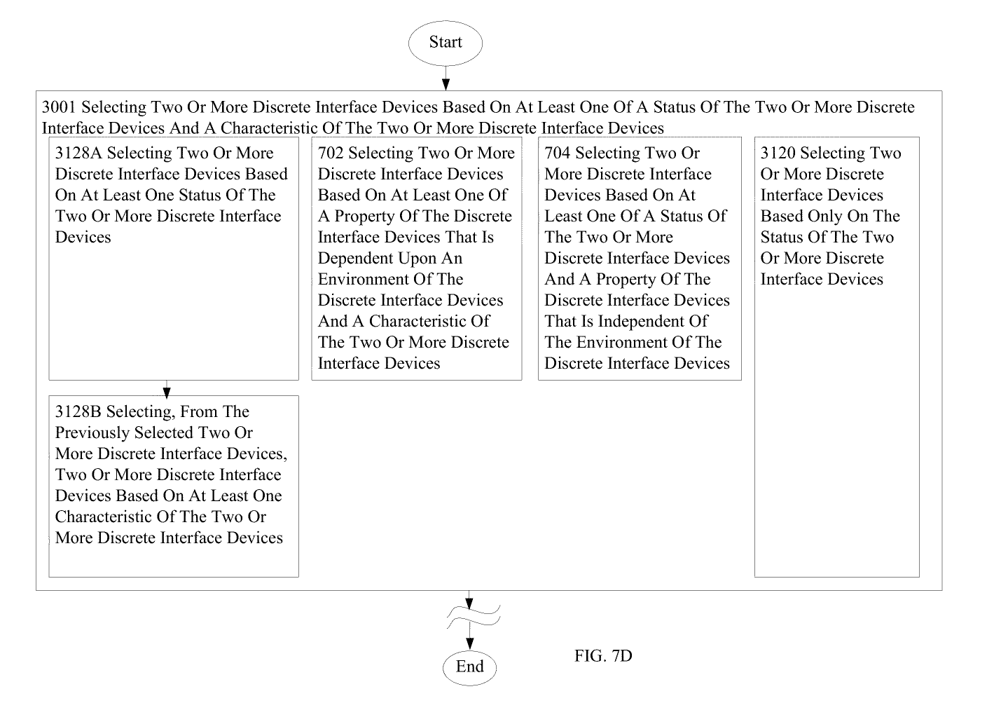

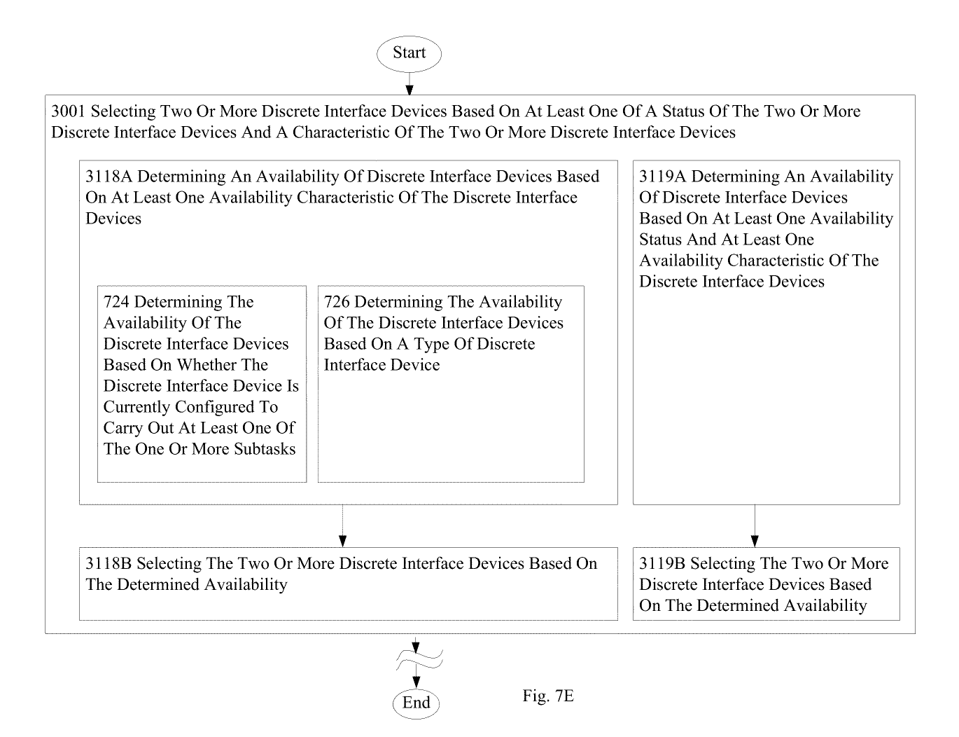

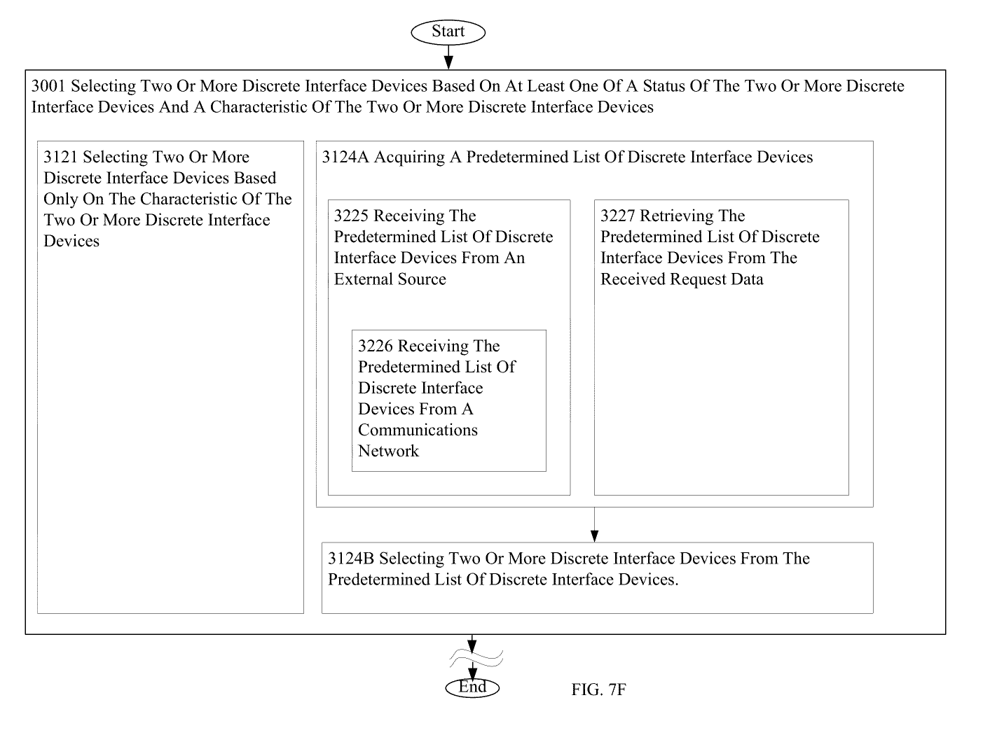

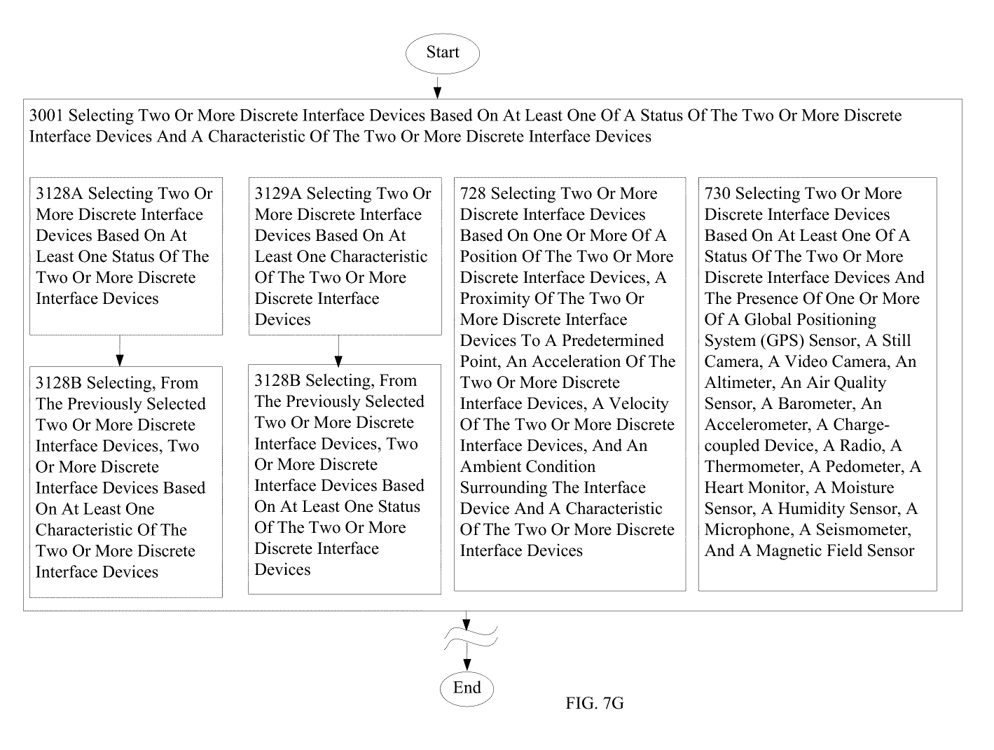

Referring now to FIG. 7D, operation 3001 shows selecting two or more discrete interface devices based on at least one of a status of the two or more discrete interface devices and a characteristic of the two or more discrete interface devices may further include operation 702 shows selecting two or more discrete interface devices based on at least one of a property of the discrete interface devices that is dependent upon an environment of the discrete interface devices and a characteristic of the two or more discrete interface devices (e.g., FIG. 2C shows property selecting module 342 selecting two or more discrete interface devices (e.g., tablet device 20A and GPS navigator 20D) based on at least one of a property of the discrete interface devices that is dependent upon an environment of the discrete interface devices (e.g., a velocity of the tablet device 20A and the GPS navigator 20D) and a characteristic (e.g., a property of the discrete interface devices that is independent of an environment of the discrete interface devices, such as “this device is a tablet,” or “this device is a BlackBerry”) of the two or more discrete interface devices (e.g. tablet device 20A and GPS navigator 20D)).

Referring now to FIG. 7D, operation 3001 shows selecting two or more discrete interface devices based on at least one of a status of the two or more discrete interface devices and a characteristic of the two or more discrete interface devices may further include operation 704 depicting selecting two or more discrete interface devices based on at least one of a status of the two or more discrete interface devices and a property of the discrete interface devices that is independent of the environment of the discrete interface devices (e.g., FIG. 2C shows property characteristic selecting module 344 selecting two or more discrete interface devices (e.g., tablet device 20A and GPS navigator 20D) based on at least one of a status (e.g., a property of the discrete interface devices that is dependent on an environment of the discrete interface devices, such as a location of the tablet device 20A and the GPS navigator 20D) of the discrete interface devices and a property of the discrete interface devices that is independent of the environment of the discrete interface devices (e.g., a device that has a Wi-Fi radio)).

Referring now to FIG. 5A, operation 1001 shows receiving request data including a request to carry out a task of acquiring data may include operation 204 depicting receiving request data including a request to carry out a task of acquiring data, that is delivered from a communications network (e.g. FIG. 2A depicts receiving request data from a communications network module 102 receiving request data (e.g. request data 72) including a request to carry out a task of acquiring data (e.g. “How many sticky buns are left in George's Bakery”) that is delivered from a communications network (e.g. AT&T's EDGE network)).

Referring now to FIG. 5A, operation 1001 shows receiving request data including a request to carry out a task of acquiring data may include operation 206 depicting receiving request data including a request to carry out a task of acquiring data, that is delivered from a computing device (e.g. FIG. 2A depicts module 104 receiving request data (e.g. request data 72) including a request to carry out a task of acquiring data (e.g. “How much rain fell in San Francisco yesterday”) that is delivered from a computing device (e.g., a user's Dell laptop including a screen, keyboard, and mouse)).

Referring now to FIG. 5A, operation 1001 shows receiving request data including a request to carry out a task of acquiring data may include operation 208 depicting receiving request data including a request to carry out an acquisition of information capable of being subdivided into one or more subtasks that are capable of being carried out by an interface device (e.g. FIG. 2A depicts module 106 for receiving request data (e.g. request data 72) including a request to carry out an acquisition of information (e.g. “What is the most humid part of Seattle right now”) capable of being subdivided into one or more subtasks (e.g. “determine a position and humidity value at the current time”) that are capable of being carried out by an interface device (e.g. mobile smart phone device 20B that has a humidity sensor)).

Referring now to FIG. 5A, operation 1001 depicts receiving request data including a request to carry out a task of acquiring data may include operation 210 depicting receiving request data including a request to carry out an acquisition of information capable of being collected by a computationally-implemented method (e.g. FIG. 2A depicts module 108 for receiving request data (e.g. request data 72) including a request to carry out an acquisition of information (e.g. “take a real-time picture of Notre Dame stadium”) capable of being collected by a computationally-implemented method (e.g., a processor of mobile device 20C instructs the camera of mobile device 20C to take a picture and stores the image data in a memory of mobile device 20C)).

Referring now to FIG. 5A, operation 1001 shows receiving request data including a request to carry out a task of acquiring data may include operation 210 depicting receiving request data including a request to carry out an acquisition of information capable of being collected by a computationally-implemented method, operation 210 may include operation 212 depicting receiving request data including a request to carry out an acquisition of information regarding one or more conditions present at one or more locations (e.g. FIG. 2A depicts module 110 for receiving request data (e.g. request data 72) including a request to carry out an acquisition of information (e.g. “determine if traffic is backed up right now on the I-90 bridge”) regarding one or more conditions present (e.g., the presence of traffic) at one or more locations (e.g., the I-90 bridge)).

Referring now to FIG. 5A, operation 1001 depicts receiving request data including a request to carry out a task of acquiring data may include operation 210 depicting receiving request data including a request to carry out an acquisition of information capable of being collected by a computationally-implemented method, operation 210 may include operation 214 depicting receiving request data including a request to carry out an acquisition of information regarding one or more weather conditions present at one or more locations (e.g. FIG. 2A depicts module 112 that shows receiving request data including a request to carry out an acquisition of information (e.g. “determine if it is raining right now on the I-90 bridge”) regarding one or more weather conditions present (e.g., the presence of rain) at one or more locations (e.g., the I-90 bridge)).

Referring now to FIG. 5A, operation 1001 depicts receiving request data including a request to carry out a task of acquiring data may include operation 210 depicting receiving request data including a request to carry out an acquisition of information capable of being collected by a computationally-implemented method, operation 210 may include operation 216 depicting receiving request data including a request to carry out an acquisition of information capable of assisting a user (e.g. FIG. 2A depicts module 114 for receiving request data including a request to carry out an acquisition of information (e.g. “what is the earliest next showing time for “Pirates of the Caribbean 6” in the Bellevue, Wash. area”) capable of assisting a user (e.g., assists the user in selecting a movie theater)).

Referring now to FIG. 5A, operation 1001 shows receiving request data including a request to carry out a task of acquiring data may include operation 210 depicting receiving request data including a request to carry out an acquisition of information capable of being collected by, a computationally-implemented method, operation 210 may include operation 218 depicting receiving request data including a request to carry out an acquisition of information in response to a user's request (e.g., FIG. 2A depicts module 118 for receiving request data including a request to carry out an acquisition of information (e.g. “what movie theater has the darkest screening rooms”) in response to a user's request (e.g., the user requests to know which movie theater has the darkest screening rooms)).

Referring now to FIG. 5A, operation 1001 depicts receiving request data including a request to carry out a task of acquiring data includes operation 210 depicting receiving request data including a request to carry out an acquisition of information capable of being collected by a computationally-implemented method, operation 210 may include operation 220 depicting receiving request data including a request to carry out an acquisition of information regarding one or more past events (e.g. FIG. 2A depicts module 120 for receiving request data including a request to carry out an acquisition of information (e.g. “what time was sunset in Seattle, Wash. yesterday”) regarding past events (e.g., yesterday's sunset)).

Referring now to FIG. 5B, operation 1001 depicts receiving request data including a request to carry out a task of acquiring data includes operation 210 depicting receiving request data including a request to carry out an acquisition of information capable of being collected by a computationally-implemented method, operation 210 may include operation 222 depicting receiving request data including a request to carry out an acquisition of information regarding one or more future events (e.g. FIG. 2A depicts module 122 that shows receiving request data including a request to carry out an acquisition of information (e.g. “Based on yesterday's sunsets, what time will the sun be sinking over the water when viewing from LaSalle restaurant tomorrow”) regarding future events (e.g., tomorrow's sunset time relative to a particular place)).

Referring now to FIG. 5B, operation 1001 depicts receiving request data including a request to carry out a task of acquiring data includes operation 210 depicting receiving request data including a request to carry out an acquisition of information capable of being collected by a computationally-implemented method, operation 210 may include operation 224 depicting receiving request data including a request to carry out an acquisition of information regarding one or more presently-occurring events (e.g., FIG. 2A depicts module 124 for receiving request data including a request to carry out an acquisition of information (e.g. “How close is the sun to setting under the water, when viewed from the Space Needle”) regarding presently-occurring events (e.g., the current sunset timeframe)).

Referring now to FIG. 5B, operation 1001 shows receiving request data including a request to carry out a task of acquiring data includes operation 210 depicting receiving request data including a request to carry out an acquisition of information capable of being collected by a computationally-implemented method, operation 210 may include operation 226 depicting receiving request data including a request to carry an acquisition of information regarding one or more persons (e.g. FIG. 2A depicts module 126 for receiving request data including a request to carry out an acquisition of information (e.g. “Has Jay-Z come on stage yet at the 9:30 Club”) regarding one or more persons (e.g., Jay-Z)).

Referring now to FIG. 5B, operation 1001 shows receiving request data including a request to carry out a task of acquiring data includes operation 210 depicting receiving request data including a request to carry out an acquisition of information capable of being collected by a computationally-implemented method, operation 210 may include operation 228 depicting receiving request data including a request to carry out an acquisition of information regarding one or more interface devices (e.g. FIG. 2A depicts module 128 for receiving request data including a request to carry out an acquisition of information (e.g. “How many cell phone cameras are in Times Square”) regarding one or more interface devices (e.g., mobile devices having cameras)).

Referring now to FIG. 5B, operation 1001 depicts receiving request data including a request to carry out a task of acquiring data may include operation 230 depicting receiving request data, including a request to carry out a task of acquiring data, represented as a text string (e.g. FIG. 2A depicts module 130 for receiving request data, including a request to carry out a task of acquiring data (e.g. “Determine where is the closest food truck to my location”) represented as a text string (e.g. “Where is the closest food truck?”).

Referring now to FIG. 5B, operation 1001 depicts receiving request data including a request to carry out a task of acquiring data may include operation 230 depicting receiving request data, including a request to carry out a task of acquiring data, represented as a text string (e.g. FIG. 2A depicts module 130 for receiving request data, including a request to carry out a task of acquiring data (e.g. “Determine where is the closest food truck to my location”) represented as a text string (e.g. “Where is the closest food truck?”)).

Referring now to FIG. 5B, operation 1001 depicts receiving request data including a request to carry out a task of acquiring data may include operation 232 depicting receiving request data, including a request to carry out a task of acquiring data, represented as one or more tokens (e.g., FIG. 2A depicts module 132 receiving request data, including a request to carry out a task of acquiring data (e.g. “Which seats at Safeco Field have the best view of the scoreboard”), represented as one or more tokens (e.g. noun tokens, e.g., “seats,” location tokens, e.g., “Safeco Field,” verb tokens, e.g. “view,” object tokens, e.g. “scoreboard”)).

Referring now to FIG. 5B, operation 1001 depicts receiving request data including a request to carry out a task of acquiring data includes operation 232 depicting receiving request data, including a request to carry out a task of acquiring data, represented as one or more tokens, operation 232 may further include operation 234 depicting receiving request data, including a request to carry out a task of acquiring data, represented as one or more words (e.g., FIG. 2A depicts module 134 for receiving request data, including a request to carry out a task of acquiring data (e.g. “Which Seattle music show has seats available,”) represented as one or more words (e.g., “Seattle,” “music,” and “show”)).

Referring now to FIG. 5B, operation 1001 shows receiving request data including a request to carry out a task of acquiring data may include operation 236 depicting receiving request data, including a request to carry out a task of acquiring data, representing a selection of a computer-generated representation (e.g. FIG. 2A depicts module 136 for receiving request data, including a request to carry out a task of acquiring data (e.g., “What segments of Sacramento are currently without power”) representing a selection, (e.g., interacting with a computing device, e.g., a computer, using an input device, e.g., a microphone), to choose from one or more options of a computer-generated representation (e.g., a sound presented through headphones)).

Referring now to FIG. 5B, operation 1001 depicts receiving request data including a request to carry out a task of acquiring data includes operation 236 depicting receiving request data, including a request to carry out a task of acquiring data, representing a selection of a computer-generated representation, operation 236 further may include operation 238 depicting receiving request data, including a request to carry out a task of acquiring data, representing a selection of a computer-generated graphic (e.g. FIG. 2A depicts module 138 for receiving request data, including a request to carry out a task of acquiring data (e.g., “What segments of Sacramento are currently without water”) representing a selection, (e.g., interacting with a computing device, e.g., a computer, using an input device, e.g., a keyboard), to choose from one or more options of a computer-generated graphic (e.g., a picture displayed on a display device)).

Referring now to FIG. 5B, operation 1001 depicts receiving request data including a request to carry out a task of acquiring data includes operation 238 depicting receiving request data, including a request to carry out a task of acquiring data, representing a selection of a computer-generated graphic, operation 238 further may include operation 240 depicting receiving request data, including a request to carry out a task of acquiring data, representing a selection of a computer-generated graphic that is configured to be selectable via a user interface (e.g. FIG. 2A depicts module 140 for receiving request data, including a request to carry out a task of acquiring data (e.g., “What segments of Sacramento are currently without gas heat”) representing a selection, (e.g., interacting with a computing device, e.g., a computer, using an input device, e.g., a mouse), to choose from one or more options of a computer-generated graphic (e.g., an icon displayed on a display device of a computer running Windows Vista)).

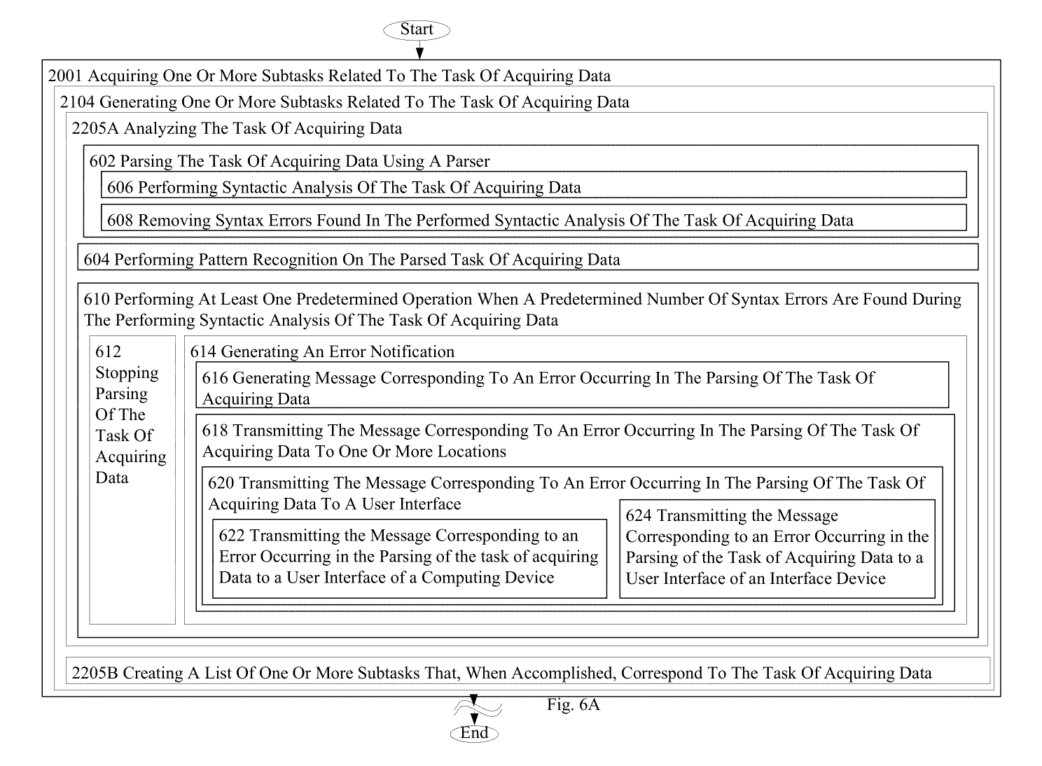

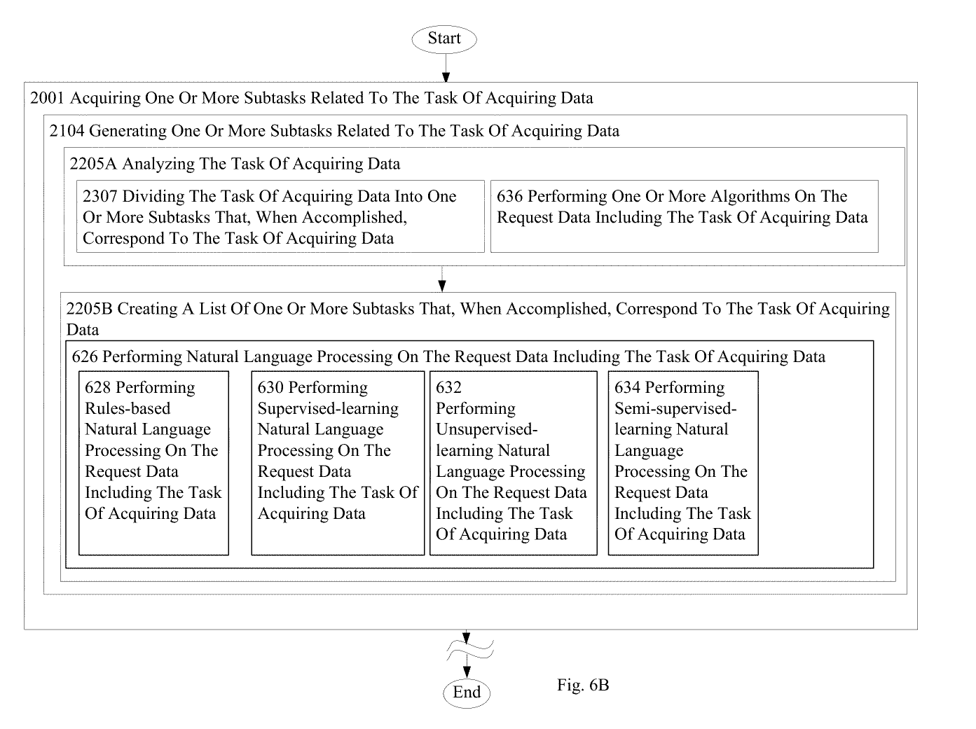

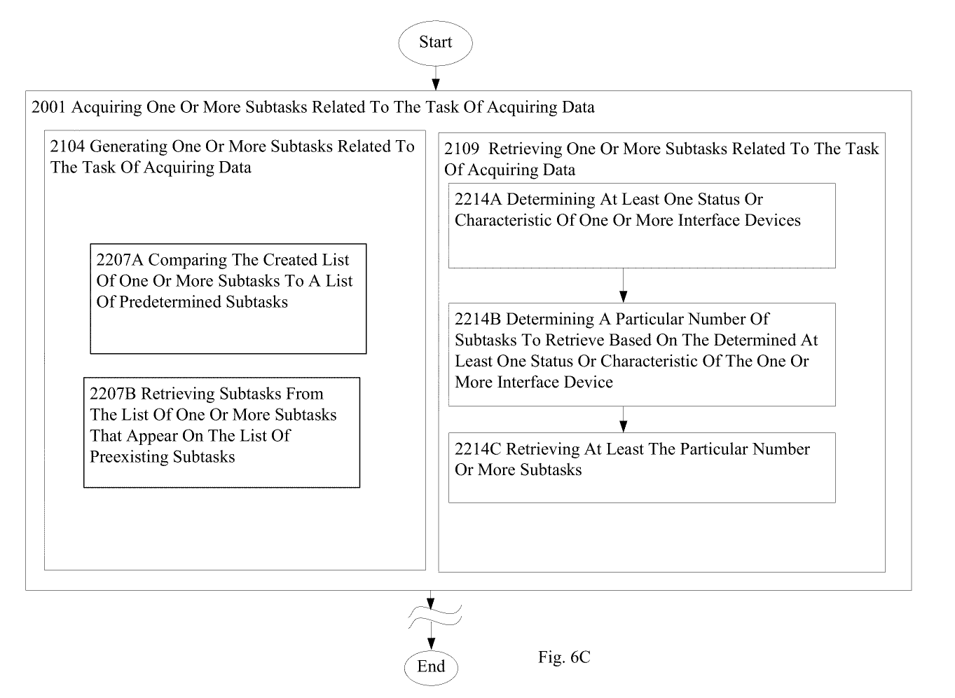

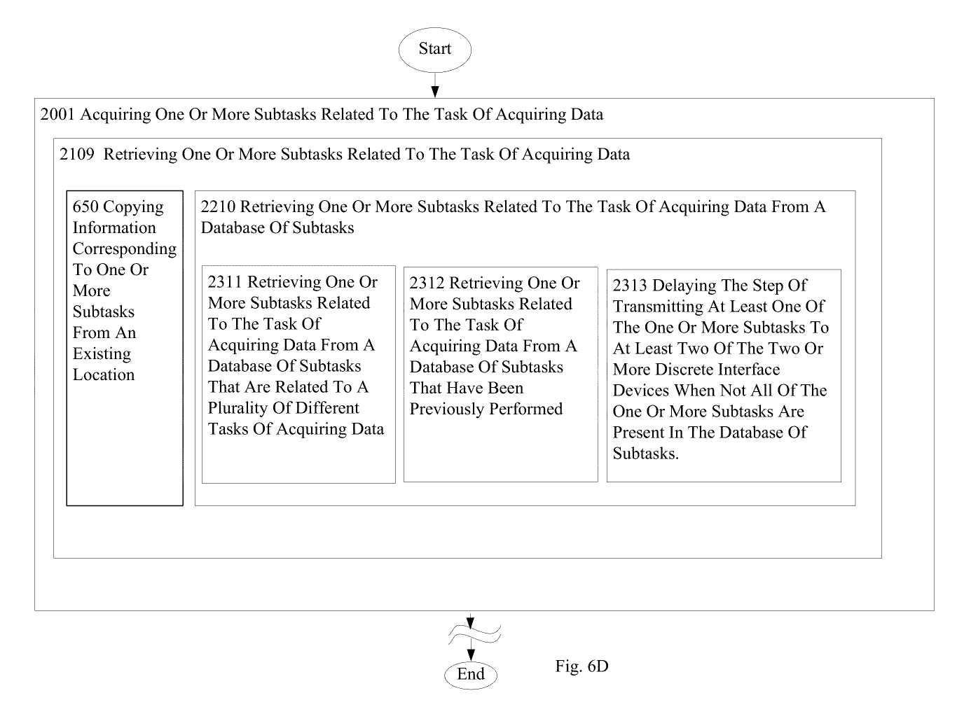

Referring now to FIG. 4, as described above, operational flow 400 may include an acquiring one or more subtasks operation 2001. Referring to FIG. 6A, in some embodiments, operation 2001 may include a generating one or more subtasks operation 2104 shows generating one or more subtasks related to the task of acquiring data (e.g., FIG. 2B depicts subtask generating module 251 generating (e.g., creating subtasks by using algorithms stored on processor 28 and information stored in memory 34 to process the task of acquiring data) one or more subtasks (e.g., “take a five-second video of the White House”) related to the task of acquiring data (e.g., “acquire a near-real-time panoramic video of the White House”).

Referring to FIG. 6A, in some embodiments, the operation 2104 of the acquiring one or more subtasks related to the task of acquiring data operation 2001 may include an analyzing operation 2205A for analyzing the task of acquiring data (e.g., FIG. 2B depicts the subtask analyzing module 261 of the subtask acquiring module 152 analyzing (e.g., performing computational analysis using processor 28) the task of acquiring data e.g. (“acquire a near-real-time panoramic photo of Puget Sound.”)

In some cases, the generating one or more subtasks operation 2104 may also include an operation 2205B for creating a list of one or more subtasks that, when accomplished, correspond to the task of acquiring data (e.g., FIG. 2B depicts the subtask creating module 262 creating a list (e.g., a data structure that can be stored in memory) of one or more subtasks (e.g. “take a picture of Puget Sound”) that, when accomplished, correspond to the task of acquiring data (e.g., “acquire a near-real-time panoramic photo of Puget Sound”). As used in the context of this application, “list” means any data structure in which information can be stored, e.g., list, container, queue, array, set, stack, tree, graph, and hash. In some cases, the list may be stored in memory and added to or modified as needed. In some cases, the list may be preserved after the operation is complete, and expires when power to the one or more computing device(s) is shut down. In other cases, the list is preserved even when the one or more computing device(s) are powered down. In still other cases, the list is not stored after execution of the operation. In still further cases, the list may be created new upon each execution of the acquiring data operation 2001. As an example, in some embodiments, the list may be stored in the one or more task application databases 24 which are part of memory 34 of the computing device 30. In some cases, the memory 34 may extend across multiple computing devices 30, which may be in discrete locations and which may communicate via the communication networks 40. Memory 34 may be any form of Read Only Memory (ROM), Random Access Memory (RAM), Solid State Device (SSD) memory, Hard Disk Device (HDD) memory, or any other storage medium capable of storing data.

Referring to FIG. 6B, in some embodiments, the analyzing operation 2205A may include a dividing operation 2307 of (e.g., FIG. 2B depicts task dividing module 271 separating the request data including the task of acquiring data (e.g. “Take a 360 degree picture of the Eiffel Tower) into one or more subtasks (e.g., determining that this task requires the action “take a picture” with the modifier “360 degrees” and the object “Eiffel Tower”)). This example of analyzing the request data is for exemplary purposes only, and is provided for its simplicity. More complex methods of analyzing the request data, e.g., the use of an adaptive engine, or a neural network, or any linear or non-linear statistical data modeling or decision making tools, may be used in order analyze the request data and acquire the one or more subtasks that are related to the task of acquiring data.

Referring again to FIG. 6A, in some embodiments, the analyzing operation 2205A may include a parsing operation 602 shows parsing the task of acquiring data using a parser (e.g., FIG. 2B shows a parser module 272 depicting parsing (e.g., traversing and performing analysis on) the task of acquiring data (e.g., “Determine if there are any Beanie Babies left at the Wal-Mart on 158^{th} Street”) using a parser (e.g., a PERL or JAVA-based regular expression text parser, loaded on computing device 30)).

Referring again to FIG. 6A, in some embodiments, the analyzing operation 2205A also may include an operation 604 depicting performing pattern recognition on the parsed task of acquiring data (e.g., FIG. 2B shows a parsed data recognition module 273 depicting performing pattern recognition (e.g., comparing the parsed text, e.g. “Wal-Mart” to determine that a “Wal-Mart” is a store”) on the parsed task of acquiring data (e.g. “How many”, “Beanie Babies,” “Wal-Mart” “158^{th} Street”)).

Referring again to FIG. 6A, in some embodiments, the analyzing operation 2205A also may include an operation 606 depicting performing syntactic analysis of the task of acquiring data (e.g., FIG. 2B shows a parser syntactic analysis module 274 depicting performing syntactic analysis (e.g., determining whether the sentence “determine if there are any Wal-Mart 158^{th} Beanie Babies street”) of the task of acquiring data (e.g. “determine if there are any Wal-Mart 158^{th} Beanie Babies street”)).

Referring again to FIG. 6A, in some embodiments, the analyzing operation 2205A also may include an operation 608 depicting removing syntax errors found in the performed syntactic analysis of the task of acquiring data (e.g., FIG. 2B shows a module 276 depicting removing syntax errors (e.g., moving or re-categorizing “Wal-Mart 158^{th} Beanie Babies street” as (“Beanie Babies, Wal-Mart, 158^{th} Street”) found in the performed syntactic analysis of the task of acquiring data (e.g. “determine if there are any Wal-Mart 158^{th} Beanie Babies street”).

Referring again to FIG. 6A, in some embodiments, the analyzing operation 2205A also may include an operation 610 depicting performing at least one predetermined operation when a predetermined number of syntax errors are found during the performing syntactic analysis of the task of acquiring data (e.g., FIG. 2B shows a module 275 depicting performing at least one predetermined operation (e.g., stopping analyzing the task of acquiring data) when a predetermined number of syntax errors (e.g., in an environment that requires good syntax, the predetermined number may be one (1)) are found during the performing syntactic analysis of the task of acquiring data (e.g., “determine if there are any Wal-Mart 158^{th} Beanie Babies street”).

Referring again to FIG. 6A, in some embodiments, the operation 610 also may include an operation 612 depicting stopping parsing of the task of acquiring data (e.g., FIG. 2B shows a module 277 depicting stopping parsing of the task of acquiring data (e.g., aborting the process of analyzing the task of acquiring data, e.g., stopping computing device 30 from doing further processing on the task of acquiring data)).

Referring again to FIG. 6A, in some embodiments, the operation 610 also may include an operation 614 depicting generating an error notification (e.g., FIG. 2B shows a module 278 depicting generating an error notification (e.g. displaying a message on a screen saying “Unfortunately, we were unable to process this query. Please check the syntax of your request and try again.”)).

Referring again to FIG. 6A, in some embodiments, the operation 614 also may include an operation 616 depicting generating a message corresponding to an error occurring in the parsing of the task of acquiring data (e.g. FIG. 2B shows a module 279 depicting generating a message (e.g., “An error has been detected, please check the syntax of the request and try again.”) corresponding to an error occurring (e.g., a bad syntax) in the parsing of the task of acquiring data (e.g., “269 Wal-Mart Seattle Ave. Denny”)).

Referring again to FIG. 6A, in some embodiments, the operation 614 also may include operation 618 depicting transmitting the message corresponding to an error occurring in the parsing of the task of acquiring data to one or more locations (e.g., FIG. 2B shows a module 280 depicting transmitting (e.g., using a communication network 40, e.g., AT&T's EDGE network to send) the message correspond to an error (e.g., “An error has been detected, please check the syntax of the request and try again.”) corresponding to an error occurring (e.g., a bad syntax) in the parsing of the task of acquiring data (e.g., “269 Wal-Mart Seattle Ave. Denny”) to one or more locations (e.g., the querying device 15 (e.g., the querying user on their iPhone or computer) that initially transmitted the query to computing device 30))).

Referring again to FIG. 6A, in some embodiments, operation 618 may include operation 620 depicting transmitting the message corresponding to an error occurring in the parsing of the task of acquiring data to a user interface (e.g., FIG. 2B shows a module 281 depicting transmitting (e.g., using a communication network 40, e.g., AT&T's EDGE network to send) the message correspond to an error (e.g., “An error has been detected, please check the syntax of the request and try again.”) corresponding to an error occurring (e.g., a bad syntax) in the parsing of the task of acquiring data (e.g., “269 Wal-Mart Seattle Ave. Denny”) to a user interface (e.g. a screen of the interface device of the querying user, e.g., the iPhone used to send the request to the computing device 30))).

Referring again to FIG. 6A, in some embodiments, operation 620 may further include operation 622 depicting transmitting the message corresponding to an error occurring in the parsing of the task of acquiring data to a user interface of a computing device (e.g., FIG. 2B shows a module 282 depicting transmitting (e.g., using a communication network 40, e.g., AT&T's EDGE network to send) the message correspond to an error (e.g., “An error has been detected, please check the syntax of the request and try again.”) corresponding to an error occurring (e.g., a bad syntax) in the parsing of the task of acquiring data (e.g., “269 Wal-Mart Seattle Ave. Denny”) to a user interface of a computing device (e.g. a monitor of the computing device 30 of the querying user, e.g., the Windows Vista screen used to select a task to be carried out)).

Referring again to FIG. 6A, in some embodiments, operation 620 may further include operation 624 depicting transmitting the message corresponding to an error occurring in the parsing of the task of acquiring data to a user interface of an interface device (e.g., FIG. 2B shows a module 283 depicting transmitting (e.g., using a communication network 40, e.g., AT&T's EDGE network to send) the message correspond to an error (e.g., “An error has been detected, please check the syntax of the request and try again.”) corresponding to an error occurring (e.g., a bad syntax) in the parsing of the task of acquiring data (e.g., “269 Wal-Mart Seattle Ave. Denny”) to a user interface of an interface device (e.g., the iPad used to send the request to the computing device 30))).

Referring to FIG. 6B, in some embodiments, operation 2205B may further include operation 626 depicting performing natural language processing on the request data including the task of acquiring data (e.g., FIG. 2B shows a module 284 depicting performing natural language processing (e.g., processing a query using a natural language processor, e.g., the Stanford NLP that is freely available, implemented in hardware or software, e.g., stored in memory 34 and executed by processor 32 of computing device 30 (e.g., understanding a plain-English sentence (e.g., “Find me an open hair salon in Seattle,”))) on the request data including the task of acquiring data (e.g., “Find me an open hair salon in Seattle”)).

Referring to FIG. 6B, in some embodiments, operation 626 may further include operation 628 depicting performing rules-based natural language processing on the request data including the task of acquiring data (e.g., FIG. 2B shows a module 285 depicting performing rules-based natural language processing (e.g., processing a query using a rules-based natural language processor (e.g., the conventional chatterbox systems, (e.g., PARRY)), implemented in hardware or software, e.g., stored in memory 34 and executed by processor 32 of computing device 30 (e.g., understanding a plain-English sentence (e.g., “Find me a busy coffee shop in Seattle,”))) on the request data including the task of acquiring data (e.g., “Find me a busy coffee shop in Seattle”)).

Referring to FIG. 6B, in some embodiments, operation 626 may further include operation 630 depicting performing supervised-learning natural language processing on the request data including the task of acquiring data (e.g., FIG. 2B shows a module 286 depicting performing supervised-learning natural language processing (e.g., processing a query using a supervised-learning natural language processor (e.g., a rules-based repetitive learning system, e.g., (Kernel-based Robust Interpretation for Semantic Parsing (“KRISP”)) implemented in hardware or software, e.g., stored in memory 34 and executed by processor 32 of computing device 30 (e.g., understanding a plain-English sentence (e.g., “Find me an empty coffee shop in Seattle,”))) on the request data including the task of acquiring data (e.g., “Find me an empty coffee shop in Seattle”)).

Referring to FIG. 6B, in some embodiments, operation 626 may further include operation 632 depicting performing unsupervised-learning natural language processing on the request data including the task of acquiring data (e.g., FIG. 2B shows a module 287 depicting performing semi-supervised-learning natural language processing (e.g., processing a query using a semi-supervised-learning natural language processor (e.g., in hardware or software, e.g., stored in memory 34 and executed by processor 32 of computing device 30 (e.g., understanding a plain-English sentence (e.g., “Find me a coffee shop in Seattle full of members of the opposite sex,”))) on the request data including the task of acquiring data (e.g., “Find me a coffee shop in Seattle full of members of the opposite sex”)).

Referring to FIG. 6B, in some embodiments, operation 626 may further include operation 634 depicting performing semi-supervised-learning natural language processing on the request data including the task of acquiring data (e.g., FIG. 2B shows a module 288 depicting performing semi-supervised-learning natural language processing (e.g., processing a query using a semi-supervised-learning natural language processor (e.g., SEMISUP-KRISP, or an always-online neural network learning system)), implemented in hardware or software, e.g., stored in memory 34 and executed by processor 32 of computing'device 30 (e.g., understanding a plain-English sentence (e.g., “Find me a coffee shop in Seattle having a Monet artwork on the wall,”))) on the request data including the task of acquiring data (e.g., “Find me a coffee shop in Seattle having a Monet artwork on the wall”)).

Referring to FIG. 6B, in some embodiments, analyzing operation 2205A may further include operation 636 depicting performing one or more algorithms on the request data including the task of acquiring data (e.g., FIG. 2B shows module 289 performing one or more algorithms (e.g., decision tree processing carried out by processor 32 of computing device 30 (e.g., performing the algorithm of “determine a location of the task, determine what information is needed, and create subtasks based on those two parameters.”)) on the request data including the task of acquiring data (e.g., “Find me a coffee shop in Seattle with a view of Puget Sound.”)). As another example, module 289 of subtask acquiring module 152 may determine that the task application module 150 requires a number of, e.g., twenty, pictures of the Eiffel Tower from each of the four cardinal directions to stitch together a sufficiently high-quality 360-degree picture of the Eiffel Tower. Thus, the subtask generating module 251 of the subtask acquiring module 152 may generate four subtasks, e.g., “take a picture of the Eiffel Tower while facing north,” “take a picture of the Eiffel Tower while facing east,” “take a picture of the Eiffel Tower while facing south,” and “take a picture of the Eiffel Tower while facing west.” Each of these subtasks may be replicated twenty times, and distributed, as will be discussed in more detail herein. In an embodiment of the invention, the subtask generating module 251 may communicate with dynamic information collecting module 259 to determine the location and placement of interface devices in proximity to the Eiffel Tower, and use this information to determine how many pictures of the Eiffel Tower are needed. In addition, the subtask generating module 251 may perform additional queries from the interface devices in proximity to the Eiffel Tower, in order to determine how many subtasks should be generated to perform the task of acquiring data. For example, the dynamic information collecting module 259 may communicate with interface devices in the proximity of the Eiffel Tower to determine lighting and weather conditions, and using that information, may increase or decrease the number of subtasks that are created, based on an estimation of the number of pictures needed. In another embodiment, subtask generating module 251 may generate fewer subtasks than the number of subtasks determined by task analyzing module 252. These fewer subtasks may be distributed to the interface devices, as will be described herein, and the results may be further analyzed by task analyzing module 252.

For example, in some embodiments, a task of “take a 360 degree picture of the Eiffel Tower,” may be deconstructed into a calculated number of still pictures. For another example, a task of “calculate the fastest way to get to the movie theater on 8^{th} street,” may be deconstructed into “analyze the traffic around 8^{th} street,” “determine available parking spaces around the movie theater on 8^{th} street,” and “calculate walking time from the determined available parking spaces.”

Referring to FIG. 6C, in some embodiments, the generating one or more subtasks operation 2104 may include a comparing operation 2207A for comparing the created list of one or more subtasks to a list of preexisting subtasks (e.g., FIG. 2B depicts module 290 comparing the created list of one or more subtasks (e.g., “Take a picture of the Grand Canyon,”) to a list of preexisting subtasks (e.g., a preexisting subtask may include “take a picture of the Eiffel tower while facing south”))). A list of preexisting subtasks may be stored in subtask database 26, which is part of memory 24 of the computing device 30 of the environment 100 of FIG. 1. For example, preexisting subtasks may include “measure the temperature upon receipt of this subtask,” or “measure the temperature at 7 pm on the date this subtask is received.” These subtasks may be examples of subtasks that were previously performed to complete other tasks. In comparing operation 2207A, the created list of subtasks is compared against the list of preexisting subtasks. The list of preexisting subtasks may be ordered in such a way as to facilitate search, e.g., grouped by like tasks, or may include information within the entries of preexisting subtasks that facilitate searching, e.g., a field that states “this is a picture-taking subtask.”

Referring again to FIG. 6C, in some cases, operation 2104 also may include a retrieving operation 2207B for retrieving subtasks from the list of one or more subtasks that appear on the list of preexisting subtasks (e.g., FIG. 2B depicts module 291 retrieving subtasks (e.g. “take a picture of the Eiffel Tower while facing south”) from the list of one or more subtasks that appear on the list of preexisting subtasks (e.g., a list including subtasks of “take a picture of [various famous places]” in which the [various famous places] may be landmarks such as the Statute of Liberty, Mt. Rushmore, the White House, and the Golden Gate bridge)). In some cases, these subtasks may previously have been transmitted to discrete interfaces devices. In other cases, however, the subtask is retrieved from the subtask database 26 and transmitted, as will be discussed in more detail herein.

Referring now to FIG. 6D, the acquiring one or more subtasks operation 2001 may include a retrieving one or more subtasks operation 2109 for retrieving one or more subtasks related to the task of acquiring data (e.g. FIG. 2B depicts module 266 retrieving one or more subtasks (e.g., “measure the temperature in Tijuana” and “measure the humidity in Tijuana”) related to the task of acquiring data (e.g., the task of acquiring data is “What is the weather like in Tijuana”). In some cases, the subtasks may be retrieved from a different database, from an interface device, or from a separate computing device that creates subtasks. As above, the retrieved subtasks may be subtasks that were previously used to execute tasks, or they may be subtasks that were previously programmed prior to retrieving request data for carrying out a task of acquiring data.

Referring again to FIG. 6D, In some cases, the retrieving one or more subtasks operation 2109 of the acquiring one or more subtasks operation 2001 may include a retrieving one or more related subtasks operation 2210 shows retrieving one or more subtasks related to the task of acquiring data from a database of subtasks (e.g., FIG. 2B depicts module 292 retrieving one or more subtasks (e.g., “measure the cloud cover in Tijuana” and “measure the humidity in Tijuana”) related to the task of acquiring data (e.g., the task of acquiring data is “What is the likelihood of rain in Tijuana”) from a database of subtasks (e.g., a database of subtasks 26 stored in a computing device 30 that stores subtasks, e.g., “measure the temperature in Tijuana.”))) For example, the subtask retrieving module 256 may, as above, retrieve one or more subtasks from the subtask database 26.

Referring again to FIG. 6D, in some cases, retrieving one or more subtasks operation 2210 may include a retrieving one or more subtasks related to the task of acquiring data from a database of subtasks that are related to a plurality of different tasks of acquiring data operation 2311 shows retrieving one or more subtasks related to the task of acquiring data from a database of subtasks that are related to a plurality of different tasks of acquiring data (e.g., FIG. 2B shows a module 293 retrieving one or more subtasks (e.g., “measure the cloud cover in Tijuana”) related to the task of acquiring data (e.g., “what is the likelihood of rain in Tijuana”) from a database of subtasks (e.g., a database of subtasks 26 stored in a computing device 30 that stores subtasks) that are related to a plurality of different tasks of acquiring data (e.g., in this example, the subtask of “measure the cloud cover in Tijuana” is a subtask related to the task of determining “what is the likelihood of rain in Tijuana,” but the subtask also may be related to a task of “determine the photographic conditions for sunset over Tijuana,” and also related to a task of “determine the visibility over Tijuana airport.” In another example, the subtask database 26 may store a subtask of “detect the amount of ambient light each minute for a two-hour period.” This subtask may be a subtask that is used in a task of, for example “determine the exact time of sunset at a geographic location,” in which case the task application module may use this task to determine when sunset is reached based on ambient light, and also for a subtask that is “take a picture of the sun setting over Puget Sound on Thursday,” in which case the task application module may use this task to determine when to execute the subtask of taking a picture in order to take the requested picture. This example is merely for exemplary purposes, and as can be seen from the example, many subtasks are usable in a plurality of tasks. In some cases, these subtasks are stored in the subtask database 26. In some cases, a subtask is stored in the subtask database 26 once it has been performed twice. Thus, after the first time that a subtask has been performed, that subtask is stored in the memory 34, but in a different location, e.g., a single performed subtask database (not depicted). Then, after a new subtask has been performed, the subtask acquiring module 152 determines whether that subtask is present in the single performed subtask database. If so, the subtask is moved to the subtask database and deleted from the single performed subtask database. In other cases, each subtask is stored in the subtask database 26, with a data field indicating how many times that subtask has been performed. When subtasks are retrieved from the database, those subtasks that have been performed 2 or more times may be searched.

Referring again to FIG. 6D, operation 2001 may include operation 2312 shows retrieving one or more subtasks related to the task of acquiring data from a database of subtasks that have been previously performed (e.g., FIG. 2B depicts module 293 retrieving one or more subtasks (e.g., measure the barometric pressure in Tijuana”) related to the task of acquiring data (e.g., the task of acquiring data is “What is the air quality in Tijuana”) from a database of subtasks (e.g., a database of subtasks 26 stored in a computing device 30 that stores subtasks (e.g., “measure the barometric pressure in Tijuana.”))) that have been previously performed (e.g., in a different query than “what is the air quality in Tijuana)))). For example, in this example, the previously performed subtask of “measure the barometric pressure” may have been performed in the same task previously, e.g., “what is the air quality in Tijuana,” or in a different task previously, e.g. “what is the weather report in Tijuana.” Similarly to as above, the subtasks are stored in the subtask database 26. In some cases, each subtask stored in the subtask database 26 has a data field indicating how many times that subtask has been performed. In other cases, this field is eliminated, and after a subtask is executed, it is placed in the subtask database 26 for retrieval by the subtask acquiring module 152 of the task application module 150 shown in FIG. 2A.

Referring again to FIG. 6D, in some cases, the retrieving one or more subtasks operation 2109 of the acquiring one or more subtasks operation 2001 may include a delaying operation 2313 of delaying said transmitting at least one of the one or more subtasks to at least two of the two or more discrete interface devices when not all of the one or more subtasks are present in the database of subtasks (e.g. FIG. 2B depicts module 294 delaying said transmitting (e.g., sending via communication networks 40, e.g., Verizon 4G LTE), at least one of the one or more subtasks)). For example, transmission delaying module 260 of subtask acquiring module 152 may delay subtask transmitting module 154 from executing, as described herein, when not all of the one or more subtasks appear in the subtask database 26. For example, after receiving a request to carry out a task of acquiring data, the computing device 30 may not have all of the subtasks needed to carry out the task. For example, if the generation of subtasks is handled by a different one or more computing devices, or if the one or more computing devices require more time or information to generate all of the subtasks. In some cases, the generation of subtasks may have to wait until other subtasks are completed, e.g., if a task is requested to “take a picture of the sun setting over the Puget Sound,” then first, the task application module 150 will determine what time to take a picture, and then send out the subtask of taking the picture. Thus, the subtask of “take the picture” may be delayed until the task application module 150 has calculated at what time to take a picture.

Referring again to FIG. 6C, in some embodiments, operation 2109 may include operation 2214A depicting determining at least one status or characteristic of one or more interface devices (e.g., FIG. 2B depicting module 267 may determine at least one status (e.g., location) or characteristic (e.g., list of sensors present) of one or more interface devices (e.g., tablet device 20A). In some embodiments, module 267 may communicate with the interface devices via one or more of network interface 38 and polling interface 33 to determine information about one or more interface devices. The information may be a status of the one or more interface devices or a characteristic of the one or more interface devices, which characteristic and status will be described in more detail further herein.

Referring again to FIG. 6C, in some embodiments, operation 2109 also may include operation 2214B depicting determining a particular number of subtasks to retrieve based on the determined at least one status or characteristic of the one or more interface device (e.g. FIG. 2B depicting module 268 determining a particular number of subtasks to retrieve (e.g. 10) based on the determined at least one status (e.g. “location: at the Eiffel Tower”) or characteristic (e.g. “camera: present on interface device”) of the one or more interface devices (e.g., movable smart phone device 20B and mobile device 20C)). For example, in some embodiments, the subtask acquiring module 152 may use the information determined during the determining operation 2214A to determine a particular number of subtasks to retrieve. In some cases, the particular number may represent the minimum number of subtasks needed to carry out the task. In other cases, the particular number represents the optimal number of subtasks needed to carry out the task. In still other cases, the particular number represents the number of subtasks needed to carry out the task with a predetermined accuracy. The predetermined accuracy may be transmitted with the request data, or it may be stored in the memory 34 of the computing device 30.

Referring again to FIG. 6C, operation 2109 further may include operation 2214C for retrieving at least the particular number or more subtasks (e.g., FIG. 2B depicting module 269 retrieving at least the particular number (e.g. 10) or more subtasks (e.g. “take a picture of the Eiffel Tower”). For example, the subtask generating module 251 may communicate with dynamic information collecting module 259 to determine the location and placement of interface devices in proximity to the Eiffel Tower, and use this information to determine how many pictures of the Eiffel Tower are needed. In addition, the subtask generating module 251 may perform additional queries from the interface devices in proximity to the Eiffel Tower, in order to determine how many subtasks should be generated to perform the task of acquiring data. For example, the dynamic information collecting module 259 may communicate with interface devices in the proximity of the Eiffel Tower to determine lighting and weather conditions, and using that information, may increase or decrease the particular number of subtasks, based on an estimation of the number of pictures needed. In another embodiment, subtask generating module 251 may generate fewer subtasks than the number of subtasks determined by task analyzing module 252. These fewer subtasks may be transmitted to the interface devices, as will be described herein, and the results may be further analyzed by task analyzing module 252, before further transmitting of subtasks.

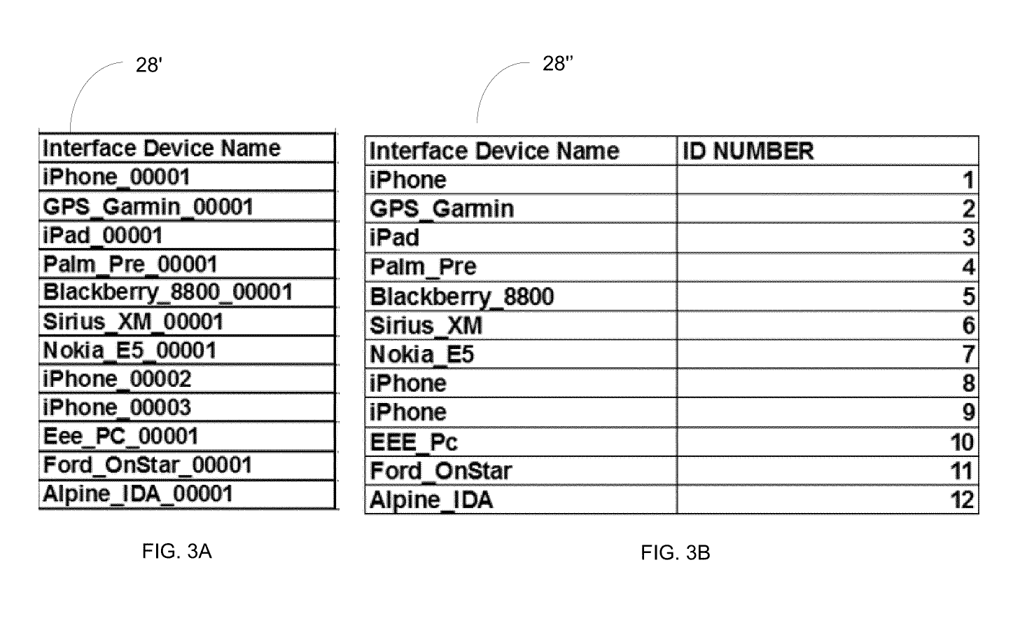

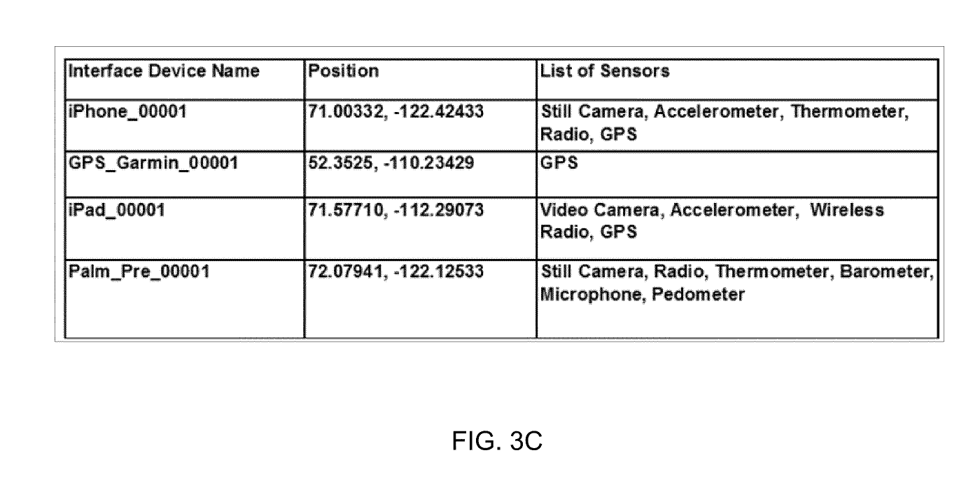

Referring now to FIG. 1, as described above, operational flow 400 of FIG. 4 also may include a selecting two or more discrete interface devices operation 3001 shows selecting two or more discrete interface devices based on at least one of a status of the two or more discrete interface devices and a characteristic of the two or more discrete interface devices. Referring to FIG. 7A, in some embodiments, the selecting two or more discrete interface devices operation 3001 may include an operation 3115 depicting selecting two or more discrete interface devices from a database comprising a list of discrete interface devices, e.g. FIG. 2C depicts module 331 selecting two or more discrete interface devices (e.g., a mobile smart phone device 20A, e.g. “iPhone 00001,” and “Blackberry 8800 00001”) from a database comprising a list of discrete interface devices (e.g. a database of uniquely identified discrete interface devices, e.g. as shown in FIG. 3A)))). For example, in some embodiments, module 331 may retrieve a list of discrete interface devices from interface device database 28 stored in memory 34 of computing device 30. Interface device database 28 comprises a list of interface devices. In some embodiments, interface device database 28 contains only a list of interface devices. For example, an exemplary interface device database data structure is shown in tabular format in example database 28′ shown in FIG. 3A. As shown in FIG. 3A, each device in example interface device database 28′ is given a unique name. In the example shown in example interface device database 28′, the unique name is formed by appending a unique five-digit number to a shortened device name that carries some information about the device. In some embodiments of the invention, the device name is transmitted from the interface device. In some embodiments of the invention, a user is prompted to enter the device name. In some embodiments of the invention, the device name may be determined by the computing device 30 based on the signals transmitted from the interface device. In some embodiments, for example, the embodiment shown in FIG. 3A, no status information or characteristic information is stored in the database. In some embodiments, this information may be retrieved in other manners, as needed. For example, if one of the interface devices is an iPad, the computing device 30 may consult a database stored separately that details characteristic information about the iPad. For another example, if one of the interface devices is a Palm Pre, the computing device 30 may consult the service provider for the cellular network for the Palm Pre to determine the characteristic information, e.g., location.

In some embodiments, interface device database 28 contains a list of interface devices, and also a unique identification number for categorizing the interface devices. For example, an exemplary interface device database data structure is shown in tabular format in example interface device database 28″ shown in FIG. 3B. As shown in FIG. 3B, each device in example interface device database 28″ has a device name, which may or may not be unique, and a device ID number, which is unique. As described in more detail above with respect to FIG. 3A, in some embodiments of the invention, a user is prompted to enter the device name. In some embodiments of the invention, the device name may be determined by the computing device 30 based on the signals transmitted from the interface device. In some embodiments, for example, the embodiment shown in FIG. 3B, no status information or characteristic information is stored in the database. In some embodiments, this information may be retrieved in other manners, as needed.

Referring to FIG. 7A, in some embodiments, operation 3115 may include operation 302 depicting selecting two or more discrete interface devices from a database provided by a provider of (e.g., FIG. 2C depicts module 357 selecting two or more discrete interface devices (e.g., an iPhone and an iPad) from a database provided by a provider (e.g., AT&T) of communication networks (e.g., the EDGE network)).

Referring to FIG. 7A, in some embodiments, operation 3115 may include operation 304 depicting selecting two or more discrete interface devices from a database provided by one or more discrete interface devices (e.g. FIG. 2C depicts module 358 selecting two or more discrete interface devices (e.g., an iPhone and an iPad) from a database provided by one or more discrete interface devices (e.g., a computer communicating with a network that stores a database of discrete interface devices))).

Referring to FIG. 7A, in some embodiments, interface device database 28 comprises a list of discrete interface devices, status information, e.g., at least one status of the discrete interface devices, and characteristic information, e.g., at least one characteristic of the discrete interface devices. In some of these embodiments, the selecting from a database operation 3115 may include a selecting operation 3216 depicting selecting two or more discrete interface devices from a database comprising the list of discrete interface devices, at least one status of the discrete interface devices, and at least one characteristic of the discrete interface devices (e.g. FIG. 2C depicts module 341 selecting two or more interface devices (e.g., an iPhone and an iPad) from a database comprising the list of discrete interface devices (e.g. “iPhone 00001,” “iPhone 00002,” “iPhone 00003,” “Blackberry 00001”) at least one status of the discrete interface devices (e.g., iPhone 00001—<100 meters from the Eiffel Tower), and at least one characteristic of the discrete interface devices (e.g. iPhone 00001—has an accelerometer).

For example, the interface device database retrieving module 331 of the interface device selecting module 153 shown in FIG. 2C may retrieve a list of discrete interface devices, at least one status of the discrete interface devices, and at least one characteristic of the discrete interface devices from interface device database 28, e.g., example interface device database 28′, stored in memory 34 of computing device 30, as shown in FIG. 1. For example, an exemplary interface device database data structure is shown in tabular format in example interface device database 28′ shown in FIG. 3C. As shown in FIG. 3C, each device in example interface device database 28″ has a device name, which in this example is a unique device name. In addition, example interface device database 288′ stores, for each device, a status, e.g., the position of the device in absolute terms, expressed in this example in longitude and latitude. This status is shown merely as an example, and any status could be substituted. In addition, the position of the device could be expressed in other terms, e.g., distance from a certain point, or the city in which the device is presently located. In addition, example interface device database 288′ stores, for each device, a characteristic, e.g., the sensors present on the device. This characteristic could also be stored as a series of single bits indicating whether a sensor is present at the interface device. For example, in some embodiments (not depicted), in row 3 of the example interface device database 28″, the iPad_00001 device would have a “1” bit for the columns indicating “video camera,” “accelerometer,” “wireless radio,” and “GPS,” and a “0” bit for the other columns, e.g., “pedometer” and “radio.” This set of characteristics is shown merely as an example, and any single characteristic or set of characteristics could be substituted.

In some embodiments, the interface device database also comprises information about the interface device, including status and characteristic information. In some embodiments, the interface device database 28 comprises information about each interface device, including status and characteristic information. For example, the interface device database 28 may store an interface device, its position, and a list of sensors. A specific example is shown in FIG. 3A, in which a this list may be compiled in a number of different ways. For example, in an embodiment, the list of interface devices is compiled by providing a user interface for interface devices to interact with, and add their interface device information to the interface device database. In some embodiments, the interface device transmits all the characteristic and status information at once, and in other embodiments the interface device transmits the characteristic and status information at intervals. In some embodiments, the interface device transmits the characteristic and status information upon specific requests from the computing device 30, e.g., as shown in environment 100 of FIG. 1, the computing device 30 may send a request for interface device information 71.

Referring to FIG. 7A, for example, in some embodiments, operation 3116 may further include operation 306 depicting selecting two or more discrete interface devices from a database comprising the list of discrete interface devices, a position of the discrete interface devices, and at least one characteristic of the discrete interface devices (e.g., FIG. 2C depicts module 359 selecting two or more discrete interface devices (e.g., an iPhone and a Blackberry) from a database comprising the list of discrete interface devices (e.g., iPhone 00001, Blackberry 00001), a position of the discrete interface devices (e.g., iPhone 00001—71.3535N, 42.5253W, Blackberry 00001—68.3512N, 60.2355W), and at least one characteristic of the discrete interface devices (e.g., iPhone 00001—has an accelerometer, Blackberry 00001—has a seismometer)).

For example, in some embodiments, operation 3116 may further include operation 308 depicting selecting two or more discrete interface devices from a database comprising the list of discrete interface devices, a velocity of the discrete interface devices, and at least one characteristic of the discrete interface devices (e.g., FIG. 2C depicts module 360 selecting two or more discrete interface devices (e.g., an iPhone and a Blackberry) from a database comprising the list of discrete interface devices (e.g., iPhone 00001, Blackberry 00001), a velocity of the discrete interface devices (e.g., iPhone 00001—10 m/s, Blackberry 00001—65 m/s), and at least one characteristic of the discrete interface devices (e.g., iPhone 00001—has an accelerometer, Blackberry 00001—has a seismometer)).

Referring to FIG. 7A, for example, in some embodiments, operation 3116 may further include operation 310 depicting selecting two or more discrete interface devices from a database comprising the list of discrete interface devices, a data transfer rate of the discrete interface devices, and at least one characteristic of the discrete interface devices (e.g., FIG. 2C depicts module 361 selecting two or more discrete interface devices (e.g., an iPhone and a Blackberry) from a database comprising the list of discrete interface devices (e.g., iPhone 00001, Blackberry 00001), a data transfer rate of the discrete interface devices (e.g., iPhone 00001—800 KB/s, Blackberry 00001—225 KB/s), and at least one characteristic of the discrete interface devices (e.g., iPhone 00001—has an accelerometer, Blackberry 00001—has a seismometer)).

Referring to FIG. 7A, for example, in some embodiments, operation 3116 may further include operation 312 depicting selecting two or more discrete interface devices from a database comprising the list of discrete interface devices, at least one status of the discrete interface devices, and a presence or absence of a sensor at the discrete interface devices (e.g., FIG. 2C depicts module 362 selecting two or more discrete interface devices (e.g., an iPhone and a Blackberry) from a database comprising the list of discrete interface devices (e.g., iPhone 00001, Blackberry 00001), at least one status of the discrete interface devices (e.g., iPhone 00001—10 m/s, Blackberry 00001—65 m/s), and at least one presence or absence of a sensor at the discrete interface devices (e.g., iPhone 00001—has an accelerometer, Blackberry 00001—has a heart rate monitor)).

Referring to FIG. 7A, in some embodiments, operation 312 may further include operation 314 depicting selecting two or more discrete interface devices from a database comprising the list of discrete interface devices, at least one status of the discrete interface devices, and a presence or absence of a camera at the discrete interface devices (e.g., FIG. 2C depicts module 363 selecting two or more discrete interface devices (e.g., an iPhone and a Blackberry) from a database comprising the list of discrete interface devices (e.g., iPhone 00001, Blackberry 00001), at least one status of the discrete interface devices (e.g., iPhone 00001—10 m/s, Blackberry 00001—65 m/s), and at least one presence or absence of a sensor at the discrete interface devices (e.g., iPhone 00001—has an accelerometer, Blackberry 00001—has a 6.0 megapixel camera)).

Referring to FIG. 7B, in some embodiments, the selecting two or more discrete interface devices operation 3001 may include a determining an availability operation 3117A for determining an availability of discrete interface devices based on at least one availability status of the discrete interface devices (e.g., FIG. 2C depicts module 332 determining an availability (e.g., whether a discrete interface device meets conditions for transmitting) of discrete interface devices (e.g., “iPhone 00001 is at the location needed to carry out the subtask,”) based on at least one availability status (e.g., iPhone 00001 is within 100 m of the Eiffel Tower) of the discrete interface devices (e.g., iPhone, Blackberry, etc.)).

In some embodiments, for example, the status availability determining module 332 of the interface device selecting module 153 shown in FIG. 2C may determine an availability of interface devices based on at least one availability status of the discrete interface devices, by communicating with the interface devices, e.g., via the network interface 38, or via the polling interface 33, or by retrieving information from the interface device database 28. In the context of this application, “availability” and “available,” in the context of the discrete interface devices, means “having a status, a characteristic, or both, that makes the discrete interface device meet a condition of carrying out the task.” In some embodiments, operation 3117A may base the availability determination on a status of the discrete interface devices. For example, in some embodiments the status availability determining module 332 may use polling interface 33 to determine which discrete interface devices have availability. The polling interface 33 may send out a signal to interface devices, through the one or more communication networks 40, to request status information. In some embodiments, the status availability determining module 332 of the interface device selecting module 153 shown in FIG. 2C retrieves the status information for each discrete interface device by retrieving the information from a database, e.g., interface device database 28. For example, if the request data received in the receiving request data operation 1001 is “Take a 360 degree picture of the Eiffel Tower,” then the status availability determining module 332 may determine that only those devices within 200 meters of the Eiffel Tower are suitable for carrying out the task. Then, the status availability determining module 332 may retrieve a location status of the interface devices, and determine which devices meet the criterion or criteria, e.g., have a position that is within 200 meters of the Eiffel Tower. Thus, the status availability determining module 332 determines that discrete interface devices that have a status of “positioned within 200 meters of the Eiffel Tower” are available.

Referring to FIG. 7B, in some embodiments, the selecting two or more discrete interfaces operation 3001 that includes determining an availability operation 3117A also may include a selecting interface devices operation 3117B for selecting the two or more discrete interface devices based on the determined availability (e.g. FIG. 2C shows module 326 for selecting the two or more discrete interface devices (e.g., iPhone 00001, Blackberry 00001) based on the determined availability (e.g., distance from the Eiffel Tower)). In some embodiments of the invention, the selected interface devices are stored in the memory 34 for later use. In some embodiments of the invention, the interface devices that are determined to be available are selected as they are determined to be available, and that information is transmitted to other portions of the computing device 30 for transmission, which will be discussed in more detail herein.

Referring to FIG. 7B, in some embodiments, the availability operation 3117A may include operation 706 shows determining the availability of the discrete interface devices based on at least whether the discrete interface device is currently configured to carry out at least one of the one or more subtasks (e.g., FIG. 2C shows module 364 determining the availability of the discrete interface devices (e.g., iPhone 00001, iPad 00001) based on at least whether the discrete interface devices is currently configured to carry out the at least one of the one or more subtasks (e.g., iPhone 00001 and iPad 00001 are still in line of sight with the landmark for which a picture is requested)).

Referring to FIG. 7B, in some embodiments, the availability operation 3117A may include operation 708 shows determining the availability of the discrete interface devices based on at least a position of the discrete interface devices (e.g., FIG. 2C shows module 365 determining the availability of the discrete interface devices (e.g., iPhone 00001, iPad 00001) based on at least a position of the discrete interface devices (e.g., iPhone 00001 and iPad 00001 are still located within an area for which data has been requested, e.g., iPhone 00001 and iPad 00001 are “still in Times Square” or “still in Chicago” or “still on I-90”))).

Referring to FIG. 7B, in some embodiments, the availability operation 3117A may include operation 710 shows determining the availability of the discrete interface devices based on at least whether the discrete interface device is in communication with at least one of (e.g., FIG. 2C shows module 366 determining the availability of the discrete interface devices (e.g., iPhone 00001, iPad 00001) based on at least whether the discrete interface devices is currently configured to carry out the at least one of the one or more subtasks (e.g., iPhone 00001 and iPad 00001 are still in communication with communication networks 40 (e.g., AT&T EDGE network) and can send and receive data)).

Referring to FIG. 7B, in some embodiments, operation 710 may further include operation 712 shows determining the availability of the discrete interface devices based on at least whether the discrete interface device is in communication with a preferred communication network of the (e.g., FIG. 2C shows module 367 determining the availability of the discrete interface devices based on at least whether the discrete interface devices (e.g., iPhone 00001 and iPad 00005) are in communication with a preferred communication network (e.g., a Wi-Fi network rather than a Wireless Cellular network)). For example, in some embodiments, one or more of the discrete interface devices may incur charges for using particular types of communication networks, e.g., cellular networks, or analog “roaming” networks, and thus module 367 may select those discrete interface devices that are connected via a “preferred” communication network. In some embodiments, “preferred” may mean preferred by one or more of the discrete interface devices 20*, or preferred by computing device 30, or preferred by a provider of a communication network 40.

Referring to FIG. 7B, in some embodiments, operation 710 may further include operation 714 shows determining the availability of the discrete interface devices based on at least whether the discrete interface device is in communication with a communication network having the fastest data transfer speeds of the (e.g., FIG. 2C shows module 368 determining the availability of the discrete interface devices based on at least whether the discrete interface devices (e.g., iPhone 00001 and iPad 00005) are in communication with a network having the fastest data transfer speeds. For example, if there are ten iPhones available, and 8 of the iPhones are connected through a Wi-Fi network yielding 8 Mbps/second, and 2 of the iPhones are connected through a 3G wireless network yielding 1.5 Mbps/second, then module 368 may determine that the 8 iPhones connected through a Wi-Fi network have availability.

Referring to FIG. 7B, in some embodiments, operation 710 may further include operation 716 shows determining the availability of the discrete interface devices based on at least whether the discrete interface device is in communication with an encrypted communication network (e.g., FIG. 2C shows module 369 determining the availability of the discrete interface devices based on at least whether the discrete interface devices (e.g., iPhone 00001 and iPad 00005) are in communication with an encrypted network. For example, if there are ten iPhones available, and eight of the iPhones are connected through a Wi-Fi network secured with WPA-2, and two of the iPhones are connected through an open Wi-Fi network, then module 369 may determine that the eight iPhones connected through a secure Wi-Fi network have availability.

Referring to FIG. 7C, in some embodiments, operation 710 may further include operation 718 shows determining the availability of the discrete interface devices based on at least whether the discrete interface device is in communication with a wired communication network (e.g., FIG. 2C shows module 321 determining the availability of the discrete interface devices based on at least whether the discrete interface devices (e.g., iPhone 00001 and ASUS EeePc 00001) are in communication with a wired network (e.g., in this example, ASUS EeePc 00001 is connected to a WAN via an Ethernet cable, and iPhone 00001 is connected to a WAN via Wi-Fi, and thus module 370 may determine that the ASUS EeePc 00001 has availability.

Referring to FIG. 7C, in some embodiments, operation 710 may further include operation 720 shows determining the availability of the discrete interface devices based on at least whether the discrete interface device is in communication with a communication network having the lowest error rate of the (e.g., FIG. 2C shows module 322 determining the availability of the discrete interface devices based on at least whether the discrete interface devices (e.g., iPhone 00001 on EDGE network, iPad 00005 on Wi-Fi, BlackBerry 00003 on Verizon 4G LTE network, and Palm Pre on Sprint 4G network) are in communication with a communication network having the lowest error rate of the communication networks (e.g., which of the EDGE, Wi-Fi, 4G LTE, and Sprint 4G have the lowest error rate, the discrete interface devices communicating with that network will be determined to have availability)).

Referring to FIG. 7C, in some embodiments, operation 710 may further include operation 722 shows determining the availability of the discrete interface devices based on whether the discrete interface device is in communication with a communication network associated with a particular network provider (e.g., FIG. 2C shows module 322 determining the availability of the discrete interface devices based on at least whether the discrete interface devices (e.g., iPhone 00001 on EDGE network, BlacicBerry 00003 on Verizon 4G LTE network, and Palm Pre on Sprint 4G network) are in communication with a communication network associated with a particular network provider, e.g., Sprint)). In this example, Sprint is the particular network provider and the provider of the Sprint 4G network, and thus the Palm Pre interface device will be determined to have availability.

Referring to FIG. 7D, in some embodiments, the selecting two or more discrete interface devices operation 3001 may include a determining an availability operation 3118A for determining an availability of discrete interface devices based on at least one availability characteristic of the discrete interface devices (e.g., FIG. 2C depicts module 333 determining an availability (e.g., whether a discrete interface device meets conditions for transmitting) of discrete interface devices (e.g., “iPhone 00001” and “BlackBerry 00005”) based on at least one availability characteristic (e.g., iPhone 00001 has an accelerometer, Blackberry 00005 is a BlackBerry) of the discrete interface devices (e.g., iPhone, Blackberry, etc.)).

For example, the characteristic availability determining module 333 of the interface device selecting module 153 may determine an availability of interface devices based on at least one availability characteristic of the discrete interface devices, by communicating with the interface devices, e.g., via the network interface 38, or via the polling interface 33, or by retrieving the information from a previously stored database, e.g., the interface device database 28. The characteristic availability determining module 333 operates in a similar manner to the status availability determining module, except that the availability of the interface devices are determined by at least one characteristic of the interface devices, rather than by at least one status of the interface devices. For example, in the above-referenced “Eiffel Tower” example, in which the request data received in the receiving request data operation 1001 is “Take a 360 degree picture of the Eiffel Tower,” then the characteristic availability determining module 333 may determine that only those devices that have the characteristic of “have a camera” have an availability. For another example, if the request data received in the receiving request data operation is “Map a route from the Space Needle to the Fisherman's Market that has the least exposure to allergens,” then the characteristic availability determining module 333 may determine that only those devices that have the characteristic of “have an air quality sensor,” have an availability.

Referring to FIG. 7E, in some embodiments, the selecting two or more discrete interfaces operation 3001 that includes a selecting from a database operation 3118A also may include a selecting interface devices operation 3118B for selecting the two or more discrete interface devices based on the determined availability (e.g., FIG. 2C shows module 356 selecting the interface devices (e.g., “BlackBerry 00005”) that meet the availability criterion (e.g., “device is a BlackBerry”). In some embodiments of the invention, the selected interface devices are stored in the memory 34 for later use. In some embodiments of the invention, the interface devices that are determined to be available are selected as they are determined to be available, and that information is transmitted to other portions of the computing device 30 for transmission, which will be discussed in more detail herein.

Referring to FIG. 7E, in some embodiments, operation 3118A may further include operation 724 shows determining the availability of the discrete interface devices based on whether the discrete interface device is currently configured to carry out at least one of the one or more subtasks (e.g., FIG. 2C shows module 324 determining the availability of the discrete interface devices (e.g., iPhone 00001, BlackBerry 00005, iPad 00002) based on whether the discrete interface device is currently configured to carry out at least one of the one or more subtasks (e.g., whether the discrete interface device has a characteristic (e.g., a sensor necessary to carry out the subtasks))). For example, if one of the one or more subtasks is “determine the temperature,” then available discrete interface devices 20* would all have the characteristic of “having a thermometer.”

Referring to FIG. 7E, in some embodiments, operation 3118A may further include operation 726 shows determining the availability of the discrete interface devices based on a type of discrete interface device (e.g., FIG. 2C shows module 325 determining the availability of the discrete interface devices (e.g., iPhone 00001, BlackBerry 00005, iPad 00002, ASUS EeePc 00001) based on a type of discrete interface device (e.g., “mobile device,” “laptop computer,” “tablet,” etc.). In an example, the type of discrete interface device may be “tablet,” in which case operation 726 may indicate the iPad 00002 as having availability, because it is a “tablet” device.

Referring to FIG. 7E, in some embodiments, the selecting two or more discrete interfaces operation 3001 includes a determining availability operation 3119A determining an availability of discrete interface devices based on at least one availability characteristic and at least one availability status of the discrete interface devices (e.g., FIG. 2C shows module 327 determining an availability of discrete interface devices (e.g., TomTom 00001, ASUS EeePc 00001, iPhone 00001, HP TouchPad 00001, Amazon Kindle 000001) based on at least one availability characteristic (e.g., “has a camera”) and at least one availability status of the discrete interface device (e.g., “is connected to a communication network that can transmit data at speeds greater than 1 Mbps/second.” The status and characteristic availability determining module 334 operates in a similar manner to the status availability determining module 332 and the characteristic availability determining module 333, except that the availability of the interface devices are determined by at least one characteristic of the interface devices and by at least one status of the interface devices, rather than one or the other. For example, in the above-referenced “Eiffel Tower” example, in which the request data received in the receiving request data operation 1001 is “Take a 360 degree picture of the Eiffel Tower,” then the characteristic availability determining module 333 may determine that only those devices that have a characteristic of “have a camera” and also have a status of “within 200 meters of the Eiffel tower” have an availability.

Referring to FIG. 7E, in some embodiments, the selecting two or more discrete interfaces operation 3001 that includes a determining an availability operation 3119A also may include a selecting interface devices operation 3119B for selecting the two or more discrete interface devices based on the determined availability (e.g., FIG. 2C shows module 357 selecting the two or more interface devices (e.g., “iPhone 00001” and “HP TouchPad 00001”) that meet the availability criterion (e.g., “has a camera” and “device is connected to a communications network having data transfer speeds of at least 1 Mbps/second”))). In some embodiments of the invention, the selected interface devices are stored in the memory 34 for later use. In some embodiments of the invention, the interface devices that are determined to be available are selected as they are determined to be available, and that information is transmitted to other portions of the computing device 30 for transmission, which will be discussed in more detail herein.

Referring to FIG. 7D, in some embodiments, the selecting two or more discrete interfaces operation 3001 may include a selecting interface devices operation 3120 shows selecting two or more discrete interface devices based only on the status of the two or more discrete interface devices (e.g., FIG. 2C shows module 335 selecting two or more discrete interface devices (e.g., “iPhone 00001” and “HP TouchPad 00001”) based only on the status of the two or more discrete interface devices, e.g. (“devices within 200 meters of a particular location”)). Thus, in some embodiments, interface devices may be selected only based on their status. For example, if the task is “find a geographic location within six blocks of my location that has the strongest wireless interne signal,” then the subtask may be “determine the strength of the wireless signal,” and interface devices meeting the status “located within six blocks of the querying device's location” are selected. In some embodiments, this is the only selection criterion applied, and all such devices meeting the status are selected. It is noted that in some embodiments, this may result in selecting some devices that may not be suitable for carrying out the task, e.g., a GPS device without a wireless radio may be selected. Nevertheless, as will be discussed herein, it is not necessary to receive result data from each selected interface device in order to carry out a task. Moreover, in some embodiments, the computing device 30 may limit the total computations or database queries when selecting interface devices, and this process allows the processing power of the computing device 30 to be conserved.

Referring to FIG. 7F, in some embodiments, the selecting two or more discrete interface devices operation 3001 may include a selecting interface devices operation 3121 for selecting two or more discrete interface devices based only on the characteristic of the two or more discrete interface devices (e.g., FIG. 2C shows module 336 selecting two or more discrete interface devices (e.g., “iPhone 00001” and “HP TouchPad 00001”) based only on the characteristic of the two or more discrete interface devices, e.g. (“has an air quality sensor”)). In some embodiments, interface devices may be selected only based on a characteristic. For example, if the task is “determine allergen hotspots (places having high allergens), then the subtask may be “measure allergen content,” and interface devices having the characteristic “has an air quality sensor,” are selected. Similarly to as above, in some embodiments, this is the only selection criterion applied, and all such devices meeting the requested characteristic are selected. Although this may be required to carry out some tasks, it is noted that in some embodiments, this may result in selecting some devices that may not be suitable for carrying out the task. Nevertheless, as will be discussed herein, it is not necessary to receive result data from each selected interface device in order to carry out a task. Moreover, in some embodiments, the computing device 30 may limit the total computations or database queries when selecting interface devices, and this process allows the processing power of the computing device 30 to be conserved.

Referring to FIG. 7F, in some embodiments, the selecting two or more discrete interface devices operation 3001 may include an acquiring a predetermined list operation 3124A for acquiring a list of discrete interface devices (e.g., FIG. 2C shows predetermined list acquiring module 338 acquiring (e.g., generating, retrieving, or receiving), a list of discrete interface devices (e.g., “iPhone 00001,” “iPhone 00002,” and “ASUS EeePc 00001”)). Thus, in some embodiments, the list of interface devices may be stored in interface device database 28 and retrieved by the predetermined list acquiring module 338. In some embodiments, the list may be received from an interface device, from the querying device, from a provider of the one or more communication networks 40, from a provider of the computing device 30, or from a combination of these, or from any other source of lists of interface devices. The list may be predetermined, and may be acquired in various ways, which will be discussed in more detail herein.

Referring to FIG. 7F, in some embodiments, operation 3124B depicts selecting the two or more discrete interface devices from the predetermined list of discrete interface devices (e.g., FIG. 2C shows module 339 selecting the two or more discrete interface devices (e.g., “iPhone 00001” and “iPhone 00002”) from the predetermined list of discrete interface devices (e.g., “iPhone 00001,” “iPhone 00002,” and “ASUS EeePc 00001”)). For example, in various embodiments, the list may have been assembled based on any of various criteria, including, but not limited to status and characteristic information of the interface devices, subscriber information of the interface devices, or a separate ranking or selecting system for generating lists of interface devices. In some embodiments, the two or more discrete interface devices are selected from the list of interface devices without further processing. In some embodiments, all of the interface devices from the list of interface devices are selected. In other embodiments, computing device 30 further selects interface devices from the list of interface devices, by selecting devices from the list of interface devices that meet a characteristic or status, similarly to as described above. For example, the computing device 30 may have a list of interface devices that the computing device 30 considers to be “trusted” interface devices. For example, certain interface devices may have completed a registration process by submitting information to a database that is accessible to the computing device 30. For another example, the computing device 30 may maintain a list of interface devices that have provided information before, and the computing device 30 may consider these devices “trusted” interface devices.

Referring to FIG. 7F, in some embodiments, the acquiring a predetermined list operation 3124A may include an external source receiving operation 3225 for receiving the list of discrete interface devices from an external source (e.g., FIG. 2C shows module 348 receiving the list of discrete interface devices (e.g., (“iPad 00001,” iPhone 00001,” “iPad 00002,” “iPhone 00002,” TomTom Navi 00001,” Asus EeePc 00005,” and “Wachovia ATM machine 00001”) from an external source (e.g., a server that charges owners of interface devices to be listed on a predetermined list)). For example, external source predetermined list acquiring module 348 of predetermined list acquiring module 338 of interface device selecting module 153 may receive the predetermined list of discrete interface devices, e.g., the predetermined list of discrete interface devices 65, as shown in environment 100 from an external source. The external source may be a communications network provider, as will be described in more detail herein, or it may be a provider of a different type of service. For example, a separate service may distribute interface devices that can be used to carry out tasks, and may keep a list of those interface devices. The operator of the service may contract with the operator of the computing device 30 to use the service operator's distributed interface devices. Thus, the service operator may transmit a list of interface devices for use by the computing device 30.

Referring to FIG. 7F, in some embodiments, the external source receiving operation 3225 may include a communications network receiving operation 3226 depicting receiving the list of discrete interface devices from a provider of a communications network (e.g., FIG. 2C shows module 349 receiving the list of discrete interface devices (e.g., (“iPad 00001,” iPhone 00001,” “iPad 00002,” “iPhone 00002,” TomTom Navi 00001,” Asus EeePc 00005,” and “Wachovia ATM machine 00001”) from a provider of a communications network, e.g., Sprint)). In other embodiments, for example, in the Eiffel tower example described above, the computing device 30 may have a contract in place with a communications network provider, e.g., AT&T, to use interface devices that are part of the AT&T network. In this example, AT&T may transmit a list of interface devices to the computing device 30, and the interface device selecting module 338 of interface device selecting module 153 selects the interface devices from this list.

In some embodiments, the acquiring a predetermined list operation 3124A may include a request data list retrieving operation 3227 for retrieving the list of discrete interface devices from the received request data (e.g., FIG. 2C shows module 349 receiving the list of discrete interface devices (e.g., (“iPad 00001,” iPhone 00001,” “iPad 00002,” “iPhone 00002,” TomTom Navi 00001,” Asus EeePc 00005,” and “Wachovia ATM machine 00001”) from the received request data in operation 1001 (e.g., request data 72, e.g., the request data including the request to “take a picture of the Eiffel Tower”))). Thus, in some embodiments, the request data includes the request to carry out a task of acquiring information, and also includes a predetermined list of interface devices for carrying out subtasks for completing the task of acquiring information. In some embodiments, rather than the list itself, the request data contains a pointer or a reference to a location where the predetermined list of interface devices is stored. As an example, the request data including a request to carry out a task of acquiring data is sent from a specific type of device, e.g., an iPhone, and received with the request data 64 in the receiving request data operation 1011, as shown in environment 100 shown in FIG. 1. For example, the querying device 15, e.g., the iPhone, may request that only other iPhones should be used to carry out that request.

Referring to FIG. 7G, operation 3128A depicts selecting two or more discrete interface devices based on at least one status of the two or more discrete interface devices (e.g., FIG. 2C shows module 351 selecting two or more discrete interface devices (e.g., “Nokia E5 00001,” “Motorola Droid 00001,” and “BlackBerry Pearl 00001”) based on at least one status of the two or more discrete interface devices (e.g. “is connected to an encrypted communication network”). In some embodiments, the selecting interface devices operation 3128A may be carried out similarly to the availability determining operation 3117A, as described in more detail above.

Referring to FIG. 7G, in some embodiments, operation 3128B depicts selecting, from the previously selected two or more discrete interface devices, two or more discrete interface devices based on at least one characteristic of the two or more discrete interface devices (e.g., FIG. 2C shows module 352 selecting, from the previously selected two or more discrete interface devices (e.g., “Nokia E5 00001,” “Motorola Droid 00001,” and “BlackBerry Pearl 00001”), two or more discrete interface devices (e.g. “Motorola Droid 00001” and “BlackBerry Pearl 00001”) based on at least one characteristic of the two or more discrete interface devices, e.g., (“has Bluetooth capability”). Thus, in some embodiments, module 352 may use the previously selected two or more discrete interface devices, and from that group of previously selected two or more discrete interface devices, may select two or more discrete interface devices based on a characteristic of the two or more discrete interface devices. As an example, using the previously described “Eiffel Tower” example, a task of “Take a 360-degree picture of the Eiffel Tower” may be subdivided into fifty subtasks of “take a picture of the Eiffel Tower,” which may be distributed to fifty interface devices. First, interface devices that have a particular status may be selected. For example, the selecting interface devices operation 3128A may select interface devices that meet the status of “within 200 meters of the Eiffel Tower.” From this group of interface devices, selecting interface devices operation 3128B may select interface devices that meet the characteristic of “have a still camera.” The selected two or more interface devices, then, are interface devices that meet the criteria “within 200 meters of the Eiffel Tower,” and “have a still camera.” This two-part selection process may be faster than selecting two or more interface devices based on multiple characteristics at once, thereby increasing the speed of the selecting operation for some embodiments. This can be seen from the previous example, in which, in some embodiments, there may be substantially fewer interface devices within 200 meters of the Eiffel Tower than interface devices that have a still camera.

Referring to FIG. 7G, in some embodiments, the selecting two or more discrete interface devices operation 3001 may include a selecting interface devices operation 3129A for selecting two or more discrete interface devices based on at least one characteristic of the two or more discrete interface devices (e.g., FIG. 2C shows module 353 selecting two or more discrete interface devices (e.g., “Galaxy Tab 00008,” “Dell XPS 15 00004,” and “Nook Color 00003”) based on at least one characteristic of the two or more discrete interface devices (e.g., “has a microphone”)). For example, in some embodiments, the selecting interface devices operation 3129A may be carried out similarly to the availability determining operation 3118A, as described in more detail above.

Referring to FIG. 7G, in some embodiments, operation 3129B depicts selecting, from the previously selected two or more discrete interface devices, two or more discrete interface devices based on at least one status of the two or more discrete interface devices (e.g., FIG. 2C shows module 354 selecting, from the previously selected two or more discrete interface devices (e.g., “Galaxy Tab 00008,” “Dell XPS 15 00004,” and “Nook Color 00003”), two or more discrete interface devices (e.g. “Galaxy Tab 00008” and “Nook Color 00003”) based on at least one status of the two or more discrete interface devices (e.g., “is currently operating at a temperature below 70 degrees Fahrenheit”)). For example, using the previously described “Eiffel Tower” example, a task of “Take a 360-degree picture of the Eiffel Tower” may be subdivided into fifty subtasks of “take a picture of the Eiffel Tower,” which should be transmitted to fifty interface devices. First, interface devices that have a particular characteristic may be selected. For example, the selecting interface devices operation 3129A may select interface devices that meet the characteristic of “have a still camera.” From this group of interface devices, selecting interface devices operation 3129B may select interface devices that meet the status of “within 200 meters of the Eiffel Tower.” For another example, a user of a querying interface device may be relocating to Los Angeles, and may generate a task of “determine which part of Los Angeles has the best air quality.” This task may be subdivided into tasks of “determine air quality” and targeted to interface devices in Los Angeles. The selecting interface devices operation 3129A selects interface devices having the characteristic of “has an air quality sensor.” Then, from this group of interface devices, selecting interface devices operation 3129B selects those interface devices in Los Angeles. In this example, there may be substantially fewer interface devices that have air quality sensors than interface devices in Los Angeles, thus the amount of time needed to carry out the selecting two or more interface devices operation 3001 may be reduced.

Referring to FIG. 7G, in some embodiments, operation 728 depicts selecting two or more discrete interface devices based on one or more of a position of the two or more discrete interface devices, a proximity of the two or more discrete interface devices to a predetermined point, an acceleration of the two or more discrete interface devices, a velocity of the two or more discrete interface devices, and an ambient condition surrounding the interface device and a characteristic of the two or more discrete interface devices (e.g., FIG. 2C shows module 398 selecting two or more discrete interface devices based on one or more of a position of the two or more discrete interface devices (e.g., “71.3253N, 42.5151W”), a proximity of the two or more discrete interface devices to a predetermined point (e.g., “within 200 m of the Grand Canyon Observation Deck”), an acceleration of the two or more discrete interface devices (e.g., “9.8 m/s/s”), a velocity of the two or more discrete interface devices (e.g., “51 M.P.H.”), and an ambient condition surrounding the interface device (e.g., “temperature above 80 degrees Fahrenheit”) and a characteristic of the two or more discrete interface devices (e.g. “device is an iPad”)).

Referring to FIG. 7G, in some embodiments, operation 728 depicts selecting two or more discrete interface devices based on at least one of a status of the two or more discrete interface devices and the presence of one or more of a Global Positioning System (GPS) sensor, a still camera, a video camera, an altimeter, an air quality sensor, a barometer, an accelerometer, a charge-coupled device, a radio, a thermometer, a pedometer, a heart monitor, a moisture sensor, a humidity sensor, a microphone, a seismometer, and a magnetic field sensor (e.g., FIG. 2C shows module 399 selecting two or more discrete interface devices based on at least one of a status of the two or more discrete interface devices and the presence of one or more of a Global Positioning System (GPS) sensor, a still camera (e.g., a 6.0 megapixel camera), a video camera (e.g., a 1080p HD video camera), an altimeter, an air quality sensor, a barometer, an accelerometer, a charge-coupled device (e.g., a brightness or light sensor), a radio (e.g., AM, FM, XM/Sirius, or wireless), a thermometer, a pedometer, a heart monitor, a moisture sensor, a humidity sensor, a microphone, a seismometer, and a magnetic field sensor).

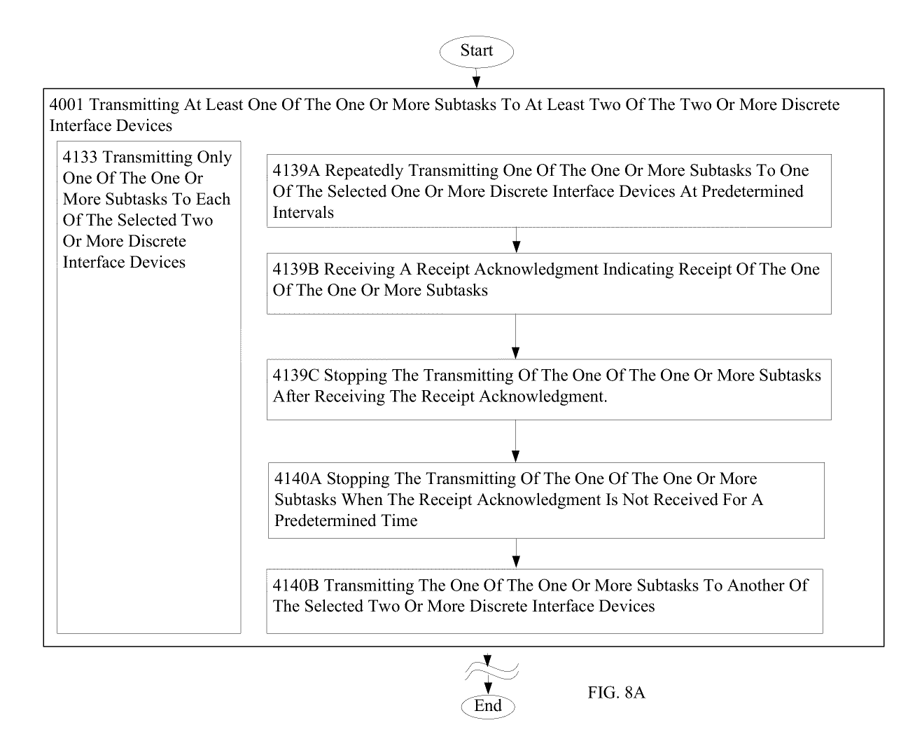

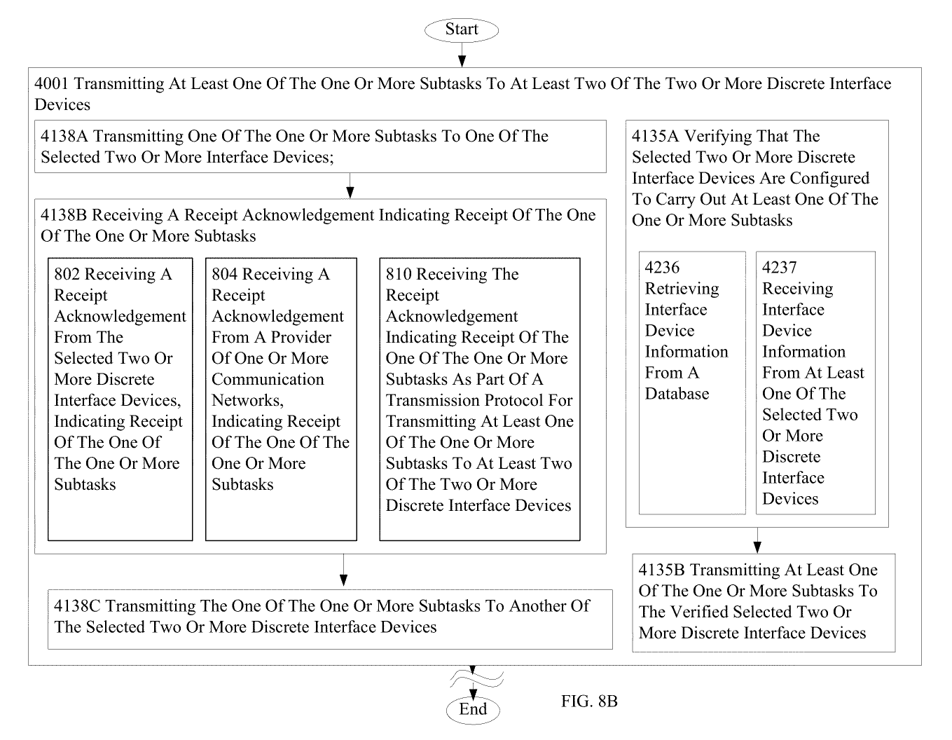

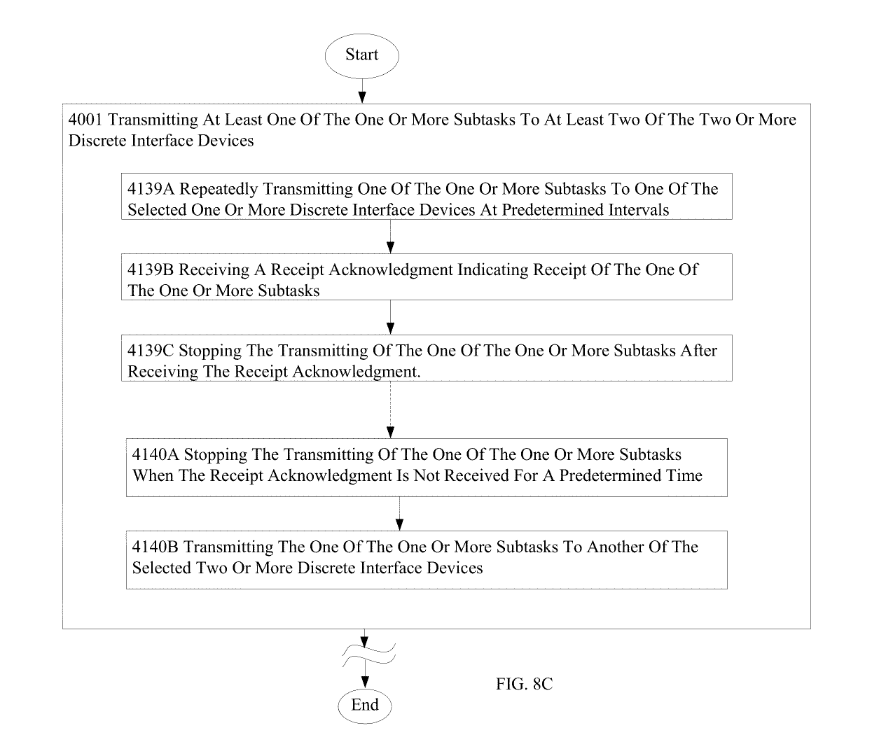

Referring to FIGS. 1 and 4, in addition to the selecting two or more discrete interface devices operation 3001, operational flow 400 of FIG. 4 may also include a transmitting operation 4001 shows transmitting at least one of the one or more subtasks to at least two of the two or more discrete interface devices. Referring to FIG. 8A, in some embodiments, operation 4132 depicts transmitting at least one of the one or more subtasks to each of the selected two or more discrete interface devices (e.g., FIG. 2D shows each-device transmitting module 421 of subtask transmitting module 154 transmitting at least one of the one or more subtasks (e.g. “take a picture of the Grand Canyon”) to each of the selected two or more discrete interface devices. For example, in some embodiments, each-device transmitting module 421 may traverse through the group of one or more subtasks. Each time a new subtask is traversed, each-device transmitting module 421 may transmit that subtask to all of the selected two or more discrete interface devices. For example, if the selecting two or more discrete interface devices operation 3001 selects twenty-five discrete interface devices, and the acquiring one or more subtasks operation 2001 acquires one subtask, e.g., “take a picture of the Eiffel Tower,” then transmitting operation 4132 includes sending the “take a picture of the Eiffel Tower” subtask to each of the selected twenty-five discrete interface devices. In this example, the selecting two or more discrete interface devices operation 3001 may already have selected interface devices that have a status of “have a location within 200 meters of the Eiffel Tower,” and a characteristic of “have a still camera.”

In some embodiments, subtask transmitting module 154 may transmit one of the one or more subtasks to each of the selected two or more interface devices. For example, the receiving request data operation 1001 may receive a task of “Determine the photography conditions at the Space Needle,” and the acquiring one or more subtasks operation 2001 may acquire subtasks of “determine the temperature at the Space Needle,” “determine the brightness at the Space Needle,” “determine the humidity at the Space Needle,” and “determine the air quality at the Space Needle.” Then, for example, the selecting two or more discrete interface devices operation 3001 may select one hundred discrete interface devices. In this example, the transmitting operation 4133 may include the single-subtask transmitting module 422 transmitting only one of the four subtasks to each of the two or more discrete interface devices operation. In some embodiments, the transmitting operation 4133 may transmitting each of the four subtasks to the same number of interface devices, e.g., to twenty-five interface devices. In other embodiments, the transmitting operation may 4133 may include transmitting each of the for subtasks to a different number of interface devices, depending on a variety of factors, including the complexity of the subtask, the types of interface devices, or any other characteristic or status of the interface devices.

Referring to FIG. 8B, in some embodiments, the transmitting operation 4001 may include operation 4135A depicting verifying that the selected two or more discrete interface devices are configured to carry out at least one of the one or more subtasks (e.g., module 424 depicts verifying that the selected two or more discrete interface devices (e.g., BlackBerry 00001 and BlackBerry 00002) are configured to carry out (e.g., have the sensors necessary, e.g., have an altimeter) at least one of the one or more subtasks (e.g., BlackBerry 00001 and BlackBerry 00002 have an altimeter, so they can carry out the subtask of “Determine the lowest altitude from Mt. Rainer at which the Space Needle is visible today.”) In some embodiments, the verification process performed by device verification module 424 may be completed internally, e.g., within computing device 30, e.g., as will be discussed in more detail with respect to retrieving operation 4236. In addition, the verification process may be completed externally, e.g., by communicating with an interface device or a third party via network interface 38 and one or more communication networks 40, as will be discussed in more detail with respect to receiving operation 4237. The verification process may vary in different embodiments. In some embodiments, for example, the interface device verification module 424 determines the subtask that will be transmitted to the interface devices, and determines one or more status and characteristic properties that the interface device needs in order to carry out the task. The interface device verification module 424 then determines whether the interface device has that status and/or characteristic property, either by communicating with the interface device, e.g., via network interface 38 or polling interface 33, or by retrieving information about the interface device from a database, e.g., a database stored internally to the computing device 30, or a database stored externally at a location accessible by the one or more communication networks 40, e.g., a service provider database.

In other embodiments, the interface verification module 424 may determine one or more status and/or characteristic properties that are unrelated to completing the task. For example, in some embodiments of the invention, when some or all of the selected two or more interface devices are devices that have contracts with service providers, the subtask transmitting module 154 may want to transmit subtasks only to those interface devices that are in good standing with their service providers. Thus, the interface device verification module 424 may complete a verifying operation 4135A by retrieving information about the interface devices from a service provider, e.g., a third party service provider. In another example, the computing device 30 may have an internal or external ranking system for ranking the interface devices, based on a variety of criteria. For example, the computing device 30 may store a ranking, e.g., a score or a point value, for the interface devices, and increment that ranking each time an interface device successfully completes a subtask. The example here is provided merely for exemplary purposes, and other embodiments may implement a ranking system in other manners.

Referring to FIG. 8B, the transmitting operation 4001 also may include operation 4135B for transmitting at least one of the one or more subtasks to the verified selected two or more discrete interface devices (e.g., FIG. 2D depicts module 425 transmits the one or more subtasks (e.g., “Determine the highest altitude of Mt. Rainer from which the Space Needle is visible”) to the verified selected two or more interface devices (e.g., BlackBerry 00001 and BlackBerry 00002, which have been verified as having an altimeter)). Transmission of the one or more subtasks to the verified selected two or more interface devices may occur in a similar manner as described above. In some embodiments, the verified transmitting operation 4135B takes place after verifying operation 4135A has completed verifying the interface devices of the selected two or more interface devices. In some other embodiments, the verified transmitting operation 4135B takes place concurrently or substantially concurrently with the verifying operation 4135A.

In some embodiments, the verifying operation 4135A includes a retrieving operation 4236 shows retrieving interface device information from a database (e.g., FIG. 2D depicts module 436 retrieving interface device information (e.g., a list of interface devices that have video cameras, or whether certain interface devices have permission to perform subtasks) from a database (e.g., a database stored internally in memory 34 of computing device 30 (e.g., a SQL database stored on a Microsoft web server))). For example, in some embodiments, for the selected two or more interface devices, the interface device information retrieving module 436 of the verified interface device transmitting module 424 may retrieve information regarding the two or more interface devices from the database.

In some embodiments, the database may merely be a database for determining whether interface devices are allowed to perform subtasks. For example, the database information may be explicit, e.g., “allow [interface device] to perform subtasks,” or may require further processing, e.g., “allow [interface device] to perform [some subset of subtasks].” In other embodiments, the database information may be unrelated to subtasks, and may require further decision-making by the retrieving operation 4236. For example, in some embodiments, the transmitting operation 4001 may want to transmit subtasks only to interface devices that are in good standing with their service provider, if they have a service provider. In this example, for instance, the retrieving operation 4236 may retrieve a list of interface devices from the service provider that are in good standing, and compare it against the selected two or more discrete interface devices. In other examples, for instance, the retrieving operation 4236 may query the service provider's database for each of the selected two or more interface devices to determine whether the discrete interface device is in good standing with the service provider.

In some embodiments, the verifying operation 4135A of the transmitting operation 4001 includes a receiving operation 4237 for receiving interface device information from at least one of the selected two or more discrete interface devices (e.g., FIG. 2D shows module 437 receiving interface device information (e.g., “this device is not authorized to perform this subtask,”) from at least one of the selected two or more discrete interface devices (e.g., BlackBerry 00005, HTC Evo 00002)). The interface device information may be specific to the subtask that is being transmitted (e.g., the device is not authorized to perform this particular subtask), or may be general device information of any level of specificity (e.g., this device is not authorized to perform any subtasks using this sensor, or this device is not authorized to perform subtasks))). For another example, in some embodiments of the invention, the verification may involve determining whether an operator of the interface device is willing to perform the subtask. In this example, for each of the selected interface devices, the interface device receiving module 437 may send a message via the one or more communication networks 40 to the discrete interface device. The message may request confirmation of willingness to carry out the subtask. In another example, the verifying operation 4135A may determine whether the selected discrete interface devices are in communications with the computing device 30 via the one or more communication networks 40. For example, the verifying operation 4237 may “ping,” e.g., send a short signal verifying successful communications to, the discrete interface devices to determine that the interface devices have not powered down, or lost signal, for example, and are still capable of carrying out the task. For another example, the verifying operation 4237 may determine that the information used when selecting the interface devices is correct and has not changed, e.g., confirming a status or characteristic of the interface devices. For example, if the selected two or more interface devices were selected at least because of their proximity to the Eiffel Tower, then in some embodiments, the verifying operation 4237 may confirm that the interface device maintains the proximity to the Eiffel Tower.

Referring to FIG. 8B, in some embodiments, the transmitting operation 4001 may include a transmitting one subtask operation 4138A for transmitting one of the one or more subtasks to one of the selected two or more discrete interface devices (e.g., FIG. 2D depicts module 426 transmitting one of the one or more subtasks (e.g., “take a picture of the artwork on the wall of the coffee shop”) to one (e.g., “BlackBerry 00001”) of the selected two or more discrete interface devices (e.g., “BlackBerry 00001 and iPhone 00002”)). Transmission may take place, for example, via network interface 38 and communications network 40, similarly to as described above. In the transmitting one subtask operation 4138A, the subtask is sent to one of the selected two or more discrete interface devices.

Referring to FIG. 8B, thus, in some embodiments, in which the transmitting operation 4001 includes the transmitting one subtask operation 4138A, the transmitting operation 4001 also includes operation 4138B depicting receiving a receipt acknowledgement indicating receipt of the one of the one or more subtasks (e.g., FIG. 2D shows module 427 of subtask transmitting module 427 receiving a receipt acknowledgment (e.g., an ACK bit from a TCP/IP transfer, or a text string stating “the interface device has successfully received the transmitted subtask,”) indicating receipt of the one of the one or more subtasks (e.g., “take a picture of the artwork on the wall of the coffee shop”)).

Referring to FIG. 8B, in some embodiments, operation 4138B may further include operation 802 depicting receiving a receipt acknowledgement from the selected two or more discrete interface devices, indicating receipt of the one of the one or more subtasks (e.g., FIG. 2D depicts module 820 receiving a receipt acknowledgment (e.g., “subtask has been received”) from the selected two or more discrete interface devices (e.g. “iPhone 00001 and iPad 03012”)), indicating receipt of the one of the one or more subtasks (i.e., “what does the view of the scoreboard look like from Section 112, Row E of Safeco Field”)). In other embodiments, the receipt acknowledgment may take any form, and does not necessarily need to have the same data format or be transmitted through the same data paths as the transmission of the one or more subtasks.

Referring to FIG. 8B, in some embodiments, operation 4138B may further include operation 804 depicting receiving a receipt acknowledgement from a provider of communication networks, indicating receipt of the one of the one or more subtasks (e.g., FIG. 2D shows module 822 receiving a receipt acknowledgment (e.g., “AT&T has confirmed receipt of the transmitted one or more subtasks,” from a provider (e.g., AT&T) of communication networks (e.g., EDGE, 3.5G) indicating receipt of the one of the one or more subtasks (e.g., “which route from downtown Chicago is currently the fastest to Naperville”). For example, in some embodiments, the service provider of the interface device, or the provider of the communications network 40 used to transmit the subtask to the interface device, may transmit the receipt acknowledgment to the computing device 30.

Referring to FIG. 8B, in some embodiments, operation 4138B may further include operation 806 shows receiving the receipt acknowledgement indicating receipt of the one of the one or more subtasks as part of a transmission protocol for transmitting at least one of the one or more subtasks to at least two of the two or more discrete interface devices (e.g., FIG. 2D shows module 828 receiving the receipt acknowledgment (e.g., Selective ACKnowledgment (SACK) option (e.g., as defined in RFCs 2018 and 2883, in which the data receiving source selectively sends an acknowledgment of blocks of data that were successfully received) indicating receipt of the one of the one or more subtasks (e.g., “Determine cloud cover in Portland today?”) as part of a transmission protocol (e.g., TCP/IP) for transmitting at least one of the one or more subtasks (e.g., “How cloudy is Portland today”) to at least two of the two or more discrete interface devices (e.g., iPad 03532 and ASUS EeePc 03515)). Other receipt acknowledgment techniques known to those skilled in the art also may be used to carry out the receipt operation.

Referring to FIG. 8B, in some embodiments, in which the transmitting operation 4001 includes operations 4138A and 4138B, the transmitting operation 4001 also may include a transmitting one subtask to another interface device operation 4138C for transmitting the one of the one or more subtasks to another of the selected two or more discrete interface devices after receiving the receipt acknowledgement (e.g., FIG. 2D shows module 418 transmitting the one of the one or more subtasks (e.g. “take a picture of Mt. Rushmore”) to another of the selected two or more discrete interface devices (e.g., iPhone 00002″) after receiving the receipt acknowledgment (e.g., “BlackBerry 00001 from operation 4138B has received the one or more subtasks”)). In some embodiments, this process may repeat until the subtasks are distributed to all of the selected discrete interface devices. In addition, in some embodiments, for example, those embodiments where a receipt acknowledgment is embedded into the transmission protocol, the transmitting may occur sequentially, i.e., one transmission right after another.

Referring to FIG. 8A, in some embodiments, operation 4001 may include operation 4139A depicting repeatedly transmitting one of the one or more subtasks to one of the selected two or more discrete interface devices at predetermined intervals (e.g., FIG. 2D shows module 428 repeatedly transmitting one of the one or more subtasks (e.g., “determine the wireless network strength of the strongest open wireless network at your location”) to one of (e.g., “iPhone 00001”) the selected two or more discrete interface devices (e.g., “iPhone 00001 and Droid X 00002”) at predetermined intervals (e.g., once every minute)). The number of times the transmission is carried out may be set by computing device 30, or may be variable, depending upon a number of factors, including, but not limited to, a status or characteristic of an interface device, a property of the communications network 40, or a setting of the computing device 30, either constant or variable based on one or more conditions. In addition, the predetermined intervals may be variable or constant, and may be of different lengths, or the same length, depending on the embodiment. In some embodiments, the predetermined intervals are calculated at the time of transmission, and in other embodiments, the predetermined intervals are retrieved from a database, either internal or external to computing device 30. As will be discussed herein, the repeated transmission may be broken when certain conditions are met.

Referring to FIG. 8A, in some embodiments in which the transmitting operation 4001 includes a repeatedly transmitting operation 4139A, the transmitting operation 4001 also may include operation 4139B depicting receiving a receipt acknowledgement indicating receipt of the one of the one or more subtasks (e.g. FIG. 2D shows module 419 receiving a receipt acknowledgment (e.g., “iPhone 00001 has received the transmitted subtask”) of the one of the one or more subtasks (e.g. “determine the wireless network strength of the strongest open wireless network at your location”)).

Referring to FIG. 8A, moreover, in some embodiments in which the transmitting operation 4001 includes operation 4139A and operation 4139B transmitting operation 4001 also may include operation 4139C depicting stopping the transmitting of the one of the one or more subtasks after receiving the receipt acknowledgement (e.g., FIG. 2D shows module 429 stopping the transmitting of the one of the one or more subtasks (e.g., “determine the wireless network strength of the strongest open wireless network at your location”) after receiving the receipt acknowledgement (e.g., “iPhone 00001 has received the transmitted subtask”)). Stopping transmission module 429 may carry out the stopping transmitting operation 4139C in a variety of ways. For example, stopping transmission module 429 may send a signal to repeated transmission module 428 to stop transmitting the subtask to the interface device. In other embodiments, the transmission may be stopped or intercepted at any point along the communications path, either internal to the computing device 30, or external to the computing device 30.

Referring to FIG. 8A, in some embodiments in which operation 4001 includes operation 4139A, operation 4139B, and operation 4139C, operation 4001 also may include operation 4140A for stopping the repeated transmitting of the one of the one or more subtasks when the receipt acknowledgement is not received for a predetermined time (e.g., FIG. 2D shows module 416 stopping the repeated transmitting of the one of the one or. For example, stopping the repeated transmitting of the one of the one or more subtasks (e.g., “determine the wireless network strength of the strongest open wireless network at your location”) when the receipt acknowledgment (e.g., “iPhone 00001 has received the transmitted subtask”) is not received for a predetermined time (e.g., 60 seconds)). For example, repeated transmission module 416 of subtask transmitting module 154 may stop the transmission of the one of the one or more subtasks when the receipt acknowledgment is not received for a predetermined time. For example, a predetermined time may be set by the stopping transmission module, or may be received from a source either external or internal to computing device 30. The predetermined time may be a constant, or the predetermined time may be calculated based on one or more factors, including, but not limited to, the type of subtask, a property of computing device 30, a property of communications network 40, and a property of the interface device 20*.

In some embodiments, in which transmitting operation 4001 includes operation 4140A, the transmitting operation 4001 also may include operation 4140B for transmitting the one of the one or more subtasks to another of the selected two or more discrete interface devices (e.g., FIG. 2D shows module 417 transmitting the one of the one or more subtasks (e.g., “determine the wireless network strength of the strongest open wireless network at your location”) to another of (e.g., “Droid X 00002”) the selected two or more discrete interface devices (e.g., “iPhone 00001” and “Droid X 00002”)). The transmitting to another interface device operation 4140B may take place after the transmitting operation 4139A to the one of the selected two or more interface devices is stopped, or the transmitting to another interface device operation 4140B may take place concurrently with the repeatedly transmitting operation 4139A, or the transmitting to another interface device operation 4140B may take place in response to the stopping of the transmitting of the one of the one or more subtasks to the one of the two or more predetermined interface devices.

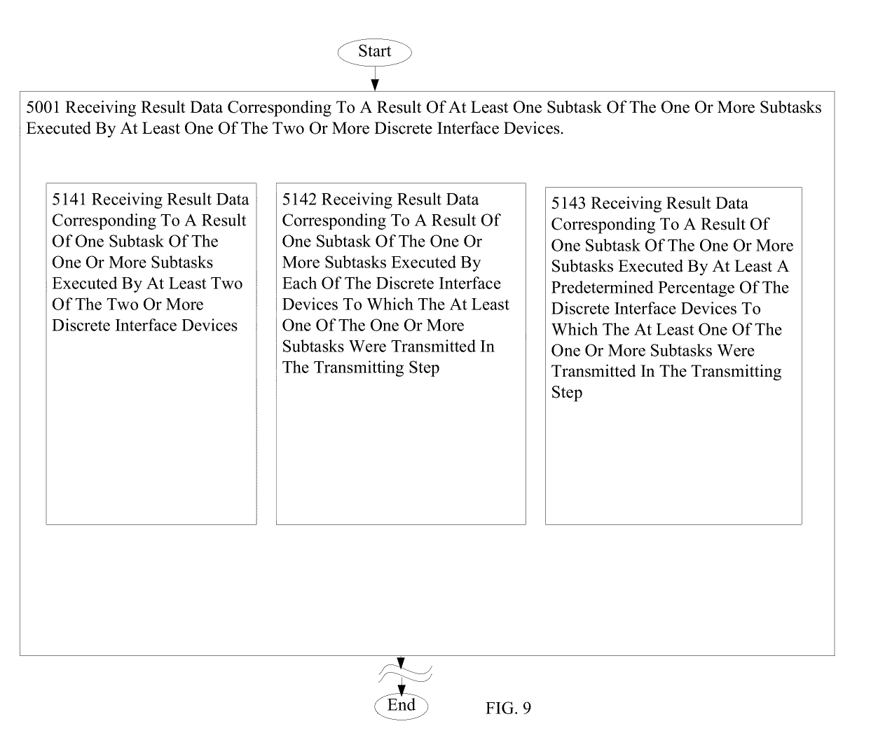

Referring to FIG. 9, as previously described above, in addition to the transmitting operation 4001, operational flow 400 depicted FIG. 4 may also include a receiving result data operation 5001. In some embodiments, receiving result data operation 5001 may include an operation 5141 depicting receiving result data corresponding to a result of one subtask of the one or more subtasks executed by at least two of the two or more discrete interface devices (e.g., FIG. 2E depicts module 521 receiving result data (e.g., “a picture of Mt. Rushmore”) corresponding to a result of one subtask (e.g., a taken picture) of the one or more subtasks (e.g., “take a picture of Mt. Rushmore”) executed by at least two of the two or more discrete interface devices (e.g., “iPhone 00001” and “Canon PowerShot 00003”)). In some embodiments, the result data that is received corresponds to a subtask carried out by at least two interface devices. For example, if the task is “Determine the temperature in Times Square,” and the subtasks generated are “determine the temperature,” and sent to interface devices having a status property of “positioned within Times Square.” In this example, it may be desirable to have two or more interface devices execute the subtask that results in the result data, in order to obtain a more accurate result.

Referring to FIG. 9, in some embodiments, receiving result data operation 5001 may include operation 5142 depicting receiving result data corresponding to a result of one subtask of the one or more subtasks executed by each of the discrete interface devices to which the at least one of the one or more subtasks were transmitted in the transmitting operation (e.g., FIG. 2E depicts module 522 receiving result data (e.g., “a picture of Mt. Rushmore”) corresponding to a result of one subtask (e.g., a taken picture) of the one or more subtasks (e.g., “take a picture of Mt. Rushmore”) executed by each of the discrete interface devices (e.g., “HTC Evo 00001” and “Asus Transformer 00001”). to which the at least one of the one or more subtasks (e.g., “take a picture of Mt. Rushmore”) were transmitted.

In some embodiments, the receiving result data corresponding to each selected interface device operation 5142 performed by the each-device result receiving module 522 may check to determine whether the received result data corresponds to each of the selected two or more interface devices. In some embodiments, the each-device result receiving module 522 may perform this determination by analyzing the received result data. In other embodiments, the result data 72 received during the receiving result data corresponding to each selected interface device operation 5142 may include information that describes the number of interface devices that carried out the one or more subtasks in order to correspond to the received result data.

Referring to FIG. 9, In some embodiments, operation 5001 may include a operation 5143 depicting receiving result data corresponding to a result of one subtask of the one or more subtasks executed by at least a predetermined percentage of the selected two or more discrete interface devices to which the at least one of the one or more subtasks were transmitted in the transmitting operation (e.g., FIG. 2E depicts module 523 receiving result data (e.g., “a picture of Mt. Rushmore”) corresponding to a result of one subtask (e.g., a taken picture) of the one or more subtasks (e.g., “take a picture of Mt. Rushmore”) executed by at least a predetermined percentage (e.g., fifty percent) of the selected two or more discrete interface devices (e.g., “iPad 06721,” and “Samsung Galaxy Tab 06326”) to which the at least one of the one or more subtasks were transmitted (e.g., “take a picture of Mt. Rushmore”) in the transmitting operation (e.g., transmitting the subtasks)). In some embodiments, in order to complete task of acquiring information that is received by computing device 30 in receiving request data operation 1001, the result data may correspond to a percentage of the selected two or more interface devices, so that sufficient data is present to complete the task of acquiring information. For example, if the task to be completed is “determine the fastest route from the Sears Tower in downtown Chicago to Naperville,” and this is divided into subtasks of “determine velocity” and transmitted to interface devices that are positioned on highways between the Sears Tower and Naperville, then, in order to obtain reliable results, then the receiving result data corresponding to predetermined interface devices operation 5143 may receive result data that corresponds to a certain percentage, e.g., fifty percent, of the selected two or more discrete interface devices, in order to provide accurate results. The predetermined percentage may be based on a variety of factors. In some embodiments, the predetermined percentage may be the same for each task of acquiring information. In some embodiments, the predetermined percentage may be related to on the number or the type of subtask. In some embodiments, the predetermined percentage may be related to a status or characteristic property of the one or more interface devices to which the one or more subtasks are transferred. In some embodiments, the predetermined percentage may be related to a condition or type of the communications network 40. In some embodiments, the predetermined percentage may be related to a service provider operating on the communications network 40.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuitry (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuitry, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

Those having skill in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

Those skilled in the art will recognize that it is common within the art to implement devices and/or processes and/or systems, and thereafter use engineering and/or other practices to integrate such implemented devices and/or processes and/or systems into more comprehensive devices and/or processes and/or systems. That is, at least a portion of the devices and/or processes and/or systems described herein can be integrated into other devices and/or processes and/or systems via a reasonable amount of experimentation. Those having skill in the art will recognize that examples of such other devices and/or processes and/or systems might include—as appropriate to context and application—all or part of devices and/or processes and/or systems of (a) an air conveyance (e.g., an airplane, rocket, helicopter, etc.), (b) a ground conveyance (e.g., a car, truck, locomotive, tank, armored personnel carrier, etc.), (c) a building (e.g., a home, warehouse, office, etc.), (d) an appliance (e.g., a refrigerator, a washing machine, a dryer, etc.), (e) a communications system (e.g., a networked system, a telephone system, a Voice over IP system, etc.), (f) a business entity (e.g., an Internet Service Provider (ISP) entity such as Comcast Cable, Qwest, Southwestern Bell, etc.), or (g) a wired/wireless services entity (e.g., Sprint, Cingular, Nextel, etc.), etc.

In certain cases, use of a system or method may occur in a territory even if components are located outside the territory. For example, in a distributed computing context, use of a distributed computing system may occur in a territory even though parts of the system may be located outside of the territory (e.g., relay, server, processor, signal-bearing medium, transmitting computer, receiving computer, etc. located outside the territory)

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality, and any two components capable of being so associated can also be viewed as being “capable of being operably coupled”, to each other to achieve the desired functionality. Specific examples of operably coupled include but are not limited to physically mateable and/or physically interacting components and/or wirelessly interactable and/or wirelessly interacting components and/or logically interacting and/or logically interactable components.

Those skilled in the art will recognize that at least a portion of the devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.).

In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

1. A computationally-implemented method comprising:
receiving request data including a request to carry out a task of acquiring data;
acquiring one or more subtasks related to the task of acquiring data;
selecting two or more discrete interface devices based on at least one of a status of the two or more discrete interface devices and a characteristic of the two or more discrete interface devices;
transmitting at least one of the one or more subtasks to at least two of the two or more discrete interface devices; and
receiving result data corresponding to a result of at least one subtask of the one or more subtasks executed by at least one of the two or more discrete interface devices.

2. The computationally-implemented method of claim 1, wherein selecting two or more discrete interface devices based on at least one of a status of the two or more discrete interface devices and a characteristic of the two or more discrete interface devices comprises:
selecting two or more discrete interface devices based on at least one of a property of the discrete interface devices that is dependent upon an environment of the discrete interface devices and a characteristic of the two or more discrete interface devices.

3. The computationally implemented method of claim 1, wherein selecting two or more discrete interface devices based on at least one of a status of the two or more discrete interface devices and a characteristic of the two or more discrete interface devices comprises:
selecting two or more discrete interface devices based on at least one of a status of the two or more discrete interface devices and a property of the discrete interface devices that is independent of the environment of the discrete interface devices.

4. The computationally-implemented method of claim 1, wherein the receiving request data including a request to carry out a task of acquiring data comprises:
receiving request data including a request to carry out a task of acquiring data, that is delivered from a communications network.

5. The computationally-implemented method of claim 1, wherein the receiving request data including a request to carry out a task of acquiring data comprises:
receiving request data including a request to carry out a task of acquiring data, that is delivered from a computing device.

6. The computationally-implemented method of claim 1, wherein the receiving request data including a request to carry out a task of acquiring data comprises:
receiving request data including a request to carry out an acquisition of information capable of being subdivided into one or more subtasks that are capable of being carried out by an interface device.

7-16. (canceled)

17. The computationally-implemented method of claim 1, wherein the receiving request data including a request to carry out a task of acquiring data comprises:
receiving request data, including a request to carry out a task of acquiring data, represented as a text string.

18. The computationally-implemented method of claim 1, wherein the receiving request data including a request to carry out a task of acquiring data comprises:
receiving request data, including a request to carry out a task of acquiring data, represented as one or more tokens.

19. (canceled)

20. The computationally-implemented method of claim 1, wherein the receiving request data including a request to carry out a task of acquiring data comprises:
receiving request data, including a request to carry out a task of acquiring data, representing a selection of a computer-generated representation.

21. The computationally-implemented method of claim 20, wherein said receiving request data, including a request to carry out a task of acquiring data, representing a selection of a computer-generated representation comprises:
receiving request data, including a request to carry out a task of acquiring data, representing a selection of a computer-generated graphic.

22. (canceled)

23. The computationally-implemented method of claim 1, wherein said acquiring one or more subtasks related to the task of acquiring data comprises:
generating one or more subtasks related to the task of acquiring data.

24. The computationally-implemented method of claim 23, wherein said generating one or more subtasks related to the task of acquiring data comprises:
analyzing the task of acquiring data.

25. (canceled)

26. The computationally-implemented method of claim 24, wherein said analyzing the task of acquiring data comprises:
parsing the task of acquiring data using a parser; and
performing pattern recognition on the parsed task of acquiring data.

27. The computationally-implemented method of claim 26, wherein said parsing the task of acquiring data using a parser comprises:
performing syntactic analysis of the task of acquiring data; and
removing syntax errors found in the performed syntactic analysis of the task of acquiring data.

28. The computationally-implemented method of claim 27, wherein said analyzing the task of acquiring data further comprises:
performing at least one predetermined operation when a predetermined number of syntax errors are found during the performing syntactic analysis of the task of acquiring data.

29. (canceled)

30. The computationally-implemented method of claim 28, wherein said performing at least one predetermined operation when a predetermined number of syntax errors are found during the performing syntactic analysis of the task of acquiring data comprises:
generating an error notification.

31. The computationally-implemented method of claim 30, wherein said generating an error notification comprises:
generating a message corresponding to an error occurring in the parsing of the task of acquiring data; and
transmitting the message corresponding to an error occurring in the parsing of the task of acquiring data to one or more locations.

32-34. (canceled)

35. The computationally-implemented method of claim 24, wherein said analyzing the task of acquiring data comprises comprises:
performing natural language processing on the request data including the task of acquiring data.

36. The computationally-implemented method of claim 35, wherein said performing natural language processing on the request data including the task of acquiring data comprises:
performing rules-based natural language processing on the request data including the task of acquiring data.

37-40. (canceled)

41. The computationally-implemented method of claim 23, wherein said generating one or more subtasks related to the task of acquiring data further comprises:
comparing the created list of one or more subtasks to a list of preexisting subtasks; and
retrieving subtasks from the list of one or more subtasks that appear on the list of preexisting subtasks.

42-52. (canceled)

53. The computationally-implemented method of claim 1, wherein said selecting two or more discrete interface devices based on at least one of a status of the two or more discrete interface devices and a characteristic of the two or more discrete interface devices comprises:
selecting two or more discrete interface devices from a database comprising a list of discrete interface devices.

54. The computationally-implemented method of claim 53, wherein said selecting two or more discrete interface devices from a database comprising a list of discrete interface devices comprises:
selecting two or more discrete interface devices from a database provided by a provider of communication networks.

55. The computationally-implemented method of claim 53, wherein said selecting two or more discrete interface devices from a database comprising a list of discrete interface devices comprises:
selecting two or more discrete interface devices from a database provided by one or more discrete interface devices.

56. The computationally-implemented method of claim 53, wherein said selecting two or more discrete interface devices based on at least one of a status of the two or more discrete interface devices and a characteristic of the two or more discrete interface devices comprises:
selecting two or more discrete interface devices from a database comprising:
the list of discrete interface devices;
at least one status of the discrete interface devices; and
at least one characteristic of the discrete interface devices.

57-61. (canceled)

62. The computationally-implemented method of claim 1, wherein the selecting two or more discrete interface devices based on at least one of a status of the two or more discrete interface devices and a characteristic of the two or more discrete interface devices comprises:
determining an availability of discrete interface devices based on at least one availability status of the discrete interface devices; and
selecting the two or more discrete interface devices based on the determined availability.

63. The computationally-implemented method of claim 62, wherein said determining an availability of discrete interface devices based on at least one availability status of the discrete interface devices comprises:
determining the availability of the discrete interface devices based on at least whether the discrete interface device is currently configured to carry out at least one of the one or more subtasks.

64. (canceled)

65. The computationally-implemented method of claim 62, wherein said determining an availability of discrete interface devices based on at least one availability status of the discrete interface devices comprises:
determining the availability of the discrete interface devices based on at least whether the discrete interface device is in communication with at least one of communication networks.

66. The computationally-implemented method of claim 65, wherein said determining the availability of the discrete interface devices based on at least whether the discrete interface device is in communication with at least one of comprises:
determining the availability of the discrete interface devices based on at least whether the discrete interface device is in communication with a preferred communication network of the communication networks.

67-70. (canceled)

71. The computationally-implemented method of claim 66, said determining the availability of the discrete interface devices based on at least whether the discrete interface device is in communication with a preferred communication network of the comprises:
determining the availability of the discrete interface devices based on whether the discrete interface device is in communication with a communication network associated with a particular network provider.

72. The computationally-implemented method of claim 1, wherein the selecting two or more discrete interface devices based on at least one of a status of the two or more discrete interface devices and a characteristic of the two or more discrete interface devices comprises:
determining an availability of discrete interface devices based on at least one availability characteristic of the discrete interface devices; and
selecting the two or more discrete interface devices based on the determined availability.

73. The computationally-implemented method of claim 72, wherein said determining an availability of discrete interface devices based on at least one availability characteristic of the discrete interface devices comprises:
determining the availability of the discrete interface devices based on whether the discrete interface device is currently configured to carry out at least one of the one or more subtasks.

74. The computationally-implemented method of claim 72, wherein said determining an availability of discrete interface devices based on at least one availability characteristic of the discrete interface devices comprises:
determining the availability of the discrete interface devices based on a type of discrete interface device.

75-77. (canceled)

78. The computationally-implemented method of claim 1, wherein said selecting two or more discrete interface devices based on at least one of a status of the two or more discrete interface devices and a characteristic of the two or more discrete interface devices comprises:
acquiring a list of discrete interface devices; and
selecting the two or more discrete interface devices from the predetermined list of discrete interface devices.

79. The computationally-implemented method of claim 78, wherein said acquiring a list of discrete interface devices comprises:
receiving the list of discrete interface devices from an external source.

80. The computationally-implemented method of claim 79, wherein said receiving the list of discrete interface devices from an external source comprises:
receiving the list of discrete interface devices from a provider of a communications network.

81. (canceled)

82. The computationally-implemented method of claim 1, wherein said selecting two or more discrete interface devices based on at least one of a status of the two or more discrete interface devices and a characteristic of the two or more discrete interface devices comprises:
selecting two or more discrete interface devices based on at least one status of the two or more discrete interface devices; and
selecting, from the previously selected two or more discrete interface devices, two or more discrete interface devices based on at least one characteristic of the two or more discrete interface devices.

83-85. (canceled)

86. The computationally-implemented method of claim 1, wherein said transmitting at least one of the one or more subtasks to at least two of the two or more discrete interface devices comprises:
transmitting at least one of the one or more subtasks to each of the selected two or more discrete interface devices.

87. The computationally-implemented method of claim 1, wherein said transmitting at least one of the one or more subtasks to at least two of the two or more discrete interface devices comprises:
verifying that the selected two or more discrete interface devices are configured to carry out at least one of the one or more subtasks; and
transmitting at least one of the one or more subtasks to the verified selected two or more discrete interface devices.

88-89. (canceled)

90. The computationally-implemented method of claim 1, wherein said transmitting at least one of the one or more subtasks to at least two of the two or more discrete interface devices comprises:
receiving a receipt acknowledgement indicating receipt of the one of the one or more subtasks.

91-93. (canceled)

94. The computationally-implemented method of claim 1, wherein said transmitting at least one of the one or more subtasks to at least two of the two or more discrete interface devices comprises:
transmitting one of the one or more subtasks to one of the selected two or more discrete interface devices;
receiving a receipt acknowledgement indicating receipt of the one of the one or more subtasks; and
transmitting the one of the one or more subtasks to another of the selected two or more discrete interface devices after receiving the receipt acknowledgement.

95. The computationally-implemented method of claim 1, wherein said transmitting at least one of the one or more subtasks to at least two of the two or more discrete interface devices comprises:
repeatedly transmitting one of the one or more subtasks to one of the selected two or more discrete interface devices at predetermined intervals;
receiving a receipt acknowledgement indicating receipt of the one of the one or more subtasks; and
stopping the transmitting of the one of the one or more subtasks after receiving the receipt acknowledgement.

96. The computationally-implemented method of claim 95, wherein said transmitting at least one of the one or more subtasks to at least two of the two or more discrete interface devices comprises further comprising:
stopping the repeated transmitting of the one of the one or more subtasks when the receipt acknowledgement is not received for a predetermined time; and
transmitting the one of the one or more subtasks to another of the selected two or more discrete interface devices.

97. The computationally-implemented method of claim 1, wherein said receiving result data corresponding to a result of at least one subtask of the one or more subtasks executed by at least one of the two or more discrete interface devices comprises:
receiving result data corresponding to a result of one subtask of the one or more subtasks executed by at least two of the two or more discrete interface devices.

98. (canceled)

99. The computationally-implemented method of claim 1, wherein said receiving result data corresponding to a result of at least one subtask of the one or more subtasks executed by at least one of the two or more discrete interface devices comprises:
receiving result data corresponding to a result of one subtask of the one or more subtasks executed by at least a predetermined percentage of the selected two or more discrete interface devices to which the at least one of the one or more subtasks were transmitted in the transmitting operation.

100-200. (canceled)
